(19) United States
(12) Patent Application Publication
(10) Pub. No.: US 2009/0135087 A1
(43) Pub. Date: May 28, 2009

(54) Metamaterial Structures with Multilayer Metallization and Via

(76) Inventors: Ajay Gummalla, San Diego, CA (US); Maha Achour, San Diego, CA (US); Norberto Lopez, San Diego, CA (US); Shane Thornwall, San Diego, CA (US); Nhan Duc Nguyen, Oceanside, CA (US); Gregory Poilasne, El Cajon, CA (US)

Correspondence Address: FISH & RICHARDSON, PC, P.O. BOX 1022, MINNEAPOLIS, MN, 55440-1022, US

(21) Appl. No.: 12/270,410

(22) Filed: Nov. 13, 2008

Related U.S. Application Data
(60) Provisional application No. 60/987,750, filed on Nov. 13, 2007.
(60) Provisional application No. 61/024,876, filed on Jan. 30, 2008.
(60) Provisional application No. 61/028,457, filed on Feb. 13, 2008.
(60) Provisional application No. 61/091,203, filed on Aug. 22, 2008.

(51) Int. Cl. H01Q 15/02

(52) U.S. Cl. 343/909

(57) ABSTRACT

Techniques and apparatus based on metamaterial structures are provided for antenna and transmission line devices, including multilayer metallization metamaterial structures with one or more conductive vias connecting conductive parts in two different metallization layers.

This application claims the benefits of the following U.S. Provisional Patent Applications:

1. Ser. No. 60/987,750 entitled “Antennas for Cell Phones, PDAs and Mobile Devices Based on Composite Right-Left Handed (CRLH) Metamaterial” and filed on Nov. 13, 2007;

2. Ser. No. 61/024,876 entitled “Antennas for Mobile Communication Devices Based on Composite Right-Left Handed (CRLH) Metamaterials” and filed on Jan. 30, 2008;

3. Ser. No. 61/028,457 entitled “Antennas for Cell Phones, PDAs and Mobile Devices Based on Composite Right-Left Handed (CRLH) Metamaterial” and filed on Feb. 13, 2008; and

4. Ser. No. 61/091,203 entitled “Metamaterial Antenna Structures with Non-Linear Coupling Geometry” and filed on Aug. 22, 2008.

The disclosures of the above applications are incorporated by reference as part of the specification of this application.

### BACKGROUND

This application relates to metamaterial structures.

The propagation of electromagnetic waves in most materials obeys the right handed rule for the (E,H,β) vector fields, where E is the electrical field, H is the magnetic field, and β is the wave vector. The phase velocity direction is the same as the direction of the signal energy propagation (group velocity) and the refractive index is a positive number. Such materials are “right handed” (RH). Most natural materials are RH materials. Artificial materials can also be RH materials.

A metamaterial (MTM) has an artificial structure. When designed with a structural average unit cell size p much smaller than the wavelength of the electromagnetic energy guided by the metamaterial, the metamaterial can behave like a homogeneous medium to the guided electromagnetic energy. Unlike RH materials, a metamaterial can exhibit a negative refractive index with permittivity ε and permeability μ being simultaneously negative, and the phase velocity direction is opposite to the direction of the signal energy propagation where the relative directions of the (E,H,β) vector fields follow the left handed rule. Metamaterials that support only a negative index of refraction with permittivity ε and permeability μ being simultaneously negative are pure “left handed” (LH) metamaterials.

Many metamaterials are mixtures of LH metamaterials and RH materials and thus are Composite Right and Left Handed (CRLH) metamaterials. A CRLH metamaterial can behave like a LH metamaterial at low frequencies and a RH material at high frequencies. Designs and properties of various CRLH metamaterials are described in, for example, Caloz and Itoh, “Electromagnetic Metamaterials: Transmission Line Theory and Microwave Applications,” John Wiley & Sons (2006). CRLH metamaterials and their applications in antennas are described by Tatsuo Itoh in “Invited paper: Prospects for Metamaterials,” Electronics Letters, Vol. 40, No. 16 (August, 2004).

CRLH metamaterials can be structured and engineered to exhibit electromagnetic properties that are tailored for specific applications and can be used in applications where it may be difficult, impractical or infeasible to use other materials. In addition, CRLH metamaterials may be used to develop new applications and to construct new devices that may not be possible with RH materials.

### SUMMARY

Techniques and apparatus based on metamaterial structures are provided for antenna and transmission line devices, including multilayer metallization metamaterial structures with one or more conductive vias connecting conductive parts in two different metallization layers.

In one aspect, a metamaterial device includes a substrate, a plurality of metallization layers associated with the substrate and patterned to have a plurality of conductive parts, and a conductive via formed in the substrate to connect a conductive part in one metallization layer to a conductive part in another metallization layer. The conductive parts and the conductive via form a composite right and left handed (CRLH) metamaterial structure. In one implementation of the device, the conductive parts and the conductive via of the CRLH metamaterial structure are structured to form a metamaterial antenna and are configured to generate two or more frequency resonances. In another implementation, two or more frequency resonances of the CRLH metamaterial structure are sufficiently close to produce a wide band. In another implementation, the parts and the conductive via of the CRLH metamaterial structure are configured to generate a first frequency resonance in a low band and a second frequency resonance in a high band, the first frequency resonance being a left-handed (LH) mode frequency resonance and the second frequency resonance being a right-handed (RH) mode frequency resonance. In yet another implementation, the parts and the conductive via of the CRLH metamaterial structure are configured to generate a first frequency resonance in a low band, a second frequency resonance in a high band, and a third frequency resonance which is substantially close in frequency to the first frequency resonance to be coupled with the first frequency resonance, providing a combined mode resonance band that is wider than the low band.

In another aspect, a metamaterial device includes a substrate, a first metallization layer formed on a first surface of the substrate and patterned to comprise a cell patch and a launch pad that are separated from each other and are electromagnetically coupled to each other, and a second metallization layer formed on a second surface of the substrate parallel to the first surface and patterned to comprise a ground electrode located outside a footprint of the cell patch, a cell via pad located underneath the cell patch, a cell via line connecting the ground electrode to the cell via pad, an interconnect pad located underneath the launch pad, and a feed line connected to the interconnect pad. This device also includes a cell via formed in the substrate to connect the cell patch to the cell via pad and an interconnect via formed in the substrate to connect the launch pad to the interconnect pad. One of the cell patch and the launch pad is shaped to include an opening and the other of the cell patch and the launch pad is located inside the opening. The cell patch, the cell via, the cell via pad, the cell via line, the ground electrode, the launch pad, the interconnect via, the interconnect via and the feed line form a composite right and left handed (CRLH) metamaterial structure.

In another aspect, a wireless communication device includes a printed circuit board (PCB) comprising a portion that is structured to form an antenna. The antenna includes a CRLH metamaterial cell comprising a top metal patch on a first surface of the PCB, a bottom metal pad on a second, opposing surface of the PCB and a conductive via connecting the top metal patch and the bottom metal pad; and a grounded co-planar waveguide (CPW) formed on the top surface of the PCB at a location to be spaced from the CRLH metal material cell and comprising a planar waveguide (CPW) feed line, a top ground (GND) around the CPW feed line. The CPW feed line has a terminal located close to and capacitively coupled to the top metal patch of the CRLH metalmaterial cell. The antenna also includes a bottom ground metal patch formed on the bottom surface of the PCB below the grounded CPW formed on the top surface of the PCB; and a bottom conductive path that connects the bottom ground metal path to the bottom metal pad of the CRLH metamaterial cell. In one implementation, the antenna is configured to have two or more resonances in different frequency bands, which may, for example, include a cellular band from 890 MHz to 960 MHz and a PCS band from 1700 MHz to 2100 MHz.

In yet another aspect, a wireless communication device includes a printed circuit board (PCB) comprising a portion that is structured to form an antenna. This antenna includes a CRLH metamaterial cell comprising a top metal patch on a first surface of the PCB; a grounded co-planar waveguide (CPW) formed on the top surface of the PCB at a location to be spaced from the CRLH metal material cell and comprising a planar waveguide (CPW) feed line, a top ground (GND) around the CPW feed line, wherein the CPW feed line has a terminal located close to and capacitively coupled to the top metal patch of the CRLH metalmaterial cell; and a top ground metal path formed on the top surface of the PCB to connect to the top ground and the top metal patch of the CRLH metamaterial cell. In one implementation, the antenna is configured to have two or more resonances in different frequency bands, which may, for example, include a cellular band from 890 MHz to 960 MHz and a PCS band from 1700 MHz to 2100 MHz.

These and other aspects and implementations and their variations are described in detail in the attached drawings, the detailed description and the claims.

### BRIEF DESCRIPTION OF THE DRAWINGS

FIG. 1 shows an example of a 1D CRLH MTM TL based on four unit cells.

FIG. 2 shows an equivalent circuit of the 1D CRLH MTM TL shown in FIG. 1.

FIG. 3 shows another representation of the equivalent circuit of the 1D CRLH MTM TL shown in FIG. 1.

FIG. 4A shows a two-port network matrix representation for the 1D CRLH TL equivalent circuit shown in FIG. 2.

FIG. 4B shows another two-port network matrix representation for the 1D CRLH TL equivalent circuit shown in FIG. 3.

FIG. 5 shows an example of a 1D CRLH MTM antenna based on four unit cells.

FIG. 6A shows a two-port network matrix representation for the 1D CRLH antenna equivalent circuit analogous to the TL case shown in FIG. 4A.

FIG. 6B shows another two-port network matrix representation for the 1D CRLH antenna equivalent circuit analogous to the TL case shown in FIG. 4B.

FIG. 7A shows an example of a dispersion curve for the balanced case.

FIG. 7B shows an example of a dispersion curve for the unbalanced case.

FIG. 8 shows an example of a 1D CRLH MTM TL with a truncated ground based on four unit cells.

FIG. 9 shows an equivalent circuit of the 1D CRLH MTM TL with the truncated ground shown in FIG. 8.

FIG. 10 shows an example of a 1D CRLH MTM antenna with a truncated ground based on four unit cells.

FIG. 11 shows another example of a 1D CRLH MTM TL with a truncated ground based on four unit cells.

FIG. 12 shows an equivalent circuit of the 1D CRLH MTM TL with the truncated ground shown in FIG. 11.

FIGS. 13(a)-13(d) show an example of a one-cell two-layer MTM antenna structure with a via, illustrating the 3D view, side view, top view of the top layer and the top view of the bottom layer, respectively.

FIG. 14(a) shows the simulated return loss of the MTM antenna structure shown in FIGS. 13(a)-13(d).

FIG. 14(b) shows the simulated input impedance of the MTM antenna structure shown in FIGS. 13(a)-13(d).

FIGS. 15(a) and 15(b) shows the measured efficiency of the MTM antenna structure shown in FIGS. 13(a)-13(d) for the low band and high band, respectively.

FIGS. 16(a)-16(c) show an example of a two-cell two-layer MTM antenna structure with a via and via line extension, illustrating the 3D view, top view of the top layer and top view of the bottom layer, respectively.

FIG. 17(a) shows the simulated return loss of the MTM structure shown in FIGS. 16(a)-16(c).

FIG. 17(b) shows the simulated input impedance of the MTM antenna structure shown in FIGS. 16(a)-16(c).

FIGS. 18(a)-18(f) show an example of a two-cell two-layer MTM antenna structure with a via and via line extension as shown in FIGS. 16(a)-16(c) with the elevated antenna portion, illustrating the 3D view, side view, top view of the top layer of the elevated substrate, top view of the bottom layer of the elevated substrate, top view of the top layer of the main substrate, and top view of the bottom layer of the main substrate, respectively.

FIG. 19(a) shows the simulated return loss of the MTM antenna structure shown in FIGS. 18(a)-18(f) for three different elevations h=2 mm, 4 mm and 5 mm.

FIG. 19(b) shows the simulated input impedance of the MTM antenna structure shown in FIGS. 18(a)-18(f) for three different elevations h=2 mm, 4 mm and 5 mm.

FIG. 20(a) shows the photos of a fabricated sample of the MTM antenna structure (planar version) shown in FIGS. 16(a)-16(c).

FIG. 20(b) shows the photos of a fabricated sample of the MTM antenna structure (3D version) shown in FIGS. 18(a)-18(f).

FIG. 21 shows the measured return loss of the MTM antenna structure (planar version) shown in FIGS. 16(a)-16(c) for bare board, closed lid and open lid configurations.

FIG. 22 shows the measured return loss of the MTM antenna structure (3D version) shown in FIGS. 18(a)-18(f) for bare board, closed lid and open lid configurations.

FIGS. 23(a)-23(c) show an example of a two-antenna array with a low-band MTM antenna and high-band MTM antenna, illustrating the 3D view, top view of the top layer and top view of the bottom layer, respectively.

FIG. 24 shows the measured return loss and coupling of the two-antenna array shown in FIGS. 23(a)-23(c), where Return Loss 1 refers to the return loss of the low-band MTM antenna and Return Loss 2 refers to the return loss of the high-band MTM antenna.

FIGS. 25(a) and 25(b) show the measured efficiency of the two-antenna array shown in FIGS. 23(a)-23(c) for the low band and high band, respectively.

FIG. 26 shows a photo of a fabricated sample of a reduced size two-antenna array with a low-band MTM antenna and high-band MTM antenna, illustrating the top view of the top layer.

FIG. 27(a) shows the measured return loss of the reduced size two-antenna array shown in FIG. 26, where S11 refers to the return loss of the low-band MTM antenna and S22 refers to the return loss of the high-band MTM antenna.

FIG. 27(b) shows the measured coupling of the reduced size two-antenna array shown in FIG. 26.

FIG. 28 shows the measured efficiency of the reduced size two-antenna array shown in FIG. 26 for the low band and high band.

FIGS. 29(a)-29(c) show an example of a receive-diversity antenna array with three MTM antennas, Antenna 1, Antenna 2 and Antenna 3, illustrating the 3D view, top view of the top layer and top view of the bottom layer, respectively.

FIG. 30 shows the measured return loss of the receive-diversity antenna array with three MTM antennas shown in FIGS. 29(a)-29(c), where S11, S22 and S33 refer to the return loss of Antenna 1, Antenna 2 and Antenna 3, respectively.

FIGS. 31(a)-31(c) show an example of a two-cell two-layer two-spiral MTM antenna structure with one via, illustrating the 3D view, top view of the top layer and top view of the bottom layer, respectively.

FIG. 32(a) shows the simulated return loss of the MTM antenna structure shown in FIGS. 31(a)-31(c).

FIG. 32(b) shows the simulated input impedance of the MTM antenna structure shown in FIGS. 31(a)-31(c).

FIG. 33 shows the simulated measured return loss of the MTM antenna structure shown in FIGS. 31(a)-31(c).

FIG. 34 shows the measured efficiency of the MTM antenna structure shown in FIGS. 31(a)-31(c).

FIGS. 35(a)-35(d) show an example of a two-cell two-layer two-spiral MTM antenna structure with two vias, illustrating the 3D view, side view, top view of the top layer and top view of the bottom layer, respectively.

FIGS. 36(a)-36(d) show an example of a semi single-layer MTM antenna structure with a cell patch extension and meander extension with connecting vias, illustrating the 3D view, side view, top view of the top layer and top view of the bottom layer, respectively.

FIG. 37(a) shows the simulated return loss of the MTM antenna structure shown in FIGS. 36(a)-36(d).

FIG. 37(b) shows the simulated input impedance of the MTM antenna structure shown in FIGS. 36(a)-36(d).

FIG. 38 shows the measured return loss of the MTM antenna structure shown in FIGS. 36(a)-36(d).

FIGS. 39(a) and 39(b) show the measured efficiency of the MTM antenna structure shown in FIGS. 36(a)-36(d) for the low band and high band, respectively.

FIGS. 40(a) and 40(b) show photos of a fabricated sample of a reduced-size one-cell two-layer MTM antenna structure with a meander line on the same side as the cell patch, illustrating the top view of the top layer and bottom view of the bottom layer, respectively.

FIG. 41 shows the measured return loss of the MTM antenna structure shown in FIGS. 40(a) and 40(b).

FIG. 42 shows the measured efficiency of the MTM antenna structure shown in FIGS. 40(a) and 40(b).

FIGS. 43(a)-43(c) show an example of a small one-cell two-layer MTM antenna structure with a split spiral, illustrating the 3D view, top view of the top layer and top view of the bottom layer, respectively.

FIG. 44 shows the measured return loss of the MTM antenna structure shown in FIGS. 43(a)-43(c).

FIG. 45 shows the measured efficiency of the MTM antenna structure shown in FIGS. 43(a)-43(c).

FIGS. 46(a)-46(d) show an example of an MTM antenna structure with a launch pad surrounded by a cell patch, illustrating the 3D view, side view, top view of the top layer and top view of the bottom layer, respectively.

FIGS. 47(a) and 47(b) show photos of a fabricated sample of the MTM antenna structure shown in FIGS. 46(a)-46(d), illustrating the top view of the top layer and bottom view of the bottom layer, respectively.

FIG. 48 shows the measured return loss of the MTM antenna structure shown in FIGS. 46(a)-46(d).

FIG. 49 shows the measured efficiency of the MTM antenna structure shown in FIGS. 46(a)-46(d).

FIGS. 50(a)-50(d) show an example of a two-antenna array with each MTM antenna as shown in FIGS. 46(a)-46(d), illustrating the 3D view, side view, top view of the top layer and top view of the bottom layer, respectively.

FIGS. 51(a) and 51(b) show photos of a fabricated sample of the two-antenna array shown in FIGS. 50(a)-50(d), illustrating the top view of the top layer and bottom view of the bottom layer, respectively.

FIG. 52 shows the measured return loss and coupling of the two-antenna array shown in FIGS. 50(a)-50(d), where Return Loss 1 refers to the return loss of Antenna 1 and Return Loss 2 refers to the return loss of Antenna 2.

FIG. 53 shows the measured efficiency of the two-antenna array shown in FIGS. 50(a)-50(d), where Efficiency 1 refers to the efficiency of Antenna 1 and Efficiency 2 refers to the efficiency of Antenna 2.

FIG. 54 shows the measured efficiency of one of the Antennas when the other Antenna is removed in the two-antenna array shown in FIGS. 50(a)-50(d).

FIG. 55 (a)-55(d) show an example of a two-antenna array with each MTM antenna having a cell patch surrounded by a launch pad, illustrating the 3D view, side view, top view of the top layer and top view of the bottom layer, respectively.

FIGS. 56(a) and 56(b) show photos of a fabricated sample of the two-antenna array shown in FIGS. 55(a)-55(d), illustrating the top view of the top layer and bottom view of the bottom layer, respectively.

FIG. 57 shows the measured return loss and coupling of the two-antenna array shown in FIGS. 55(a)-55(d), where Return Loss 1 refers to the return loss of Antenna 1 and Return Loss 2 refers to the return loss of Antenna 2.

FIG. 58 shows the measured efficiency of the two-antenna array shown in FIGS. 55(a)-55(d), where Efficiency 1 refers to the efficiency of Antenna 1 and Efficiency 2 refers to the efficiency of Antenna 2.

FIGS. 59(a)-59(f) show an example of a three-layer MTM antenna structure with vertical coupling, illustrating the 3D view, top view of the top layer, top view of the middle layer, top view of the bottom layer, top view of the top and middle layer overlaid, and side view, respectively.

FIG. 60(a) shows the simulated return loss of the MTM antenna structure shown in FIGS. 59(a)-59(f).

FIG. 60(b) shows the simulated input impedance of the MTM antenna structure shown in FIGS. 59(a)-59(f).

FIGS. 61(a)-61(c) shows an example of a one-cell two-layer MTM antenna structure with a meander line on the other side of the cell patch, illustrating the 3D view, top view of the top layer and top view of the bottom layer, respectively.

FIGS. 62(a) and 62(b) show the MTM structure as shown in FIGS. 61(a)-61(c) with a lumped capacitor and reduced-width cell patch, illustrating the top view of the top layer and top view of the bottom layer, respectively.

FIGS. 63(a) and 63(b) show the MTM structure as shown in FIGS. 61(a)-61(c) with a lumped inductor and shortened via line, illustrating the top view of the top layer and top view of the bottom layer, respectively.

FIGS. 64(a) and 64(b) show the MTM structure as shown in FIGS. 61(a)-61(c) with a lumped capacitor and reduced-width cell patch as well as a lumped inductor and shortened via line, illustrating the top view of the top layer and top view of the bottom layer, respectively.

FIGS. 65(a)-65(d) show the simulated return loss of the MTM antenna structure shown in FIGS. 61(a)-61(c), the MTM antenna structure with the lumped capacitor shown in FIGS. 62(a) and 62(b), the MTM antenna structure with the lumped inductor shown in FIGS. 63(a) and 63(b), and the MTM antenna structure with the lumped capacitor and lumped inductor shown in FIGS. 64(a) and 64(b), respectively.

### DETAILED DESCRIPTION

Metamaterial (MTM) structures can be used to construct antennas and other electrical components and devices, allowing for a wide range of technology advancements such as functionality enhancement, size reduction and performance improvements. The MTM structures can be fabricated on various circuit platforms, including circuit boards such as a FR-4 Printed Circuit Board (PCB) or a Flexible Printed Circuit (FPC) board. Examples of other fabrication techniques include thin film fabrication techniques, system on chip (SOC) techniques, low temperature co-fired ceramic (LTCC) techniques, and monolithic microwave integrated circuit (MMIC) techniques.

The examples and implementations of MTM structures described in this document include multilayer MTM antenna structures that have conductive components of the MTM structure, including a ground electrode, in two or more metallization layers. These multiple metallization layers can be formed on two or more parallel surfaces in a substrate or a plate structure where two adjacent metallization layers are separated by an electrically insulating material (e.g., a dielectric material). Two or more substrates may be stacked together with or without spacing to provide multiple surfaces for the multiple metallization layers to achieve certain technical features or advantages. Such multilayer MTM structures can have at least one conductive via to connect one conductive component in one metallization layer to another conductive component in another metallization layer. The described multilayer MTM structures with at least one via and their implementations can be structured in various configurations and may be coupled with other MTM or non-MTM circuits and circuit elements on the circuit boards.

The multilayer MTM antenna structures described in this document can be designed to generate multiple frequency bands for various applications, including cell phone applications, handheld communication device applications (e.g., PDAs and smart phones), WiFi applications, WiMax applications and other wireless mobile device applications, in which the antenna is expected to support multiple frequency bands with adequate performance under limited space constraints. These MTM antenna structures can be adapted and designed to provide one or more advantages over other antennas such as compact sizes, multiple resonances based on a single antenna solution, resonances that are stable and do not shift substantially with the user interaction, and resonant frequencies that are substantially independent of the physical size. Furthermore, elements in the present MTM antenna structure can be configured to achieve desired bands and bandwidths based on the CRLH properties.

An MTM antenna or MTM transmission line (TL) is an MTM structure with one or more MTM unit cells. The equivalent circuit for each MTM unit cell includes a right-handed series inductance (LR), a right-handed shunt capacitance (CR), a left-handed series capacitance (CL), and a left-handed shunt inductance (LL). LL and CL are structured and connected to provide the left-handed properties to the unit cell. This type of CRLH TLs or antennas can be implemented by using distributed circuit elements, lumped circuit elements or a combination of both. Each unit cell is smaller than ˜λ/4 where λ is the wavelength of the electromagnetic signal that is transmitted in the CRLH TL or antenna.

A pure LH metamaterial follows the left-hand rule for the vector trio (E,H,β), and the phase velocity direction is opposite to the signal energy propagation direction. Both the permittivity ε and permeability μ of the LH material are negative. A CRLH metamaterial can exhibit both left-hand and right-hand electromagnetic modes of propagation depending on the regime or frequency of operation. Under certain circumstances, a CRLH metamaterial can exhibit a non-zero group velocity when the wavevector of a signal is zero. This situation occurs when both left-hand and right-hand modes are balanced. In an unbalanced mode, there is a bandgap in which electromagnetic wave propagation is forbidden. In the balanced case, the dispersion curve does not show any discontinuity at the transition point of the propagation constant β(ωₒ)=0 between the left- and right-hand modes, where the guided wavelength is infinite, i.e., λ_{g}=2π/|β|→∞, while the group velocity is positive:

$${v}_{g} = \frac{d ω}{d β} {\vert}_{β = 0} > 0.$$

This state corresponds to the zeroth order mode m=0 in a TL implementation in the LH region. The CRLH structure supports a fine spectrum of low frequencies with the dispersion relation that follows the negative β parabolic region. This allows a physically small device to be built that is electromagnetically large with unique capabilities in manipulating and controlling near-field around the antenna which in turn controls the far-field radiation patterns. When this TL is used as a Zeroth Order Resonator (ZOR), it allows a constant amplitude and phase resonance across the entire resonator. The ZOR mode can be used to build MTM-based power combiners and splitters or dividers, directional couplers, matching networks, and leaky wave antennas.

In the case of RH TL resonators, the resonance frequency corresponds to electrical lengths θₘ=βₘl=mπ (m=1, 2, 3 . . . ), where l is the length of the TL. The TL length should be long to reach low and wider spectrum of resonant frequencies. The operating frequencies of a pure LH material are at low frequencies. A CRLH MTM structure is very different from an RH or LH material and can be used to reach both high and low spectral regions of the RF spectral ranges. In the CRLH case θₘ=βₘl=mπ, where l is the length of the CRLH TL and the parameter m=0, ±1, ±2, ±3 . . . ±∞.

Examples of specific MTM antenna structures are described below. Certain technical information associated with the these examples is described in U.S. patent application Ser. No. 11/741,674 entitled “Antennas, Devices, and Systems Based on Metamaterial Structures,” filed on Apr. 27, 2007, and U.S. patent application Ser. No. 11/844,982 entitled “Antennas Based on Metamaterial Structures,” filed on Aug. 24, 2007, which are incorporated by reference as part of the specification of this document.

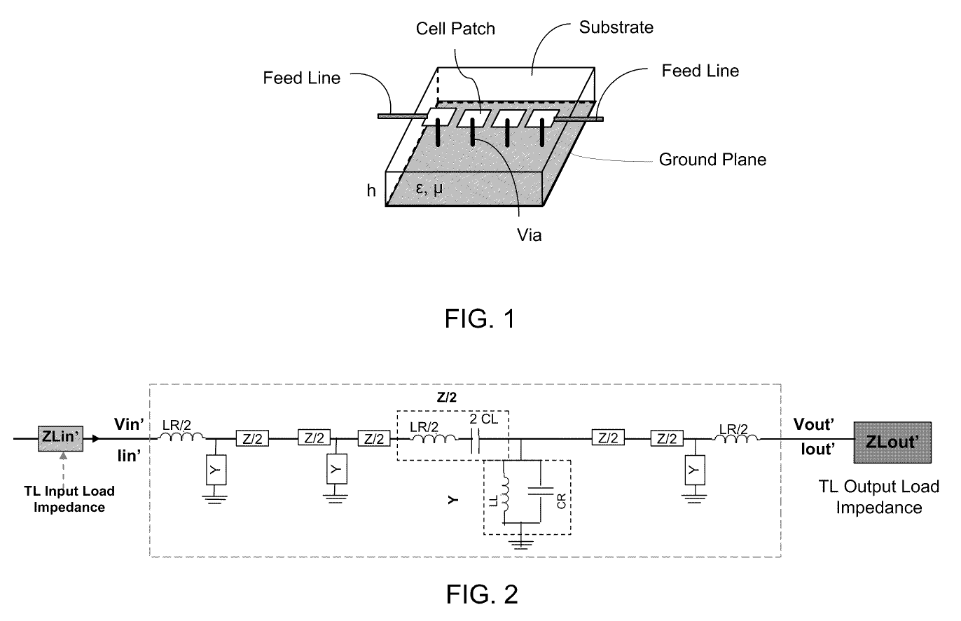

FIG. 1 illustrates an example of a 1-dimensional (1D) CRLH MTM transmission line (TL) based on four unit cells. One unit cell includes a cell patch and a via, and is a building block for constructing a desired MTM structure. The illustrated TL example includes four unit cells formed in two conductive metallization layers of a substrate where four conductive cell patches are formed on the top conductive metallization layer of the substrate and the other side of the substrate has a metallization layer as the ground electrode. Four centered conductive vias are formed to penetrate through the substrate to connect the four cell patches to the ground plane, respectively. The unit cell patch on the left side is electromagnetically coupled to a first feed line and the unit cell patch on the right side is electromagnetically coupled to a second feed line. In some implementations, each unit cell patch is electromagnetically coupled to an adjacent unit cell patch without being directly in contact with the adjacent unit cell. This structure forms the MTM transmission line to receive an RF signal from one feed line and to output the RF signal at the other feed line.

FIG. 2 shows an equivalent network circuit of the 1D CRLH MTM TL in FIG. 1. The ZLin′ and ZLout′ correspond to the TL input load impedance and TL output load impedance, respectively, and are due to the TL coupling at each end. This is an example of a printed two-layer structure. LR is due to the cell patch on the dielectric substrate, and CR is due to the dielectric substrate being sandwiched between the cell patch and the ground plane. CL is due to the presence of two adjacent cell patches, and the via induces LL.

Each individual unit cell can have two resonances ω_{SE} and ω_{SH} corresponding to the series (SE) impedance Z and shunt (SH) admittance Y. In FIG. 2, the Z/2 block includes a series combination of LR/2 and 2CL, and the Y block includes a parallel combination of LL and CR. The relationships among these parameters are expressed as follows:

$${ω}_{SH} = \frac{1}{\sqrt{L L C R}} ; \\ {ω}_{SE} = \frac{1}{\sqrt{L R C L}} ; \\ {ω}_{R} = \frac{1}{\sqrt{L R C R}} ; \\ {ω}_{L} = \frac{1}{\sqrt{L L C L}} \\ where , Z = jω L R + \frac{1}{jω C L} \\ and Y = jω C R + \frac{1}{jω L L} . \qquad Eq . ( 1 )$$

The two unit cells at the input/output edges in FIG. 1 do not include CL, since CL represents the capacitance between two adjacent cell patches and is missing at these input/output edges. The absence of the CL portion at the edge unit cells prevents (OSE frequency from resonating. Therefore, only ω_{SH} appears as an m=0 resonance frequency.

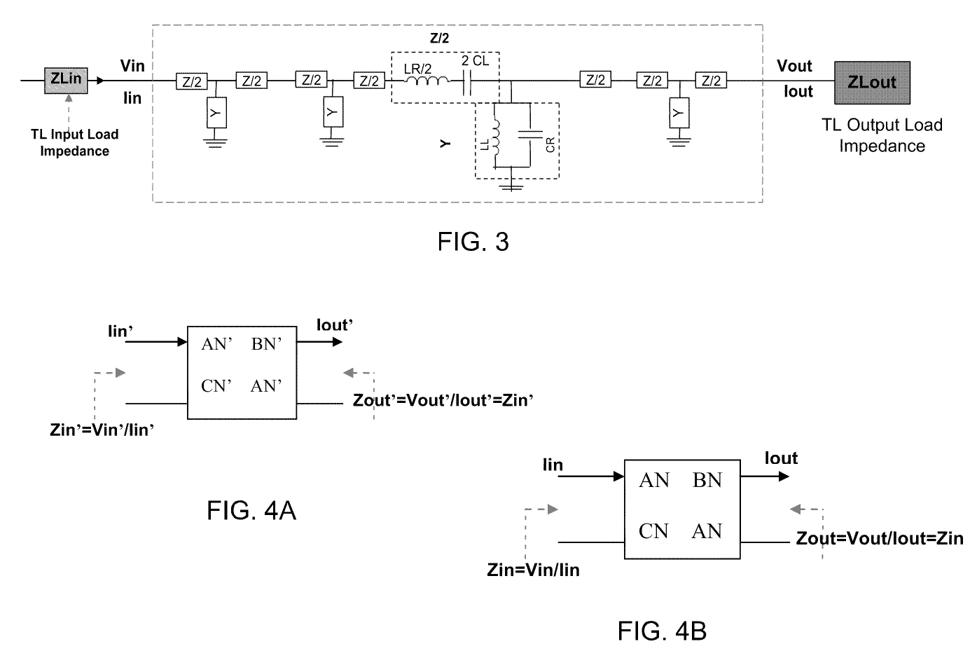

To simplify the computational analysis, a portion of the ZLin′ and ZLout′ series capacitor is included to compensate for the missing CL portion, and the remaining input and output load impedances are denoted as ZLin and ZLout, respectively, as seen in FIG. 3. Under this condition, all unit cells have identical parameters as represented by two series Z/2 blocks and one shunt Y block in FIG. 3, where the Z/2 block includes a series combination of LR/2 and 2CL, and the Y block includes a parallel combination of LL and CR.

FIG. 4A and FIG. 4B illustrate a two-port network matrix representation for TL circuits without the load impedances as shown in FIG. 2 and FIG. 3, respectively,

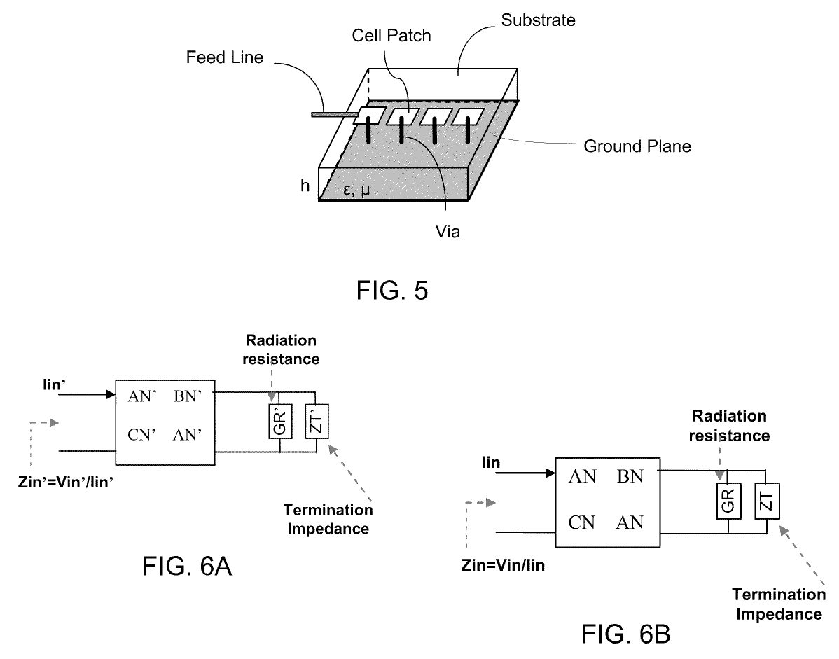

FIG. 5 illustrates an example of a 1D CRLH MTM antenna based on four unit cells. Different from the 1D CRLH MTM TL in FIG. 1, the antenna in FIG. 5 couples the unit cell on the left side to a feed line to connect the antenna to a antenna circuit and the unit cell on the right side is an open circuit so that the four cells interface with the air to transmit or receive an RF signal.

FIG. 6A shows a two-port network matrix representation for the antenna circuit in FIG. 5. FIG. 6B shows a two-port network matrix representation for the antenna circuit in FIG. 5 with the modification at the edges to account for the missing CL portion to have all the unit cells identical. FIGS. 6A and 6B are analogous to the TL circuits shown in FIGS. 4A and 4B, respectively.

In matrix notations, FIG. 4B represents the relationship given as below:

$$( \begin{matrix}Vin \\ Iin\end{matrix} ) = ( \begin{matrix}AN & BN \\ CN & AN\end{matrix} ) ( \begin{matrix}Vout \\ Iout\end{matrix} ) , \qquad Eq . ( 2 )$$

where AN=DN because the CRLH MTM TL circuit in FIG. 3 is symmetric when viewed from Vin and Vout ends.

In FIGS. 6A and 6B, the parameters GR′ and GR represent a radiation resistance, and the parameters ZT′ and ZT represent a termination impedance. Each of ZT′, ZLin′ and ZLout′ includes a contribution from the additional 2CL as expressed below:

$${ZLin}^{′} = ZLin + \frac{2}{jω CL} , \\ ZL {out}^{′} = ZLout + \frac{2}{jω CL} , \\ {ZT}^{′} = ZT + \frac{2}{jω CL} . \qquad Eq . ( 3 )$$

Since the radiation resistance GR or GR′ can be derived by either building or simulating the antenna, it may be difficult to optimize the antenna design. Therefore, it is preferable to adopt the TL approach and then simulate its corresponding antennas with various terminations ZT. The relationships in Eq. (1) are valid for the circuit in FIG. 2 with the modified values AN′, BN′, and CN′, which reflect the missing CL portion at the two edges.

The frequency bands can be determined from the dispersion equation derived by letting the N CRLH cell structure resonate with nπ propagation phase length, where n=0, ±1, ±2, . . . ±N. Here, each of the N CRLH cells is represented by Z and Y in Eq. (1), which is different from the structure shown in FIG. 2, where CL is missing from end cells. Therefore, one might expect that the resonances associated with these two structures are different. However, extensive calculations show that all resonances are the same except for n=0, where both ω_{SE} and ω_{SH} resonate in the structure in FIG. 3, and only ω_{SH} resonates in the structure in FIG. 2. The positive phase offsets (n>0) correspond to RH region resonances and the negative values (n<0) are associated with LH region resonances.

The dispersion relation of N identical CRLH cells with the Z and Y parameters is given below:

$$\{ \begin{matrix}N β p = {cos}^{- 1} ( {A}_{N} ) , ⇒ \vert {A}_{N} \vert \leq 1 ⇒ 0 \leq χ = - ZY \leq 4 ∀ N \\ where {A}_{N} = 1 at even resonances \\ \vert n \vert = 2 m ∈ \{ 0 , 2 , 4 , … 2 \times Int ( \frac{N - 1}{2} ) \} \\ and {A}_{N} = - 1 at odd resonances \\ \vert n \vert = 2 m + 1 ∈ \{ 1 , 3 , … ( 2 \times Int ( \frac{N}{2} ) - 1 ) \}\end{matrix} \qquad Eq . ( 4 )$$

where Z and Y are given in Eq. (1), AN is derived from the linear cascade of N identical CRLH unit cells as in FIG. 3, and p is the cell size. Odd n=(2m+1) and even n=2m resonances are associated with AN=−1 and AN=1, respectively. For AN′ in FIG. 4A and FIG. 6A, the n=0 mode resonates at ω₀=ω_{SH} only and not at both ω_{SE} and ω_{SH} due to the absence of CL at the end cells, regardless of the number of cells. Higher-order frequencies are given by the following equations for the different values of χ specified in Table 1:

$$For n > 0 , \\ {ω}_{\pm n}^{2} = \frac{{ω}_{SH}^{2} + {ω}_{SE}^{2} + {χω}_{R}^{2}}{2} \pm \sqrt{\begin{matrix}{( \frac{{ω}_{SH}^{2} + {ω}_{SE}^{2} + {χω}_{R}^{2}}{2} )}^{2} - \\ {ω}_{SH}^{2} {ω}_{SE}^{2}\end{matrix}} . \qquad Eq . ( 5 )$$

Table 1 provides χ values for N=1, 2, 3, and 4. It should be noted that the higher-order resonances |n|>0 are the same regardless if the full CL is present at the edge cells (FIG. 3) or absent (FIG. 2). Furthermore, resonances close to n=0 have small χ values (near χ lower bound 0), whereas higher-order resonances tend to reach χ upper bound 4 as stated in Eq. (4).

TABLE 1
Resonances for N = 1, 2, 3 and 4 cells

| N\ | | | | |
|---|---|---|---|---|
| Modes | \|n\| = 0 | \|n\| = 1 | \|n\| = 2 | \|n\| = 3 |
| N = 1 | χ_{(1, 0)} = 0; ω₀ = ω_{SH} | | | |
| N = 2 | χ_{(2, 0)} = 0; ω₀ = ω_{SH} | χ_{(2, 1)} = 2 | | |
| N = 3 | χ_{(3, 0)} = 0; ω₀ = ω_{SH} | χ_{(3, 1)} = 1 | χ_{(3, 2)} = 3 | |
| N = 4 | χ_{(4, 0)} = 0; ω₀ = ω_{SH} | χ_{(4, 1)} = 2 − \sqrt{2} | χ_{(4, 2)} = 2 | |

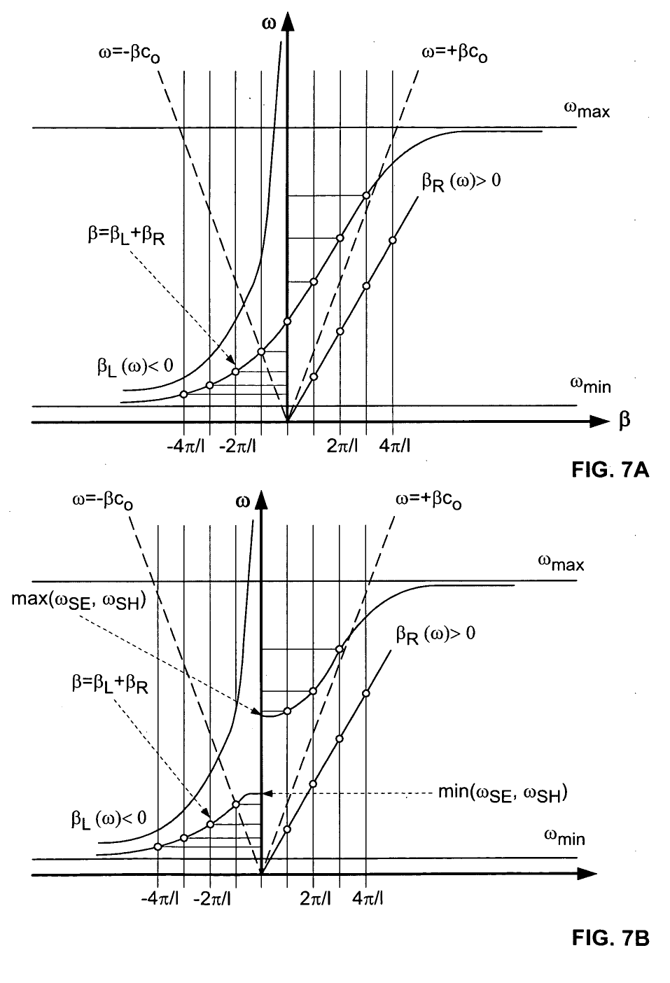

The dispersion curve β as a function of frequency ω is illustrated in FIGS. 7A and 7B for the ω_{SE}=ω_{SH} (balanced, i.e., LR CL=LL CR) and ω_{SE}≠ω_{SH} (unbalanced) cases, respectively. In the latter case, there is a frequency gap between min(ω_{SE},ω_{SH}) and max (ω_{SE},ω_{SH}). The limiting frequencies ωₘᵢₙ and ωₘₐₓ values are given by the same resonance equations in Eq. (5) with χ reaching its upper bound χ=4 as stated in the following equations:

$${ω}_{min}^{2} = \frac{{ω}_{SH}^{2} + {ω}_{SE}^{2} + 4 {ω}_{R}^{2}}{2} - \sqrt{\begin{matrix}{( \frac{{ω}_{SH}^{2} + {ω}_{SE}^{2} + 4 {ω}_{R}^{2}}{2} )}^{2} - \\ {ω}_{SH}^{2} {ω}_{SE}^{2}\end{matrix}} \\ {ω}_{max}^{2} = \frac{{ω}_{SH}^{2} + {ω}_{SE}^{2} + 4 {ω}_{R}^{2}}{2} - \sqrt{\begin{matrix}{( \frac{{ω}_{SH}^{2} + {ω}_{SE}^{2} + 4 {ω}_{R}^{2}}{2} )}^{2} - \\ {ω}_{SH}^{2} {ω}_{SE}^{2}\end{matrix}} \qquad Eq . ( 6 )$$

In addition, FIGS. 7A and 7B provide examples of the resonance position along the dispersion curves. In the RH region (n>0) the structure size 1=Np, where p is the cell size, increases with decreasing frequency. In contrast, in the LH region, lower frequencies are reached with smaller values of Np, hence size reduction. The dispersion curves provide some indication of the bandwidth around these resonances. For instance, LH resonances have the narrow bandwidth because the dispersion curves are almost flat. In the RH region, the bandwidth is wider because the dispersion curves are steeper. Thus, the first condition to obtain broadbands, 1^{st} BB condition, can be expressed as follows:

$$COND 1 \text{:} {1}^{st} B B condition {\vert \frac{d β}{d ω} \vert}_{res} = {\vert - \frac{\frac{d ( AN )}{d ω}}{\sqrt{( 1 - {AN}^{2} )}} \vert}_{res} << 1 near ω = {ω}_{res} = {ω}_{0} , {ω}_{\pm 1} , {ω}_{\pm 2} … \\ ⇒ \vert \frac{d β}{d ω} \vert = {\vert \frac{\frac{d χ}{d ω}}{2 p \sqrt{χ ( 1 - \frac{χ}{4} )}} \vert}_{res} << 1 with p = cell size and \frac{d χ}{d ω} {\vert}_{res} = \frac{2 {ω}_{\pm n}}{{ω}_{R}^{2}} ( 1 - \frac{{ω}_{SE}^{2} {ω}_{SH}^{2}}{{ω}_{\pm n}^{4}} ) , \qquad Eq . ( 7 )$$

where χ is given in Eq. (4) and ω_{R} is defined in Eq. (1). The dispersion relation in Eq. (4) indicates that resonances occur when |AN|=1, which leads to a zero denominator in the 1^{st} BB condition (COND1) of Eq. (7). As a reminder, AN is the first transmission matrix entry of the N identical unit cells (FIG. 4B and FIG. 6B). The calculation shows that COND1 is indeed independent of N and given by the second equation in Eq. (7). It is the values of the numerator and χ at resonances, which are shown in Table 1, that define the slopes of the dispersion curves, and hence possible bandwidths. Targeted structures are at most Np=λ/40 in size with the bandwidth exceeding 4%. For structures with small cell sizes p, Eq. (7) indicates that high ω_{R} values satisfy COND1, i.e., low CR and LR values, since for n<0 resonances occur at χ values near 4 in Table 1, in other terms (1−χ/4→0).

As previously indicated, once the dispersion curve slopes have steep values, then the next step is to identify suitable matching. Ideal matching impedances have fixed values and may not require large matching network footprints. Here, the word “matching impedance” refers to a feed line and termination in the case of a single side feed such as in antennas. To analyze an input/output matching network, Zin and Zout can be computed for the TL circuit in FIG. 4B. Since the network in FIG. 3 is symmetric, it is straightforward to demonstrate that Zin=Zout. It can be demonstrated that Zin is independent of N as indicated in the equation below:

$${Zin}^{2} = \frac{BN}{CN} = \frac{B 1}{C 1} = \frac{Z}{Y} ( 1 - \frac{χ}{4} ) , \qquad Eq . ( 8 )$$

which has only positive real values. One reason that B1/C1 is greater than zero is due to the condition of ═AN|≦1 in Eq. (4), which leads to the following impedance condition:

0≦−ZY=χ≦4.

The 2^{nd} broadband (BB) condition is for Zin to slightly vary with frequency near resonances in order to maintain constant matching. Remember that the real input impedance Zin′ includes a contribution from the CL series capacitance as stated in Eq. (3). The 2^{nd} BB condition is given below:

$$COND 2 \text{:} {2}^{ed} B B condition \text{:} near resonances , \\ \frac{d Zin}{d ω} {\vert}_{near res} << 1. \qquad Eq . ( 9 )$$

Different from the transmission line example in FIG. 2 and FIG. 3, antenna designs have an open-ended side with an infinite impedance which poorly matches the structure edge impedance. The capacitance termination is given by the equation below:

$${Z}_{T} = \frac{AN}{CN} , \qquad Eq . ( 10 )$$

which depends on N and is purely imaginary. Since LH resonances are typically narrower than RH resonances, selected matching values are closer to the ones derived in the n<0 region than the n>0 region.

One method to increase the bandwidth of LH resonances is to reduce the shunt capacitor CR. This reduction can lead to higher ω_{R} values of steeper dispersion curves as explained in Eq. (7). There are various methods of decreasing CR, including but not limited to: 1) increasing substrate thickness, 2) reducing the cell patch area, 3) reducing the ground area under the top cell patch, resulting in a “truncated ground,” or combinations of the above techniques.

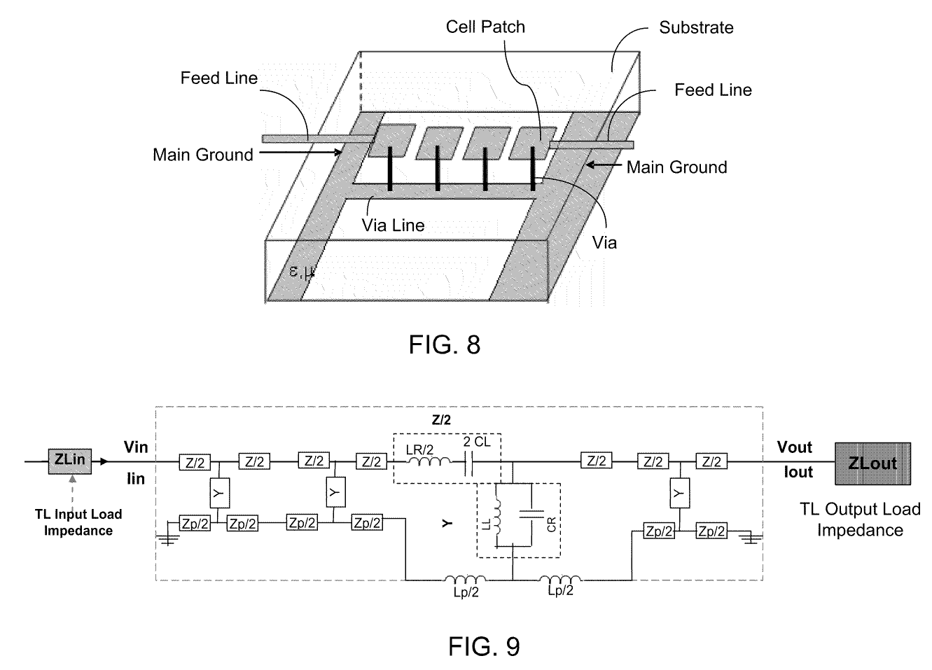

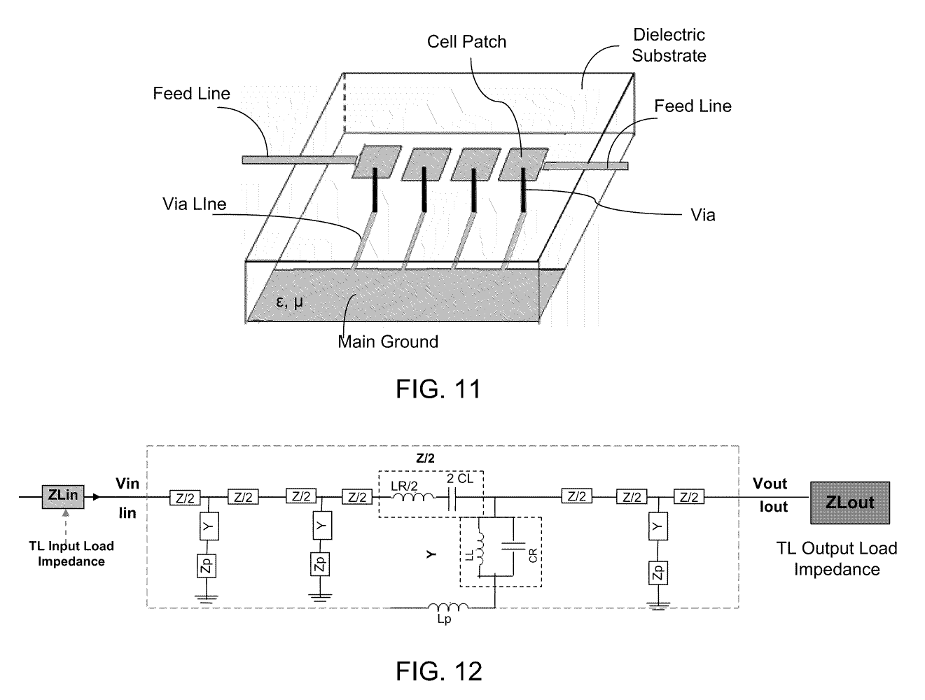

The MTM TL and antenna structures in FIGS. 1 and 5 use a conductive layer to cover the entire bottom surface of the substrate as the full ground electrode. A truncated ground electrode that has been patterned to expose one or more portions of the substrate surface can be used to reduce the area of the ground electrode to less than that of the full substrate surface. This can increase the resonant bandwidth and tune the resonant frequency. Two examples of a truncated ground structure are discussed with reference to FIGS. 8 and 11, where the amount of the ground electrode in the area in the footprint of a cell patch on the ground electrode side of the substrate has been reduced, and a remaining strip line (via line) is used to connect the via of the cell patch to a main ground electrode outside the footprint of the cell patch. This truncated ground approach may be implemented in various configurations to achieve broadband resonances.

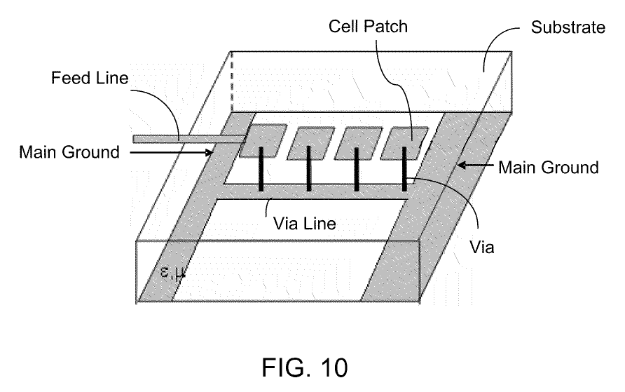

FIG. 8 illustrates one example of a truncated ground electrode for a four-cell MTM transmission line where the ground electrode has a dimension that is less than the cell patch along one direction underneath the cell patch. The ground conductive layer includes a via line that is connected to the vias and passes through underneath the cell patches. The via line has a width that is less than a dimension of the cell path of each unit cell. The use of a truncated ground may be a preferred choice over other methods in implementations of commercial devices where the substrate thickness cannot be increased or the cell patch area cannot be reduced because of the associated decrease in antenna efficiencies. When the ground is truncated, another inductor Lp (FIG. 9) is introduced by the metallization strip (via line) that connects the vias to the main ground as illustrated in FIG. 8. FIG. 10 shows a four-cell antenna counterpart with the truncated ground analogous to the TL structure in FIG. 8.

FIG. 11 illustrates another example of a MTM antenna having a truncated ground structure. In this example, the ground conductive layer includes via lines and a main ground that is formed outside the footprint of the cell patches. Each via line is connected to the main ground at a first distal end and is connected to the via at a second distal end. The via line has a width that is less than a dimension of the cell path of each unit cell.

The equations for the truncated ground structure can be derived. In the truncated ground examples, the shunt capacitance CR becomes small, and the resonances follow the same equations as in Eqs. (1), (5) and (6) and Table 1. Two approaches are presented. FIGS. 8 and 9 represent the first approach, Approach 1, wherein the resonances are the same as in Eqs. (1), (5) and (6) and Table 1 after replacing LR by (LR+Lp). For |n|#0, each mode has two resonances corresponding to (1) ω_{±n} for LR being replaced by (LR+Lp) and (2) ω_{±n} for LR being replaced by (LR+Lp/N) where N is the number of unit cells. Under this Approach 1, the impedance equation becomes:

$${Zin}^{2} = \frac{BN}{CN} = \frac{B 1}{C 1} = \frac{Z}{Y} ( 1 - \frac{χ + {χ}_{P}}{4} ) \frac{( 1 - χ - {χ}_{P} )}{( 1 - χ - {χ}_{P} \text{/} N )} , \\ where χ = - YZ and χ = - {YZ}_{P} , \qquad Eq . ( 11 )$$

where Zp=jωLp and Z, Y are defined in Eq. (2). The impedance equation in Eq. (11) provides that the two resonances ω and ω′ have low and high impedances, respectively. Thus, it is easy to tune near the ω resonance in most cases.

The second approach, Approach 2, is illustrated in FIGS. 11 and 12 and the resonances are the same as in Eqs. (1), (5), and (6) and Table 1 after replacing LL by (LL+Lp). In the second approach, the combined shunt inductor (LL+Lp) increases while the shunt capacitor CR decreases, which leads to lower LH frequencies.

The above exemplary MTM structures are formed in two metallization layers, and one of the two metallization layers is used to include the ground electrode and is connected to the other metallization layer by conductive vias. Such two-layer CRLH MTM TLs and antennas with vias can be constructed with a full ground electrode as shown in FIGS. 1 and 5 or a truncated ground electrode as shown in FIGS. 8, 10 and 11.

Variations in the MTM structure can be introduced to comply with PCB real-estate factors, device performance requirements and other specifications. Examples of various MTM antenna structures with at least one via interconnecting conductive components on two different metallization layers are described below. The cell patch can have a variety of geometrical shapes and dimensions such as but not limited to rectangular, polygonal, irregular, circular, oval, or combination of different shapes. The via line and the feed line can have a variety of geometrical shapes and dimensions such as but not limited to rectangular, polygonal, irregular, zigzag, spiral, meander or combination of different shapes. A launch pad can be added at the distal end of the feed line to enhance coupling. The launch pad can have a variety of geometrical shapes and dimensions such as but not limited to rectangular, polygonal, irregular, circular, oval, or combination of different shapes. The gap between the launch pad and cell patch can take a variety of forms such as but not limited to straight line, curved line, L-shaped line, zigzag line, discontinuous line, enclosing line, or combination of different forms. Some of the feed line, launch pad, cell patch and via line can be formed in different layers from the others. Some of the feed line, launch pad, cell patch and via line can be extended to a different layer. The antenna portion can be placed a few millimeters above the main substrate. A non-planar substrate can be used to accommodate various parts in different planes for footprint reduction. Multiple cells may be cascaded in series creating a multi-cell 1D structure. Multiple cells may be cascaded in orthogonal directions generating a 2D structure. A single feed line may be configured to deliver power to multiple cell patches. An additional conductive line may be added to the feed line or launch pad. This additional conductive line can have a variety of geometrical shapes and dimensions such as but not limited to rectangular, irregular, zigzag, spiral, meander, or combination of different shapes, and can be placed in the top, mid or bottom layer, or a few millimeters above the substrate.

The multilayer MTM antenna structures described in this document can be configured to generate multiple frequency bands including a “low band” and a “high band.” The low band includes at least one left-handed (LH) mode resonance and the high band includes at least one right-handed (RH) mode resonance. The present device structures can be implemented to use a LH mode to excite and better match the low frequency resonances as well as improve impedance matching at high frequency resonances. Identification of the LH mode can be made by observing that the LH mode resonance disappears from the input impedance and return loss when one of the following techniques is used: (i) the gap between the launch pad and cell patch is closed, which corresponds to an inductively loaded monopole antenna; (ii) the via line connecting the cell patch to the ground electrode is removed; and (iii) the via line is removed and the gap is closed, which provides a printed monopole resonance.

The MTM antennas described in this document can be designed to operate in various bands, including frequency bands for cell phone and mobile device applications, WiFi applications, WiMax applications and other wireless communication applications. Examples of the frequency bands for cell phone and mobile device applications are: the cellular band (824-960 MHz) which includes two bands, CDMA (824-894 MHz) and GSM (880-960 MHz) bands; and the PCS/DCS band (1710-2170 MHz) which includes three bands, DCS (1710-1880 MHz), PCS (1850-1990 MHz) and AWS/WCDMA (2110-2170 MHz) bands. A quad-band antenna can be used to cover one of the CDMA and GSM bands in the cellular band and all three bands in the PCS/DCS band. A penta-band antenna can be used to cover all five bands with two in the cellular band and three in the PCS/DCS band. Examples of frequency bands for WiFi applications include two bands: one ranging from 2.4 to 2.48 GHz, and the other ranging from 5.15 GHz to 5.835 GHz. The frequency bands for WiMax applications involve three bands: 2.3-2.4 GHZ, 2.5-2.7 GHZ, and 3.5-3.8 GHz.

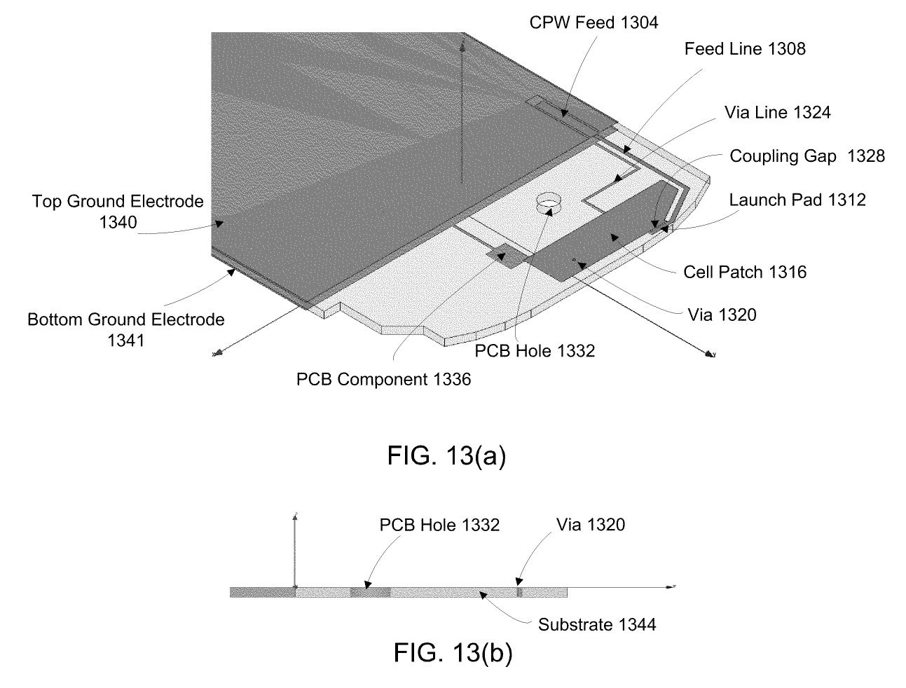

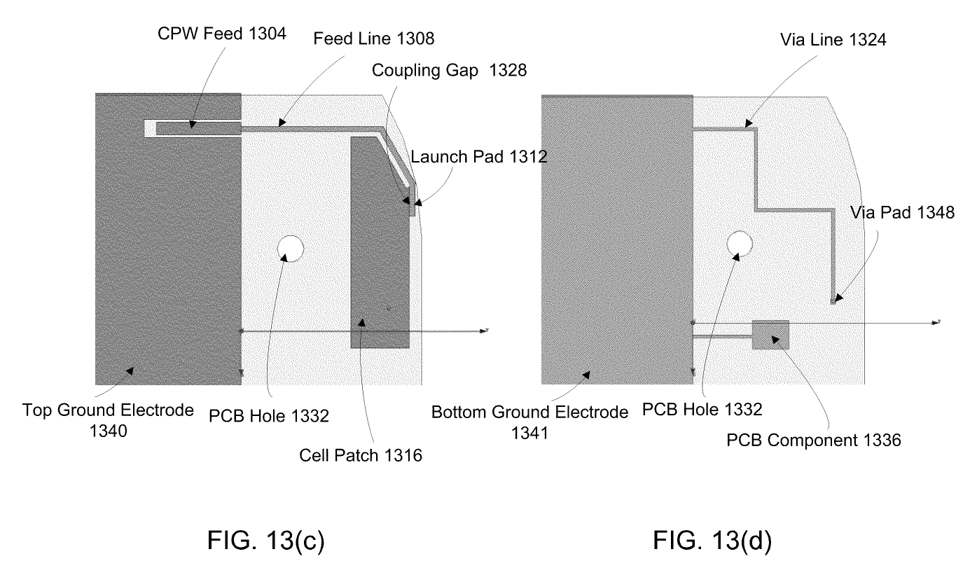

FIGS. 13(a)-13(d) show an example of a one-cell two-layer MTM antenna with a conductive via connecting the two metallization layers, illustrating the 3D view, side view, top view of the top metallization layer and top view of the bottom metallization layer, respectively. The top metallization layer is formed on the top surface of a substrate 1344 and is patterned to form some elements of the one-cell two-layer MTM antenna and a top ground electrode 1340. The bottom metallization layer is formed on the bottom surface of the substrate 1344 and is patterned to form other elements of the one-cell two-layer MTM antenna and a bottom ground electrode 1341. A via 1320 penetrates through the substrate 1344 and connects the top and bottom metallization layers.

More specifically, the top and bottom metallization layers are patterned into various metal parts for the MTM antenna: the top ground electrode 1340, the bottom ground electrode 1341, a cell patch 1316 which is spaced from the top ground electrode 1340, a launch pad 1312 separate from the cell patch 1316 by a coupling gap 1328, the via 1320 connecting the cell patch 1316 to a via pad 1348 on the bottom metallization layer, and a via line 1324 that connects the bottom ground electrode 1324 to the via pad 1348 and hence to the cell patch 1316. A feed line 1308 is formed in the top metallization layer and is connected to the launch pad 1304 to direct a signal to or receive a signal from the cell patch 1316 through the coupling gap 1328. The locations of a PCB hole 1332 and a PCB component 1336 are indicated also in the figures for reference. The width of the coupling gap 1328 can be set based on the design, such as a few mils in one implementation.

The top ground electrode 1340 is formed above the bottom ground electrode 1341 so that a co-planer waveguide (CPW) feed 1304 can be formed in the top electrode ground 1340. This CPW feed 1304 is connected to the feed line 1308 to deliver power. Therefore, in this example, the CPW ground is formed by the top and bottom ground electrodes 1340 and 1341. Alternatively, the antenna can be fed with a CPW feed that does not require a ground plane on a different layer, a probed patch or a cable connector.

In the illustrated example, the cell patch 1316 formed in the top metallization layer is located above the portion of the bottom surface that includes the via pad 1348 and the via line 1324 and is not above the bottom ground electrode 1341. Thus, this one-cell two-layer MTM antenna structure has the shunt capacitance CR with a small value associated with the cell patch 1308 in the top metallization layer and the via pad 1348 and via line 1324 in the bottom metallization layer. This MTM antenna structure also has the shunt inductance LL associated with the via 1320, and the series inductance Lp associated with the via line 1324. Therefore, this structure has a truncated ground electrode and does not use a full ground electrode plane. Some examples of MTM structure with a truncated ground electrode are shown in FIGS. 8, 10 and 11. The equivalent circuit for this one-cell two-layer MTM structure shown in FIGS. 13(a)-13(d) is similar to the one-cell antenna version of the equivalent circuit shown in FIG. 12.

Table 2 provides a summary of the elements of the one-cell two-layer MTM antenna structure with a via shown in FIGS. 13(a)-13(d).

TABLE 2

| Parameter | Description | | Location |
|---|---|---|---|
| Antenna | Each antenna element comprises a Cell coupled | | |
| Element | to a CPW Feed 1304 through a Launch Pad 1312 | | |
| | and a Feed Line 1308. | | |
| Feed Line | Connects the Launch Pad 1312 to the CPW Feed | | Top Layer |
| | 1304. | | |
| Launch | Rectangular shape that connects a Cell Patch | | Top Layer |
| Pad | 1316 to the Feed Line 1308. There is a | | |
| | Coupling Gap 1328 between the Launch Pad 1312 | | |
| | and Cell Patch 1316. | | |
| Cell | Cell Patch | Rectangular shape with a cutout at | Top Layer |
| | | one corner. | |
| | Via | Cylindrical shape that connects | |
| | | the Cell Patch 1316 to a Via Pad | |
| | | 1348. | |
| | Via Pad | Small square pad that connects the | Bottom |
| | | bottom part of the Via 1320 to a | Layer |
| | | Via Line 1324. | |
| | Via Line | Line that connects the Via Pad | Bottom |
| | | 1348, hence the Cell patch 1316, | Layer |
| | | to a Bottom Ground Electrode 1341. | |

The one-cell two-layer MTM antenna structure with a via shown in FIGS. 13(a)-13(d) can be implemented for various applications. For example, design parameters associated with this structure specifically for quad-band cell phone applications can be selected as follows: the feed line 1308 is 0.5 mm×14 mm; the launch pad 1312 is 0.5 mm×10 mm; the cell patch is 5.5 mm×20 mm; the via line 1324 has 0.3 mm in width and 17 mm in length; the gap width between the launch pad 1312 and the cell patch 1316 is 0.1 mm; the substrate 1344 is 1 mm thick, and the material is FR4 with a dielectric constant of 4.4; and the antenna covers an area of 17 mm×24 mm. The launch pad 1312 and the cell patch 1316 are shaped so as to maximize the utilization of space available for the antenna. With these optimized design parameters, this MTM antenna provides good matching in both the GSM band (880-960 MHz) and the PCS/DCS band (1710-2170 MHz).

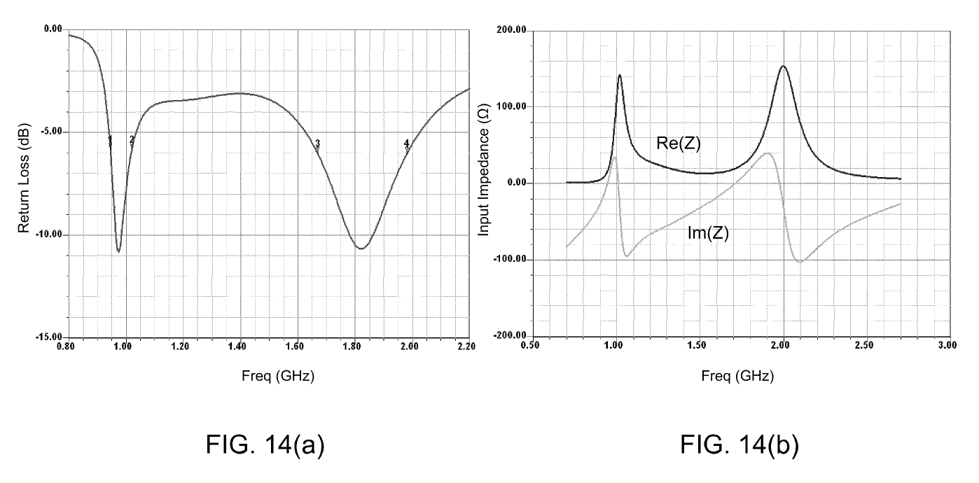

The HFSS EM simulation software is used to simulate the antenna performance with the above parameter values. Both the simulated return loss in FIG. 14(a) and the simulated input impedance in FIG. 14(b) show good matching in the two frequency bands. The four points representing the widths of the two bands are: 1(0.94 GHz, −5.86 dB), 2(1.02 GHZ, −5.84 dB), 3(1.87 GHz, −6.04 dB) and 4(1.98 GHz, −6.05 dB), as denoted in FIG. 14(a). The low band includes at least one LH mode resonance and the high band includes RH mode resonances.

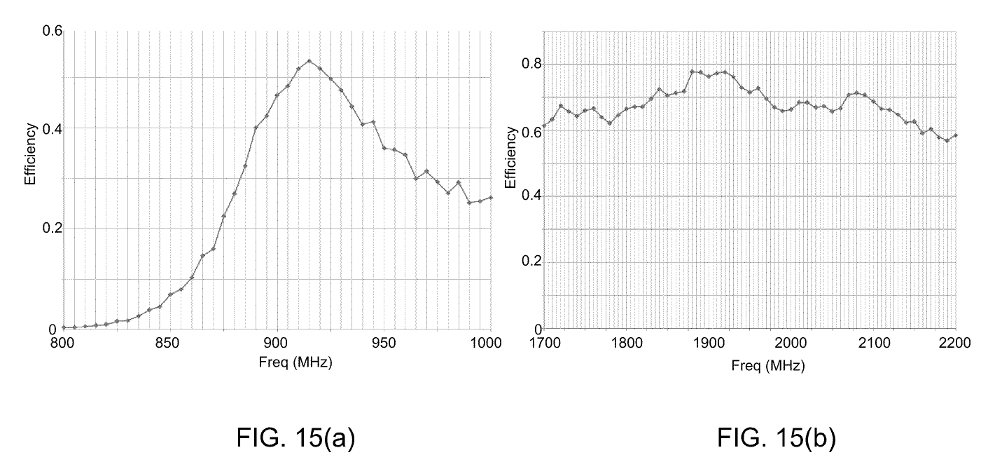

Some samples are fabricated and characterized by measurements. The measured efficiency of a fabricated sample is shown in FIGS. 15(a) and 15(b) for the GSM band and the PCS/DCS band, respectively. The fabricated antenna with the above design parameters shows high efficiency peaking at 52% in the GSM band and 78% in the PCS/DCS band.

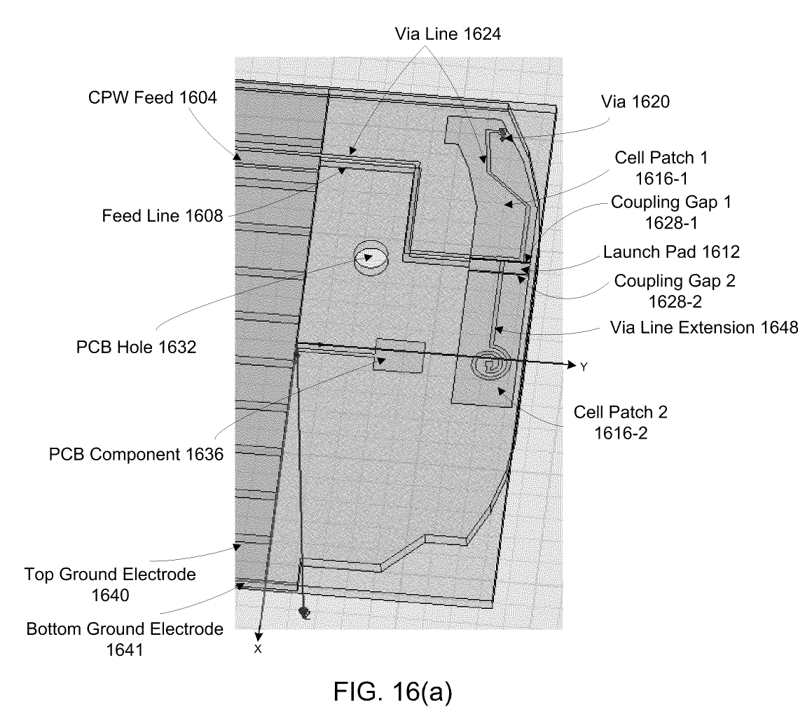

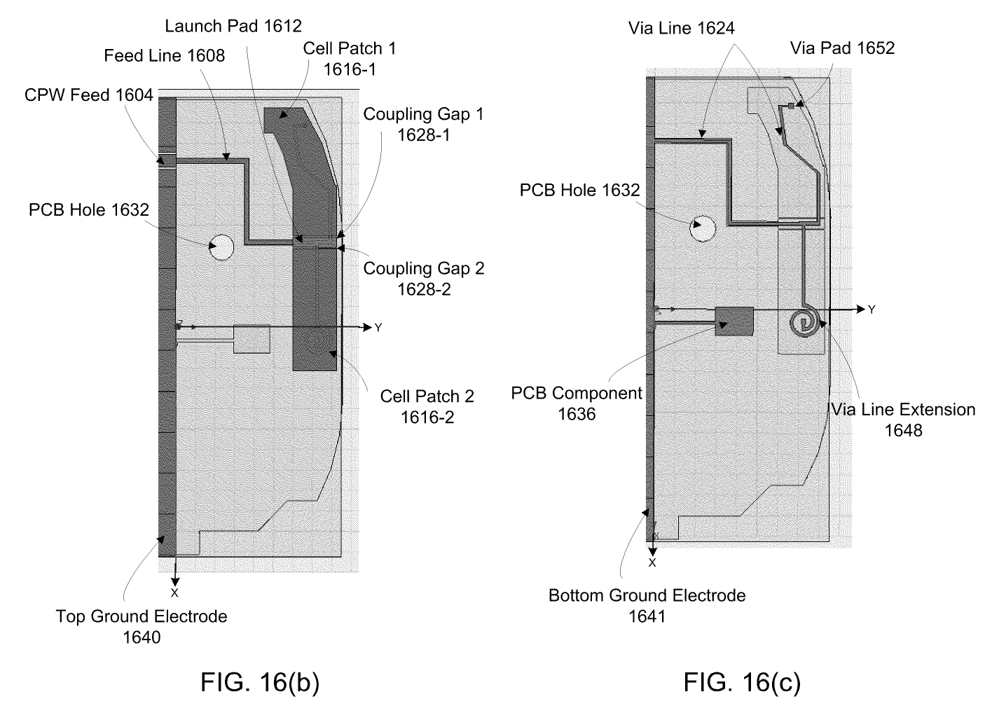

The above one-cell two-layer MTM antenna structure with at least one via can be extended to include two or more cell patches. FIGS. 16(a)-16(c) shows an example of a two-cell two-layer MTM antenna structure with a via in three different views: the 3D view, top view of the top layer and top view of the bottom layer, respectively. Two cell patches 1 and 2, 1616-1 and 1616-2, are formed in the top metallization layer and are separated from each other. A common launch pad 1612 is formed between and is shared by the two cell patches 1616-1 and 1616-2. The common launch pad 1612 is separated from the cell patch 1616-1 by a coupling gap 1626-1 and from the cell patch 1616-2 by a coupling gap 1626-2 to allow electromagnetic coupling between the two patches and the launch pad 1612 to direct a transmission antenna signal to or to receive antenna signals from the two cell patches 1616-1 and 1616-2 . A common feed line 1608 is formed in the top metallization layer to connect with the common launch pad 1612 to conduct the transmission antenna signal or the received antenna signals. A via 1620 is formed in the substrate and connects the cell patch 1 (1616-1), which is a main cell patch, in the top metallization layer to a via pad 1652 in the bottom metallization layer. The via pad 1652 is connected to a bottom ground electrode 1641 by a via line 1624 in the bottom metallization layer. The cell patch 2 (1616-2) is a secondary cell patch. The via line 1624 is extended below the cell patch 2 (1616-2), providing a via line extension 1648 which includes a conductive line portion that connects to the via line 1624 and an end portion located underneath the cell patch 2 (1616-2) to provide capacitive coupling to the cell patch 2 (1616-2), without having a via directly connecting to the cell patch 2 (1616-2) in the top metallization layer. The via line extension 1648 can be made with various shapes, lengths and sizes. In the exemplary structure shown in FIGS. 16(a)-16(c), the end portion of the via line extension 1648 has a spiral portion located underneath the rectangular secondary cell patch 2 (1616-2). The locations of a PCB hole 1632 and a PCB component 1636 are indicated also in the figures for reference.

The monopole resonance frequency of this antenna can be controlled by the total length of the feed line, launch pad and cell patch combined. The longer the total length is, the lower the resonance frequency is. For example, the position of the feed line 1608 can be moved away from the cell patch 1 (1616-1) to improve matching, adjust bandwidth, and lower the low-band center frequency. Furthermore, by having the secondary cell patch, a second monopole mode can be generated at a low frequency. The secondary cell patch may be directly connected to the launch pad resulting in a large launch pad. Therefore, this low-frequency monopole resonance that can be mainly controlled by the total length of the feed line 1604, launch pad 1612, and cell patches 1616-1 and 1616-2 can be tuned to a frequency region close to the LH-mode resonance frequency so that the two modes can be combined to create a low-frequency wide-band resonance. This resultant low-frequency wide-band resonance is referred to as a combined monopole-mode and LH-mode resonance in this document. The penta-band coverage for cell phone applications can thus be achieved based on this scheme of generating both the monopole and LH modes close enough to be combined to support the cellular band (824-960 MHz) with a bandwidth of approximately 150 MHz. The via line extension 1648, which has a spiral shape formed directly below the cell patch 2 1616-2, serves to further improve matching in this example.

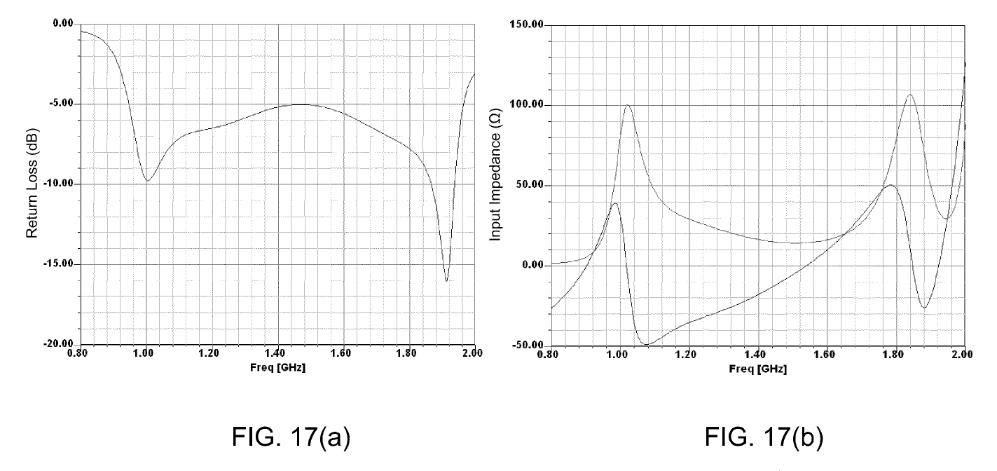

FIGS. 17(a) and 17(b) show the simulated return loss and input impedance of the two-cell two-layer MTM antenna with a via in FIGS. 16(a)-16(c), respectively. The design parameters are determined by following the same board and performance specifications as in the previous one-cell two-layer MTM example. It can be seen from FIGS. 17(a) and 17(b) that the LH mode near 1 GHz and the first monopole mode near 1.2 GHz couple with each other, thereby creating the wide low band centered around 1 GHz with a bandwidth of about 300 MHz (the combined monopole-mode and LH-mode resonance) and that the RH mode and the second monopole mode couple each other, creating the wide high band centered around 1.9 GHz with a bandwidth of about 300 MHz.

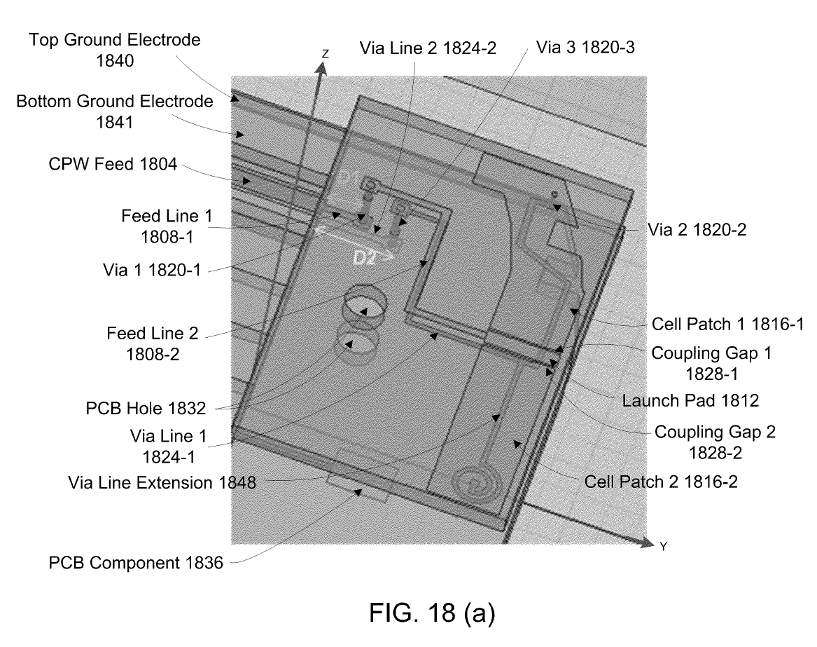

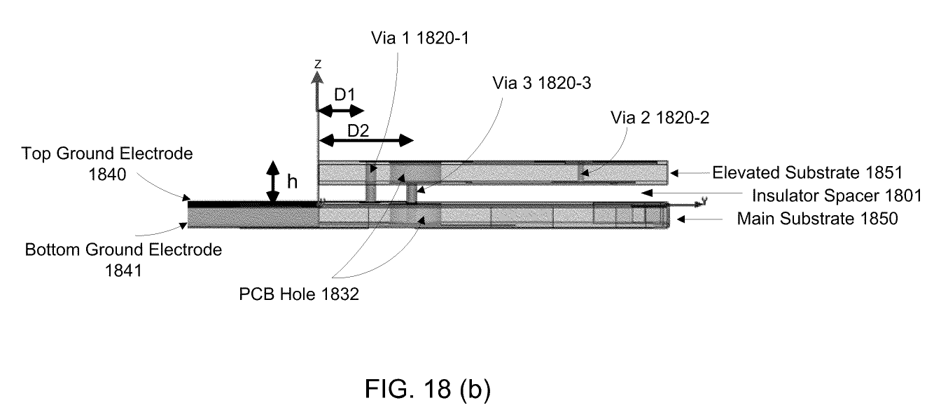

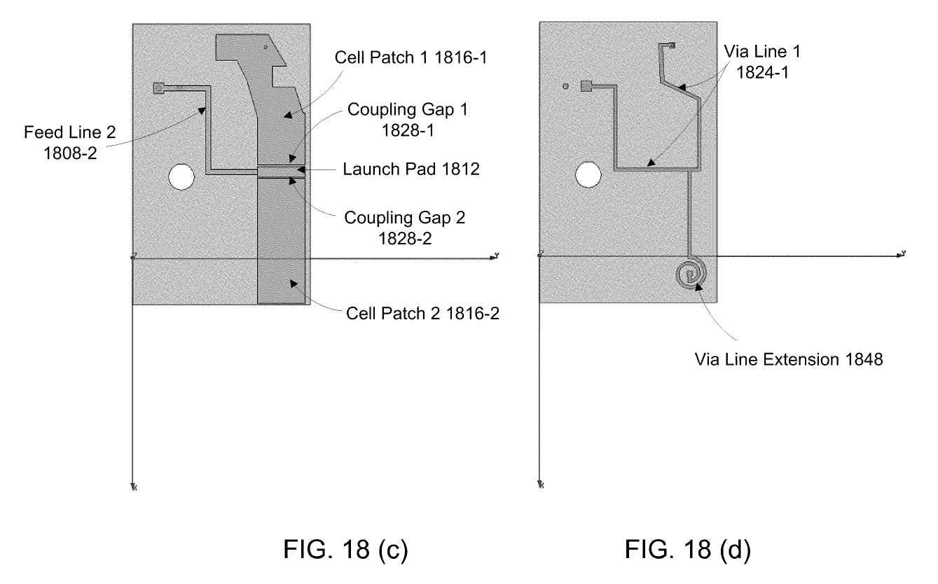

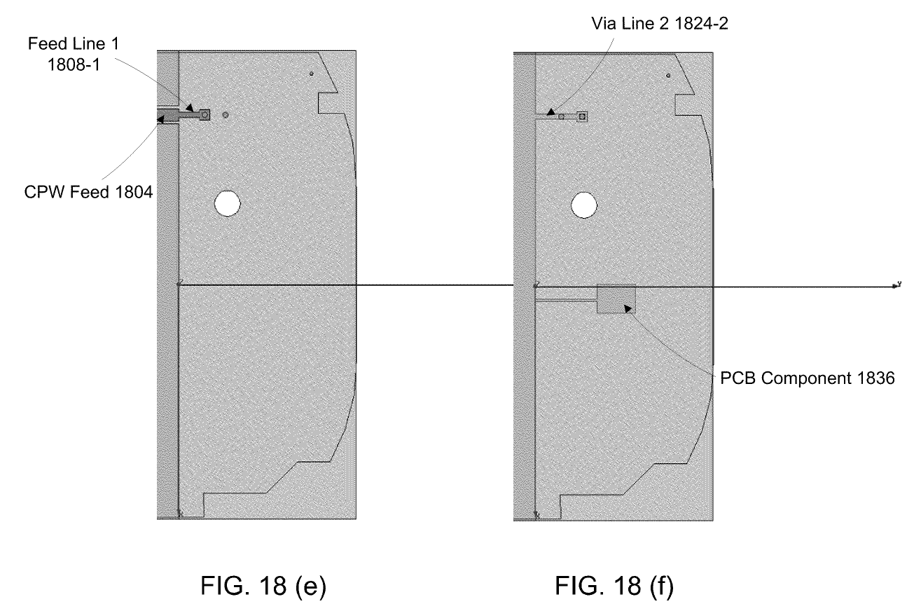

In some applications, it may be desirable to increase the separation between the antenna and the main PCB. One of reasons for doing this is to avoid interference between the antenna and components. The separation can be increased by physically moving the antenna along the Z-direction perpendicular to the main substrate plane. This may be achieved by using two different substrates with one for forming the MTM antenna and the other for forming the main PCB. The two substrates are stacked over each other and separated by a middle dielectric insulation layer. An example of such an MTM structure with an elevated antenna portion at height h with respect to the main substrate plane is illustrated in FIGS. 18(a)-18(f), showing the 3D view, side view, top view of the top layer of the elevated substrate 1851, top view of the bottom layer of the elevated substrate 1851, top view of the top layer of the main substrate 1850, and top view of the bottom layer of the main substrate 1850. A dielectric spacer 1801 can be sandwiched between the two substrates 1851 and 1850 or can be left open. The substrate 1850 is structured as the main PCB and the substrate 1851 is structured to form the MTM antenna. To a certain extent, this structure is similar to the two-cell two-layer MTM structure shown in FIGS. 16(a)-16(c) by having two cell patches 1 and 2 sharing a common launch pad. Different from the structure in FIGS. 16(a)-16(c) elements associated with the antenna in FIGS. 18(a)-18(f) are formed on the elevated substrate 1851 while the other elements such as ground electrodes remain on the main substrate 1850.

In FIGS. 18(a)-18(f), the feed line is split into a first portion on the top surface of the main substrate 1850 and a second portion on the top surface of the elevated substrate 1851. These feed line portions are referred to as a feed line 1 (1808-1) and a feed line 2 (1808-2), respectively, and are connected by a via 1 (1820-1) that penetrates through the spacer 1801 and the elevated substrate 1851 from the top surface of the main substrate 1850 to the top surface of the elevated substrate 1851. The bottom end of this via 1 (1820-1) is located at a distance D1 from the edge of the top ground electrode 1840. The via line is also split into two portions: a via line 1 (1824-1) on the bottom surface of the elevated substrate 1851 and a via line 2 (1824-2) on the bottom surface of the main substrate 1850. These two via line portions are connected by a via 3 (1820-3) that penetrates through the main substrate 1850 and the spacer 1801 from the bottom surface of the main substrate 1850 to the bottom surface of the elevated substrate 1851. The bottom end of this via 3 (1820-3) is located at a distance D2 from the edge of the bottom ground electrode 1841. A via 2 (1820-2) is formed in the elevated substrate 1851 and connects a cell patch 1 (1816-1), which is a main cell patch, on the top surface of the elevated substrate 1851 to the via line 1 (1824-1) on the bottom surface of the elevated substrate 1851. The feed line 2 (1808-2) is connected to a launch pad 1812 on the top surface of the elevated substrate 1851, which is coupled to the cell patch 1 (1816-1) through a coupling gap 1 (1828-1), to direct a signal to or receive a signal from the cell patch 1 (1816-1). A cell patch 2 (1816-2), which is a secondary cell patch, is formed on the other side of the launch pad 1812 from the cell patch 1 (1816-1) and is coupled to the launch pad 1812 through a coupling gap 2 (1828-2). Furthermore, the via line 1 (1824-1) is extended below the cell patch 2 (1816-2), providing a via line extension 1848, which does not have a via connecting to the cell patch 2 (1816-2) on the top surface of the elevated substrate 1851. The via line extension 1848 can be made with various shapes, lengths and sizes. In the exemplary structure shown in FIGS. 18(a)-18(f), the spiral via line extension 1848 is located underneath the rectangular secondary cell patch 1816-2. The locations of a PCB hole 1832 and a PCB component 1836 are indicated also in the figures for reference. The PCB component is located on the bottom surface of the main substrate 1850.

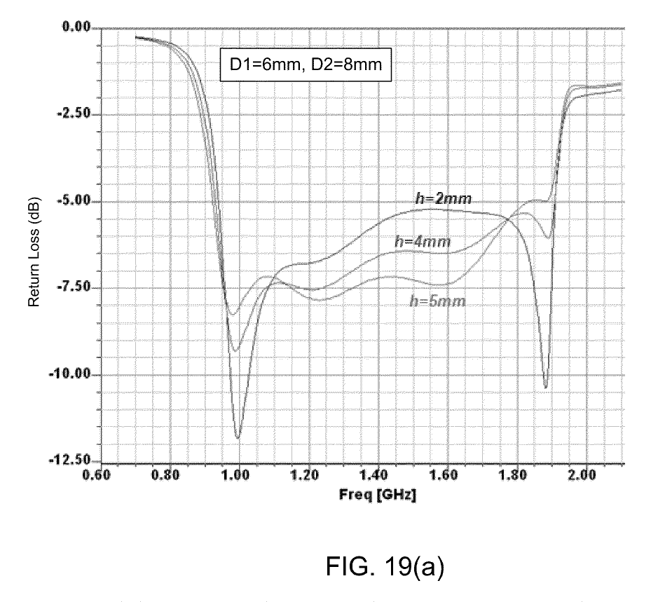

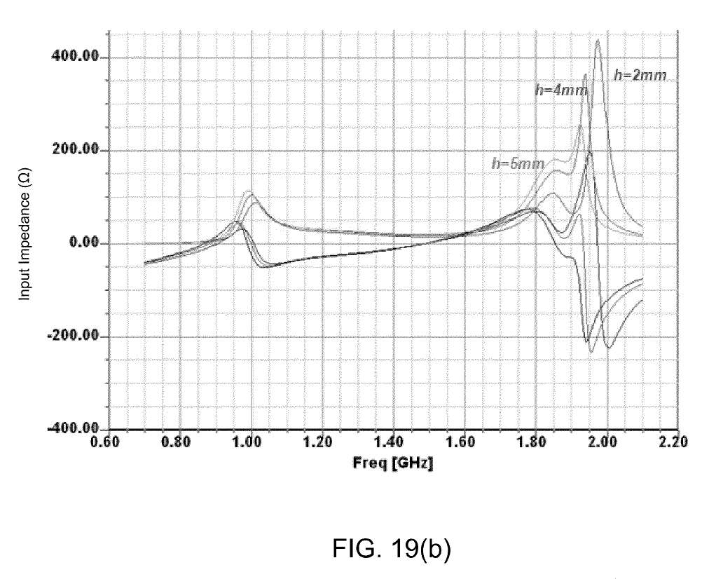

The simulated return loss and impedance of the two-cell MTM structure with the elevated antenna in FIGS. 18(a)-18(f) are shown in FIGS. 19(a) and 19(b), respectively, for three different heights of h=2 mm, 4 mm and 5 mm, for the case of D1=6 mm and D2=8 mm. It can be seen from these figures that the antenna resonates in the same bands as in the case of the two-cell two-layer MTM antenna structure shown in FIGS. 16-17. That is, the resonances are generated to support the cellular band and PCS/DCS band, but with slightly different matching. The matching in the frequency range between the center frequencies of the two bands becomes better as h increases, resulting in a very wide band at h=5 mm.

In a different implementation, the via line 2 (1824-2) may be located on the top surface of the main substrate 1850 instead of the bottom surface to terminate the via 3 (1820-3) at the top surface of the main substrate 1850, so that the via line 2 (1824-2) can be connected to the top ground electrode 1840 instead of the bottom ground electrode 1841.

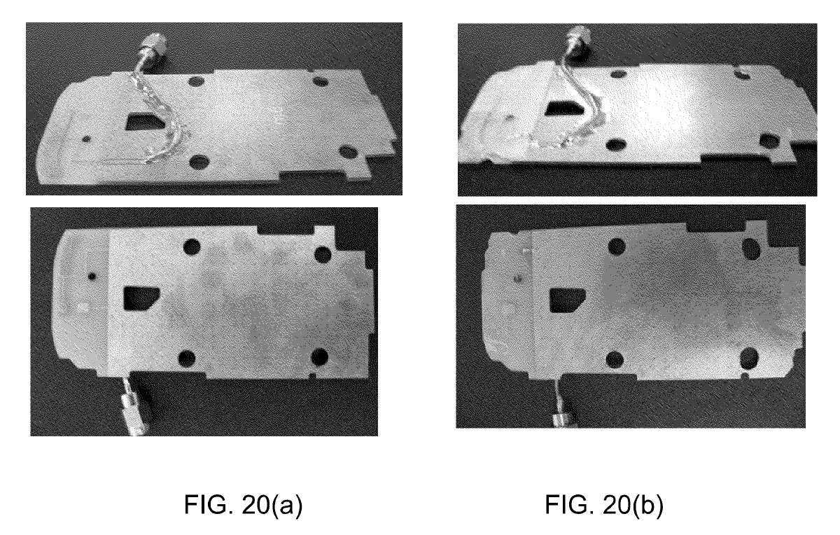

Sample antennas based on the two-cell two-layer MTM structure shown in FIGS. 16(a)-16(c), which is a planar version, and the two-cell MTM structure with the elevated antenna shown in FIGS. 18(a)-18(f), which is a 3D version, were fabricated and tested. The photos of fabricated samples of the planar version and 3D version are shown in FIGS. 20(a) and 20(b), respectively. The separation between the two substrates for the 3D version is chosen to be h=1 mm, and an air gap is used as the spacer between them in this example.

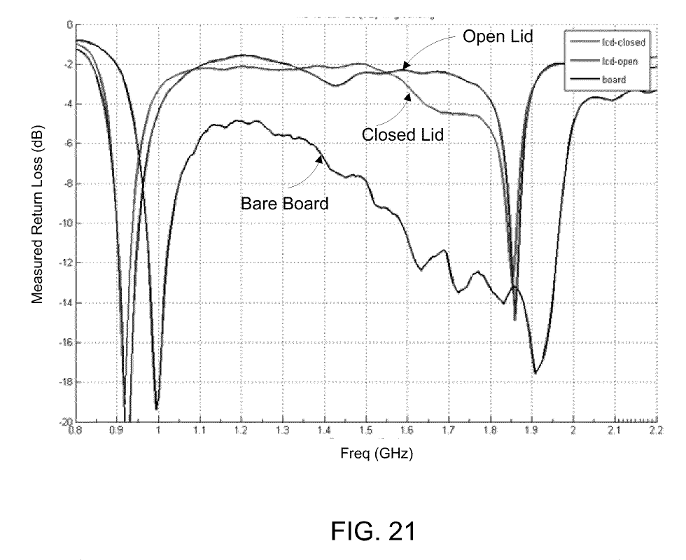

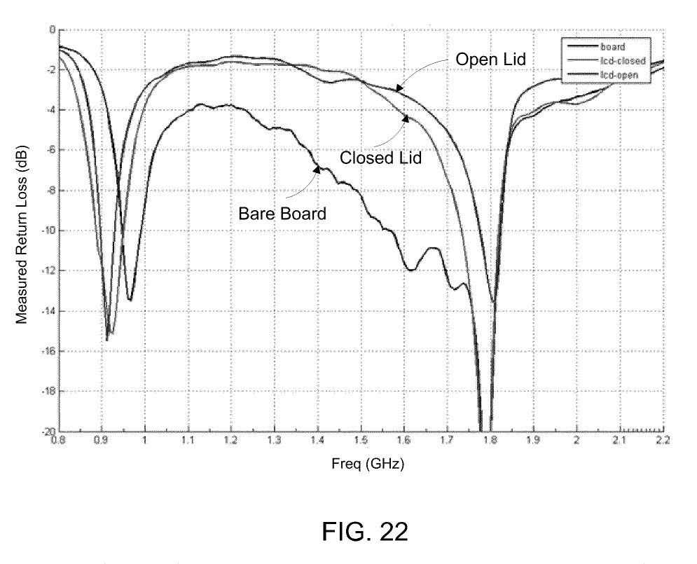

To evaluate the effect of a cell phone enclosure, each of these antennas was placed inside of a cell phone housing for measurements. FIGS. 21 and 22 show the measured return loss of the planar version and 3D version, respectively, for bare board, closed lid and open lid configurations. The measured return loss for all the cases in FIGS. 21 and 22 exhibits the two broadband resonances corresponding to the cellular band and the PSC/DCS band. However, these two bands become narrower and slightly shifted to lower frequencies when the antenna is placed inside of the cell phone housing as compared to the bare-board configuration. The measurements also indicate that the measured return loss is substantially insensitive to the open or closed lid configuration for both the planar and 3D versions. In some applications and depending on the locations of RF components on the PCB, the 3D version of an MTM antenna may exhibit better passive and active performances than its planar counterparts.

In some cell phone applications, it may be desirable to have control of the low-band bandwidth. Since the low frequency resonances of MTM antennas are excited by LH modes, the bandwidth of a low frequency resonance may be limited unless the distance between the antenna and ground is increased. However, in some situations it can be difficult or even prohibitive to increase the planar size of the antenna or the elevation of the antenna from the main substrate. In such cases, a two-port solution can be employed, where one antenna is configured to provide a low frequency resonance, thus generating a low band, and the other antenna is configured to provide a high frequency resonance, thus generating a high band. The low-band bandwidth can be widened by lowering the monopole mode resonance to be coupled with the low frequency resonance that is excited by the LH mode. The coupling between the two antennas can be decreased by widening the separation between the low band and high band in frequency.

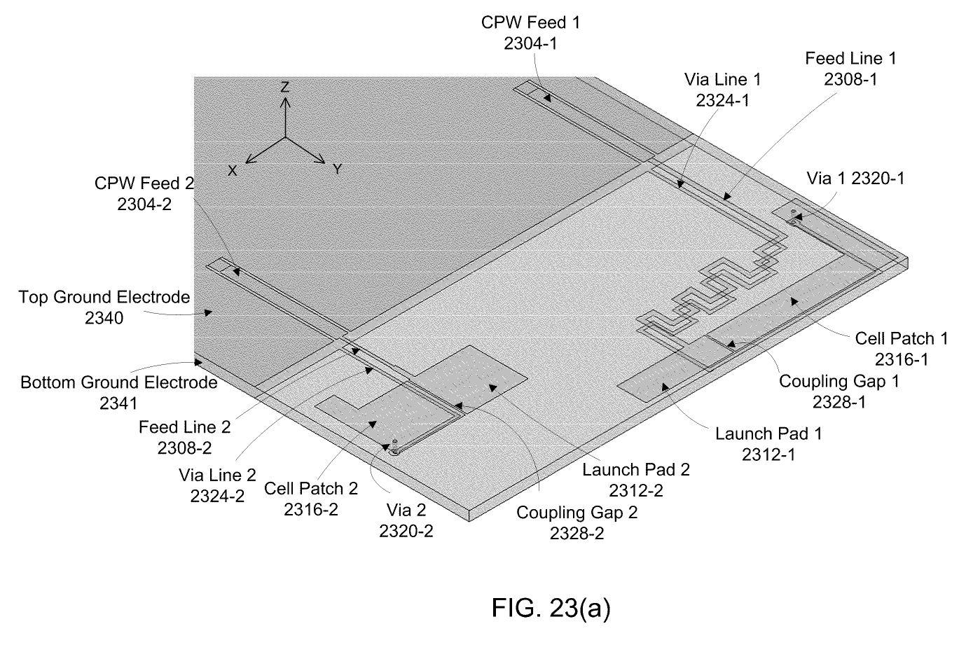

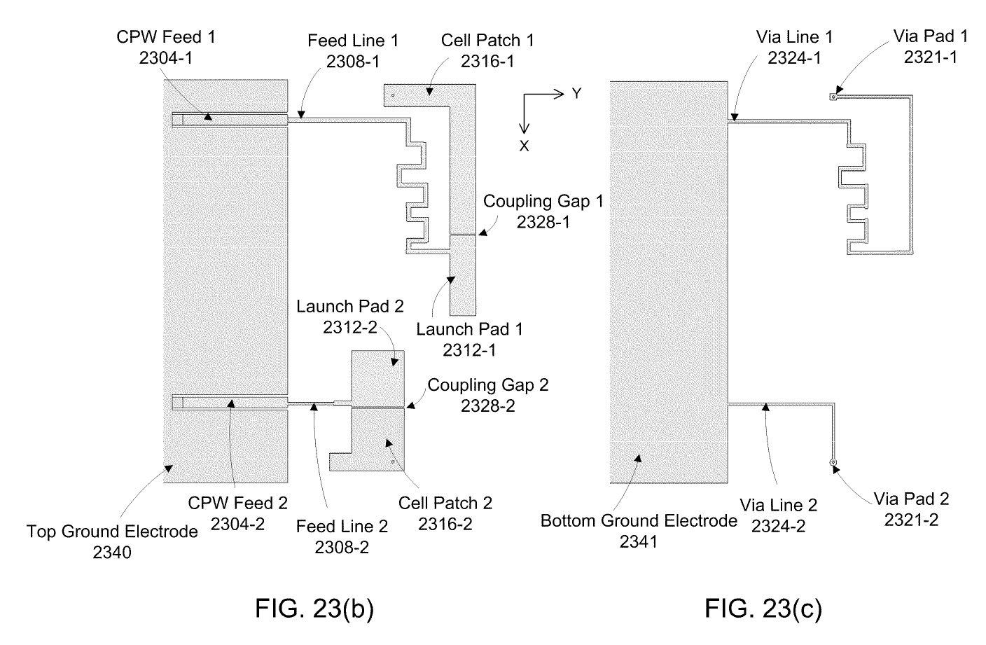

FIGS. 23(a)-23(c) show an example of a two-antenna array having one MTM antenna serving as a low-band antenna and the other serving as a high-band antenna, illustrating the 3D view, top view of the top layer and top view of the bottom layer, respectively. In this example, each of the two antennas has a single cell patch. The top metallization layer is formed on the top surface of the substrate and includes a top ground electrode 2340. The bottom metallization layer is formed on the bottom surface of the substrate and includes a bottom ground electrode 2341. The top ground electrode 2340 is formed above the bottom ground electrode 2341 so that a CPW feed 1 (2304-1) and CPW feed 2 (2304-2) can be formed in the top electrode ground 2340. Therefore, in this example, the CPW ground is formed by the top and bottom ground electrodes 2340 and 2341. The low-band and high-band MTM antennas are formed with separate ports coupled to the CPW feed 1 (2304-1) and CPW feed 2 (2304-2), respectively.

The high-band MTM antenna structure is similar to the previous example of the one-cell two-layer MTM antenna structure with a via shown in FIGS. 13(a)-13(d) and individual elements are sized and shaped differently for the high-band matching and tuning. The CPW feed 2 (2304-2) is coupled to a feed line 2 (2308-2) and a launch pad 2 (2312-2) to direct a signal to or receive a signal from a cell patch 2 (2316-2) through a coupling gap 2 (2328-2). A via 2 (2320-2) connects the cell patch 2 (2316-2) to a via pad 2 (2321-2) on the bottom surface, and a via line 2 (2324-2) connects the bottom ground electrode 2341 and the via pad 2 (2321-2).

The low-band MTM antenna structure is also similar to the previous example of the one-cell two-layer MTM antenna structure with a via shown in FIGS. 13(a)-13(d) and individual elements are sized and shaped for the low-band matching and tuning. In particular, a feed line (2308-1) has a longer length with several bends to lower the monopole mode resonance to a low frequency region. A via line 1 (2324-1) is patterned to follow the shape of the feed line 1 (2308-1) in this example. However, the via line 1 (2324-1) can take various other shapes and sizes without significantly affecting the antenna performance.

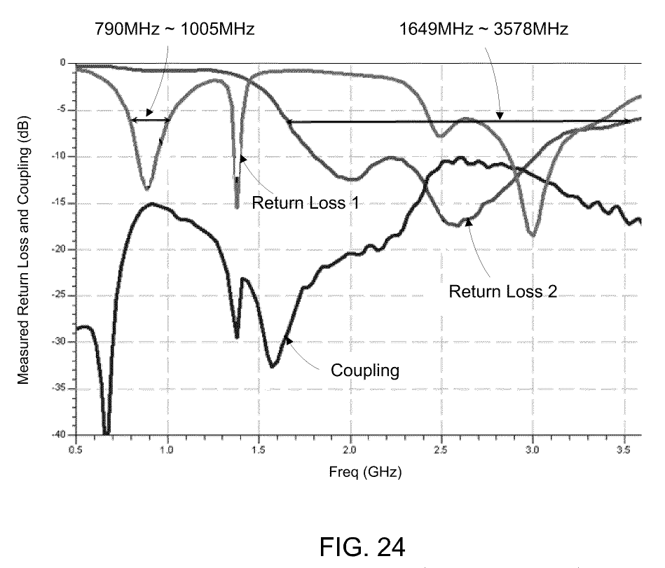

Samples of the two-antenna array having the low-band MTM antenna and high-band MTM antenna were fabricated and are illustrated in FIGS. 23(a)-23(c). The measured return loss and coupling are shown in FIG. 24. The return loss 2 of the high-band antenna exhibits a broad high band ranging from 1649 MHz to 3578 MHz at the −6 dB return loss. The return loss 1 of the low-band antenna has the monopole mode resonance around 1.3 GHz, which is coupled to the LH mode resonance (the combined monopole-mode and LH-mode resonance) to generate a broad low band ranging from 790 MHz to 1005 MHz at the −6 dB return loss. Thus, the two-antenna array having the low-band MTM antenna and high-band MTM antenna in this example provides the capability of covering the penta-band for cell phone applications.

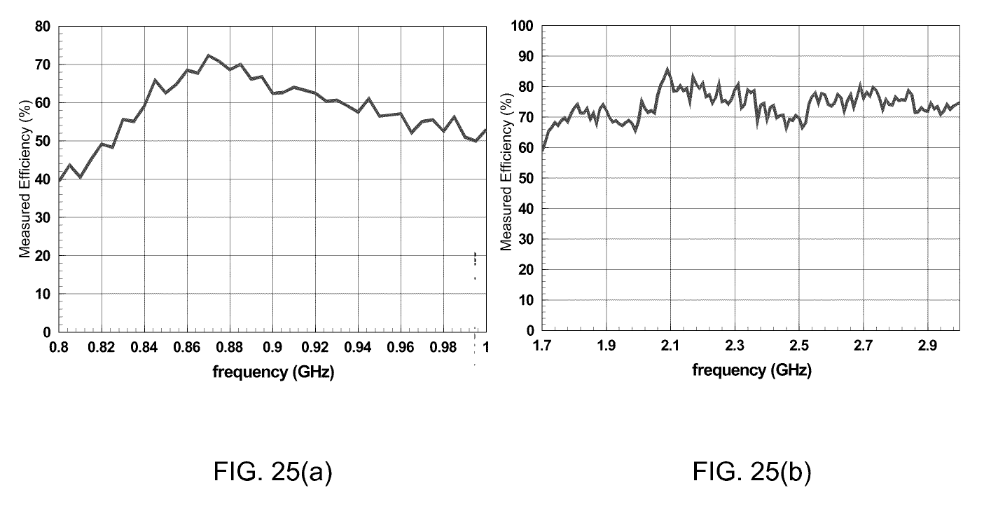

The measured efficiency is shown in FIGS. 25(a) and 25(b) for the low band and high band, respectively. The bare-board efficiency reaches 70% in the low band and 80% in the high band with over 50% from 820 to 1000 MHz and 60% from 1.7 to 3 GHz.

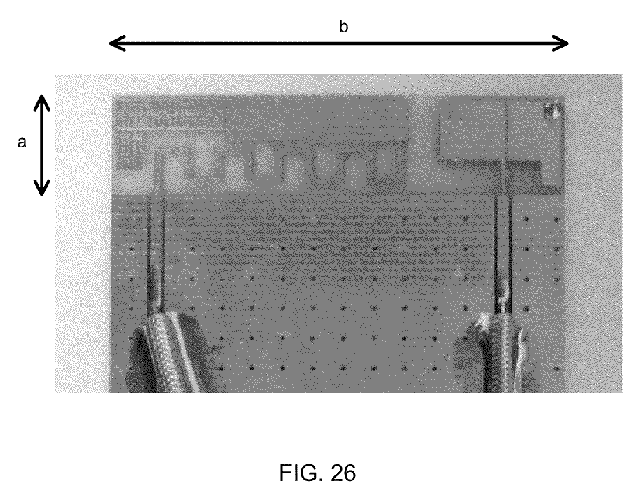

A reduced-size two-antenna array having the low-band and high-band MTM antennas is fabricated as shown in the photo of FIG. 26. This structure is similar to the two-antenna array having the low-band and high-band MTM antennas shown in FIGS. 23(a)-23(c), except that the antenna portion with the size of (a×b) as indicated in FIG. 26 is reduced to 10 mm×45 mm from 27 mm×45 mm in the previous two-antenna array example, and is closer to the top ground electrode.

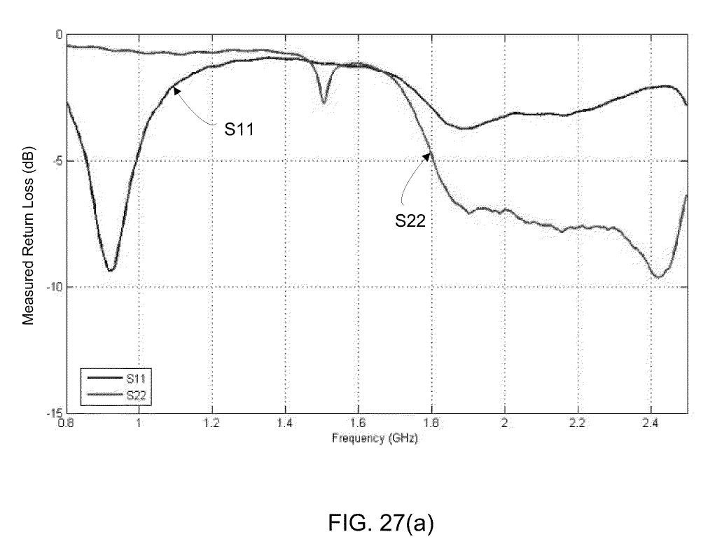

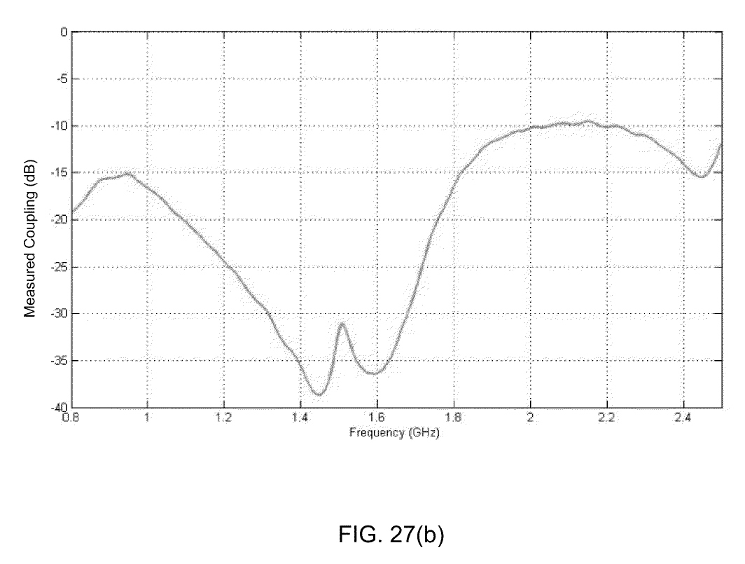

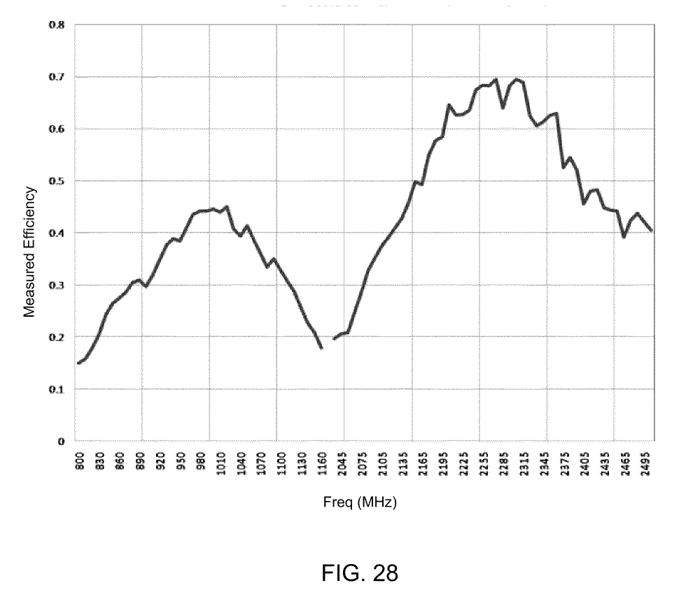

The measured return loss is depicted in FIG. 27(a), which shows that both S11 and S22 (corresponding to the return loss 1 of the low-band antenna and the return loss 2 of the high-band antenna, respectively) have narrower bandwidths than those in FIG. 24. Nonetheless, they are still wide enough to cover the penta-band including the cellular band (824-960 MHz) and PCS/DCS band (1850-2170 MHz). The coupling is low even in this reduced-size case as seen in FIG. 27(b). However, the measured efficiency for the reduced-size case in FIG. 28 is lower than that shown in FIGS. 25(a) and 25(b), reaching 45% in the low band and 70% in the high band. This is due to the size-efficiency trade-off.

Receive (Rx) diversity is one of wireless diversity schemes that utilize two or more antennas, affording a receiver several observations of an incoming signal to obtain a robust link. Due to the use of multiple antennas, compactness of the antenna device is desired. High efficiency is not normally required for Rx diversity antennas, and the efficiency requirement may range 30-40% in some cases. MTM antenna structures described in this document can be implemented to construct an MTM antenna array for providing the receive diversity while allowing a compact antenna package.

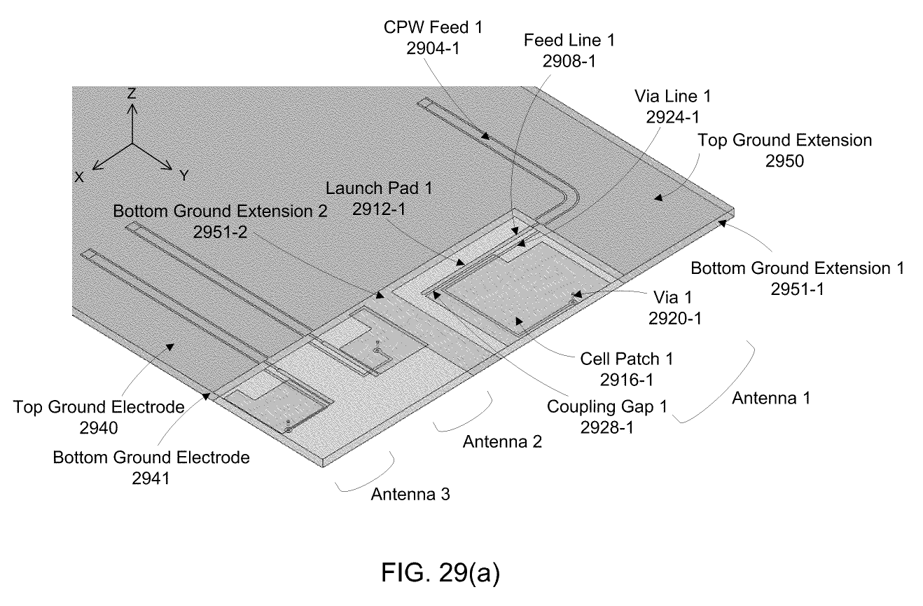

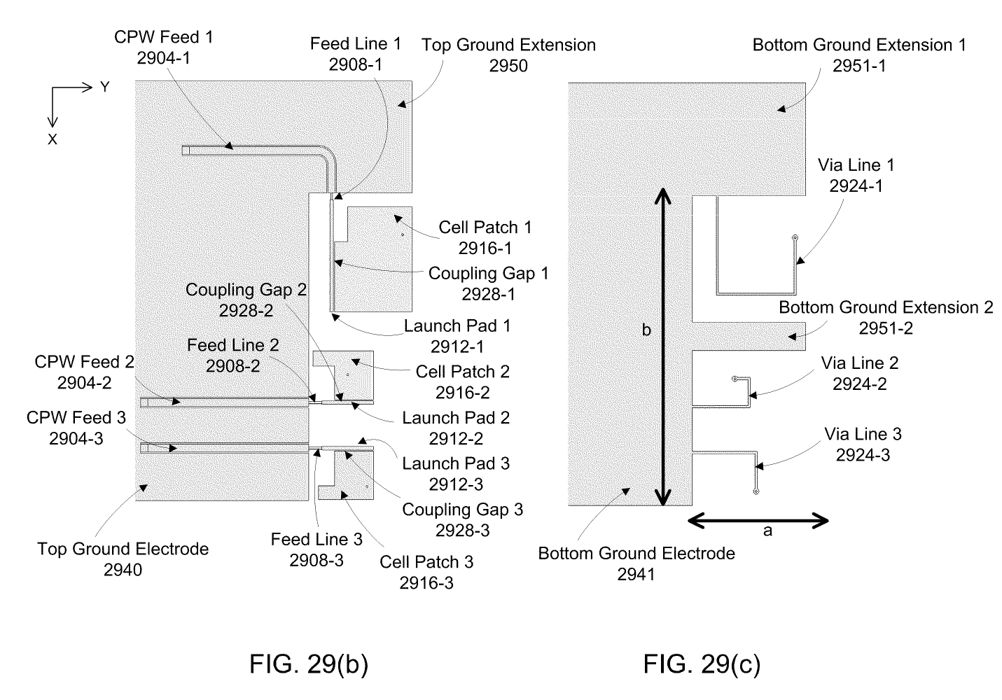

FIG. 29(a)-29(c) show an example of a Rx diversity MTM antenna array with three different antennas designed to resonate at the following three different bands for cell phone applications: US Cell Rx 869-894 MHz (Antenna 1), GPS1570-1580 MHz (Antenna 2) and PCS Rx 1930-1990 MHz (Antenna 3). The antenna area, indicated as (a×b) in FIG. 29(c), is 16 mm×44 mm, and the substrate thickness is 1 mm.

Three separate CPW feeds 1 (2904-1), 2 (2904-2) and 3 (2904-3) are formed in a top ground electrode 2940 to guide antenna signals for Antennas 1, 2 and 3, respectively. The CPW feed 1 (2904-1) for Antenna 1 is partially formed in the extended portion of the top ground, top ground extension 2950. Each antenna structure is basically a one-cell two-layer MTM antenna structure with a via as shown in FIGS. 13(a)-13(d). In the following structure description, the second reference numeral after dash (-) is omitted when the description pertains to each antenna. A feed line 2908 is formed in the top metallization layer and is connected to a launch pad 2912 to direct a signal to or receive a signal from a cell patch 2916 through a coupling gap 2928 in each Antenna. The feed line 1 (2908-1) is connected to the portion of the CPW feed 1 (2908-1) formed in the top ground extension 2950. Each cell patch 2916 is connected through a via 2920 to a via line 2924. The via lines 2 (2924-2) and 3 (2924-3) are shorted to a bottom ground electrode 2941 directly, whereas the via line 1 (2924-1) is shorted to the extended portion of the bottom ground, bottom ground extension 1 (2950-1), as shown in FIG. 29(c). Another extended portion of the bottom ground, bottom ground extension 2 (2950-2), is added for optimizing matching and coupling among the Antennas. In the example shown, the three antennas at three different locations are configured to have three different shapes and directions of shape-elongation for diversity. The dimensions of the antenna elements in these antennas are selected to produce different resonant frequencies in the three target bands. For example, the overall length of Antenna 1 is made longer than that of Antenna 2 to have lower resonant frequencies for reception by Antenna 1 than by Antenna 2.

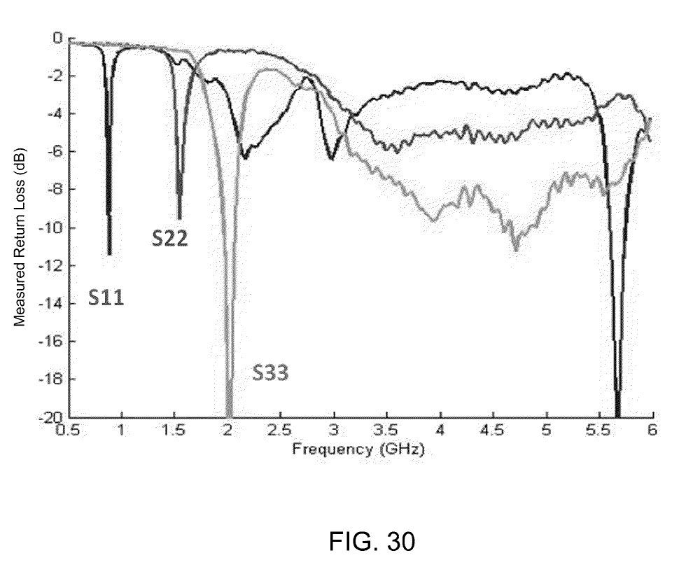

The measured return loss is shown in FIG. 30, illustrating that the three target bands are covered by Antenna 1, 2 and 3 as represented by S11, S22, and S33, respectively. These three resonances are due to the LH modes. In addition, the following table provides a summary of the Rx diversity antenna performance achieved by the present MTM design based on measurements and simulations.

TABLE 3

| Return | | Bandwidth | | | |
|---|---|---|---|---|---|
| Loss | FIG. 30 | at −6 dB | Band | Simulation | |
| | S11 | 34 MHz | 867-901 MHz | 810-830 | MHz |
| | S22 | 62 MHz | 1.527-1.589 GHz | 1.46-1.51 | GHz |
| | S33 | 214 MHz | 1.903-2.117 GHz | 1.73-1.92 | GHz |
| Coupling | S12 | S31 | S32 | | |
| | −15 dB | −9.27 dB | −20.01 dB | | |
| | @ 1.56 GHz | @ 2.068 GHz | @ 1.966 GHz | | |
| Peak | Antenna 1 | Antenna 2 | Antenna 3 | | |
| Efficiency | | | | | |
| | 51% | 54% | 58% | | |
| | @ 880 MHz | @ 1.55 GHz | @ 1.93 GHz | | |

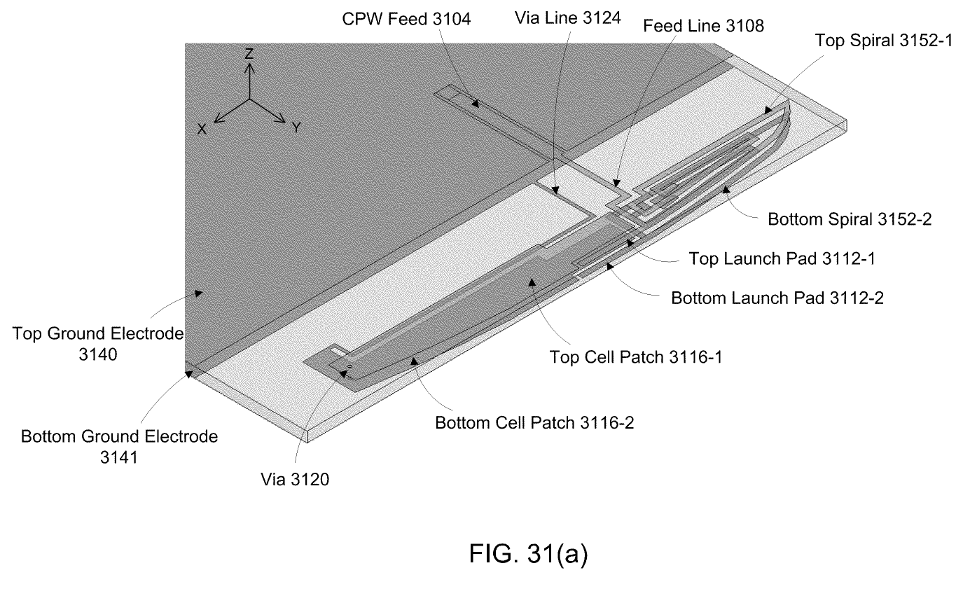

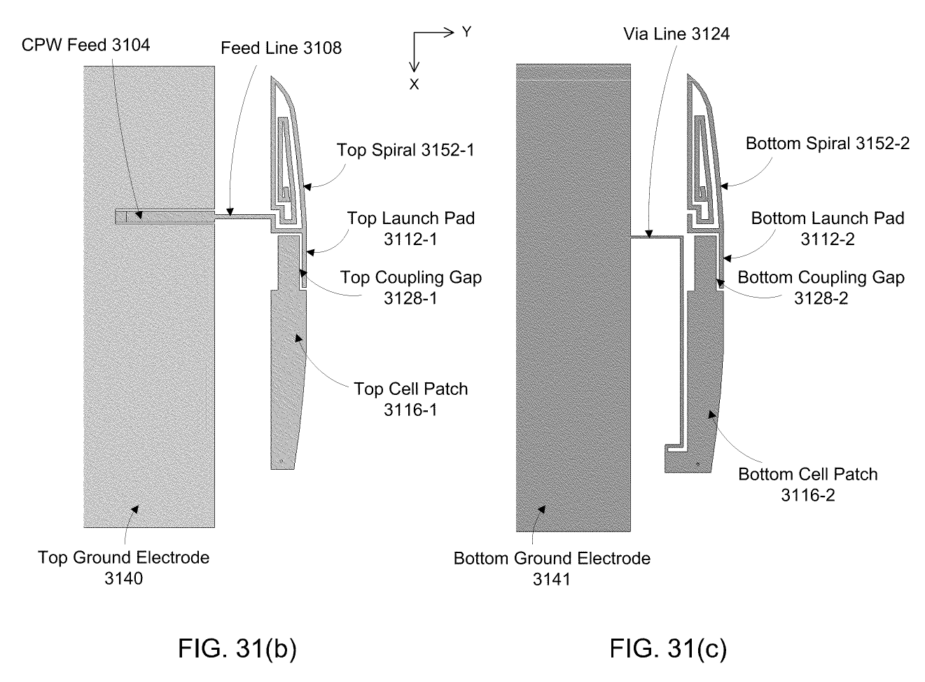

An example of a two-cell two-layer two-spiral MTM antenna structure with one via is illustrated in FIGS. 31(a)-31(c), showing the 3D view, top view of the top layer and top view of the bottom layer, respectively. This is another exemplary MTM antenna designed for penta-band cell phone applications, characterized by one pair of top and bottom cell patches and one pair of top and bottom spirals. A via is provided to connect the top and bottom cell patches, but no via is provided between the top and bottom spirals which are thus not conductively connected.

Specifically, the top metallization layer has a top ground electrode 3140, a CPW feed 3104 formed in the top ground electrode 3140, a top launch pad 3112-1, a top spiral 3152-1 attached to the top launch pad 3112-1, a feed line 3108 connecting the CPW feed 3104 and the top launch pad 3112-1, and a top cell patch 3116-1. The antenna signal is directed to and received from the top cell patch 3116-1 through a top coupling gap 3128-1, and the top cell patch 3116-1 is conductively connected to a bottom cell patch 3116-2 by a via 3120 penetrating through the substrate. The bottom metallization layer has the bottom cell patch 3116-2, a bottom ground electrode 3141, a bottom launch pad 3112-2 capacitively coupled to the bottom cell patch 3116-2 through a bottom coupling gap 3128-2, a bottom spiral 3152-2 attached to the bottom launch pad 3112-2, and a via line 3124 connecting the bottom cell patch 3116-2 to the bottom ground electrode 3141. The top and bottom spirals 3152-1 and 3152-2 are substantially identical in shape and size and positioned to overlay with each other. The top and bottom cell patches 3116-1 and 3116-2 are also substantially identical in shape and size, except that the small portion of the bottom cell patch 3116-2, where the via line 3124 is connected, is extended out slightly as compared to the top cell patch 3116-1.

The bottom cell patch 3116-2 effectuates a truncated ground and the shape and size of the truncated ground (bottom cell patch 3116-2) directly underneath the top cell patch 3116-1 are similar to those of the top cell patch 3116-1. The RH shunt capacitance CR in this example is larger than that in the one cell version of the truncated ground structures shown in FIGS. 8, 10 and 11 where a small via patch or line that is much less than the cell patch is used. Based on the analysis explained in the previous sections, it can be shown that the LH shunt inductance LL due to the via 3120, the series inductance Lp due to the via line 3124, and the LH series capacitance CL induced in the top coupling gap 3131-1 mainly control the LH resonances. On the other hand, the low-frequency monopole mode resonance is generated by the addition of the top spiral 3152-1. The length of the top spiral 3152-1 can be adjusted to create a resonance at a frequency higher than, but close to the LH resonance so that the resulting bandwidth of the two modes (the combined monopole-mode and LH-mode resonance) is sufficient to cover the low band with a bandwidth of ˜150 MHz. The bottom spiral 3152-2 can be interpreted as a capacitive loading element for the top spiral 3152-1, thereby serving as a matching means for the monopole resonance that is mainly controlled by the length of the top spiral 3152-1.

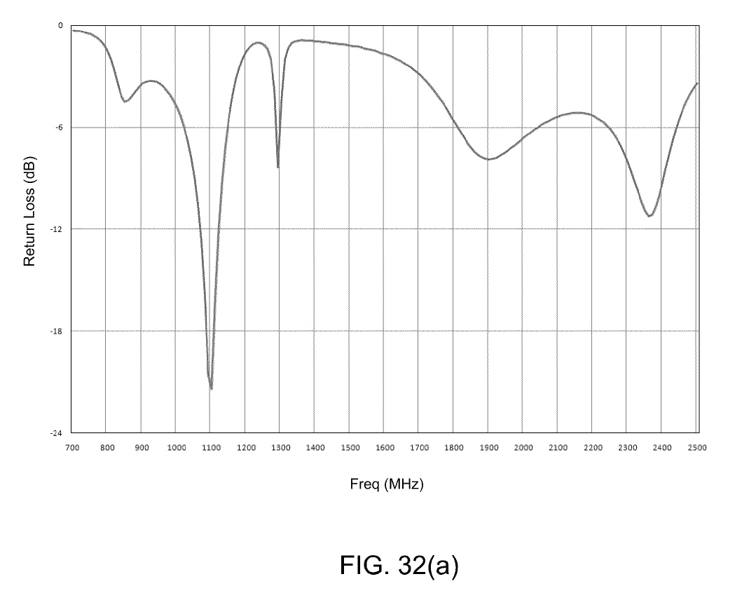

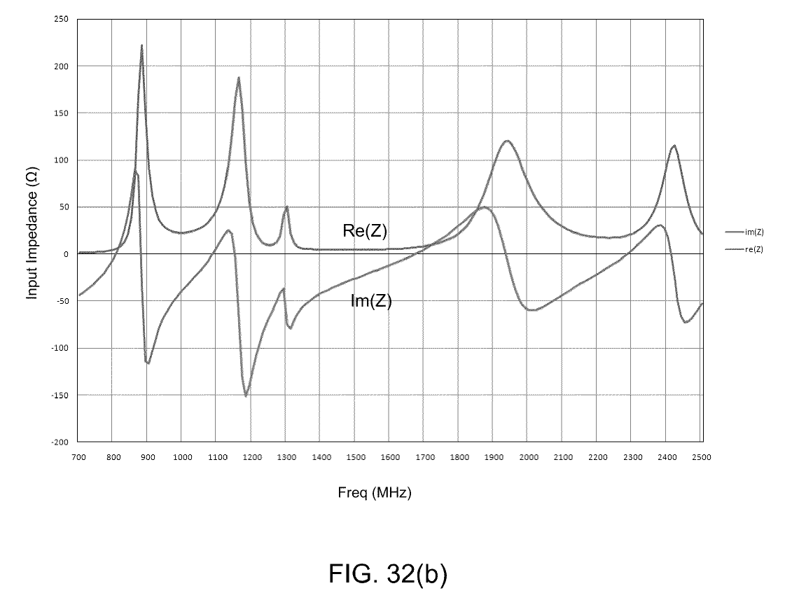

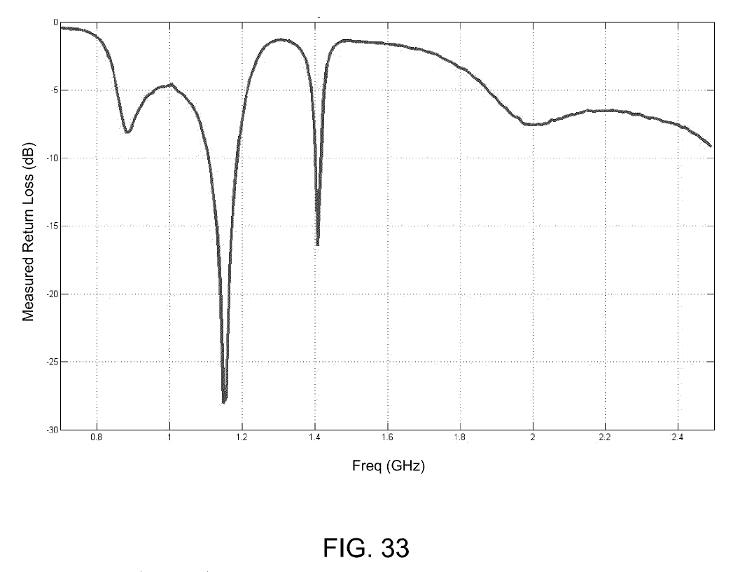

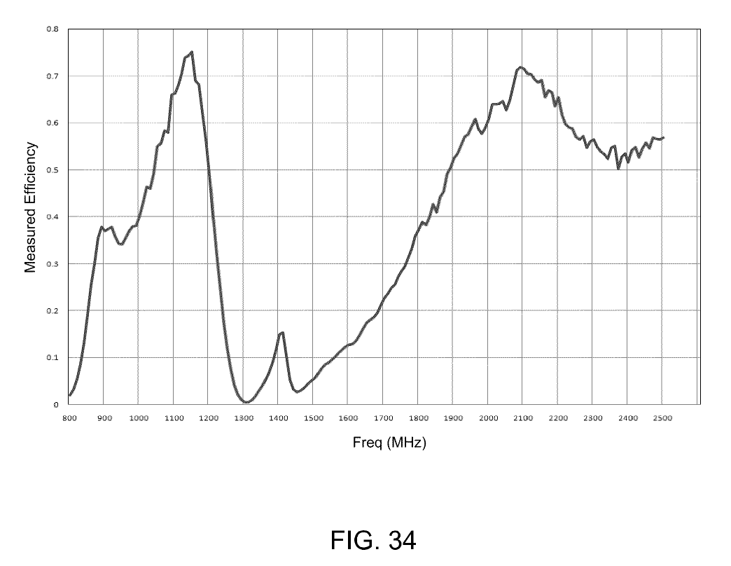

The simulated return loss and input impedance are shown in FIGS. 32(a) and 32(b), respectively. The measured return loss of a fabricated sample is shown in FIG. 33. The LH resonance appears near 890 MHz, as seen in these figures. However, this two-cell two-layer two-spiral MTM antenna with one via is not very well matched to cover the bands between 800 MHz and 1700 MHz. As seen in the measured efficiency in FIG. 34, the peak efficiency is about 70% in both the low and high bands.

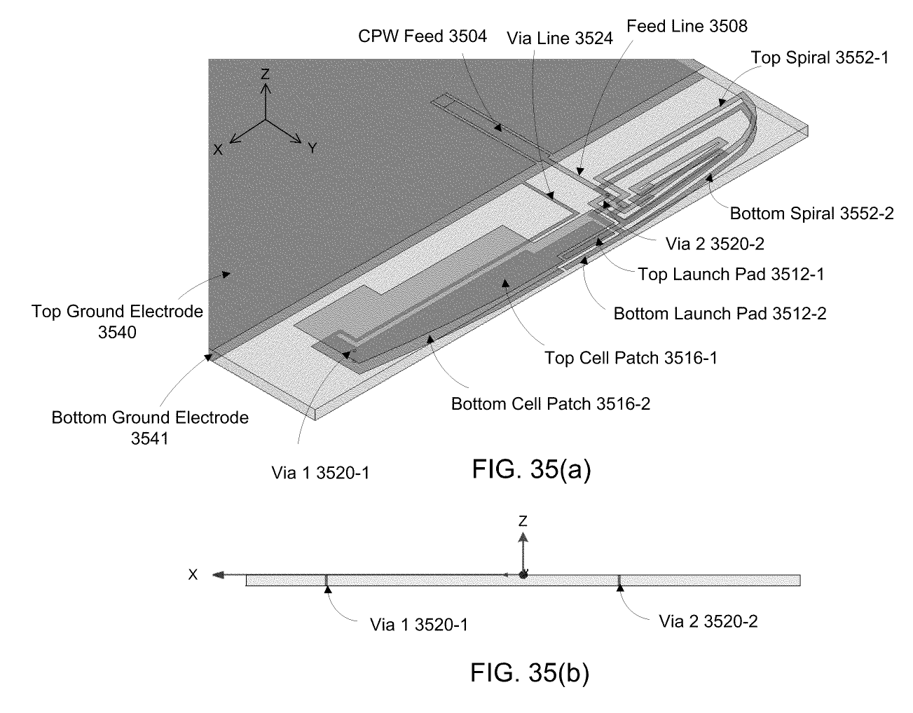

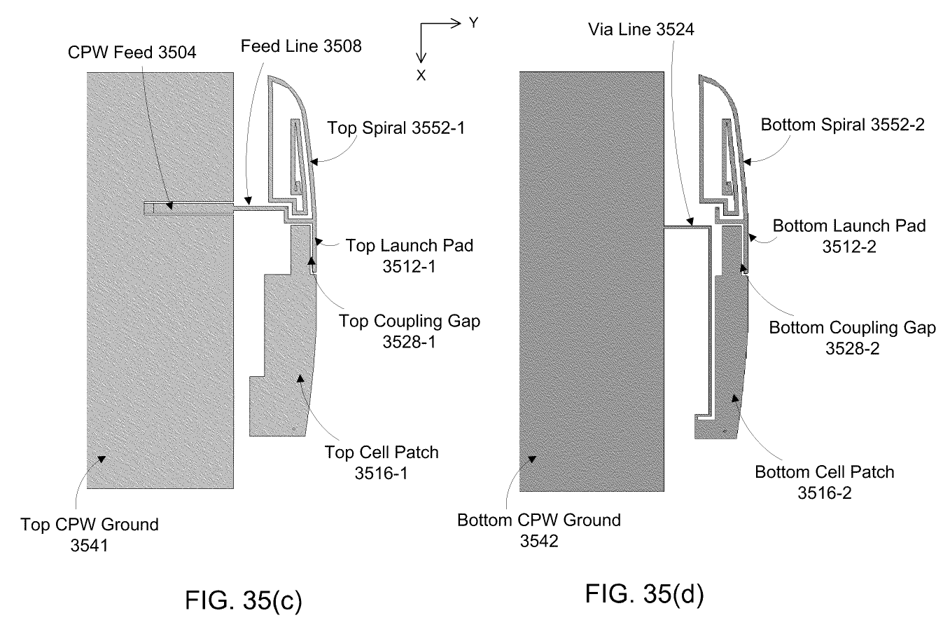

To improve matching to cover all five bands, modifications are made to the two-cell two-layer two-spiral MTM antenna structure with one via shown in FIGS. 31(a)-31(c). The modified version shown in FIGS. 35(a)-35(d) is an example of a two-cell two-layer two-spiral MTM antenna structure with two vias, in which a via 2 (3520-2) connects top and bottom spirals 3552-1 and 3552-2. In addition, a top cell patch 3516-1 is made larger than a bottom cell patch 3516-2 in this structure. The bottom launch pad 3512-2 can be interpreted as an inductive loading element for the top spiral 3552-1, thereby serving as a matching means for the low-frequency monopole resonance that is mainly controlled by the length of the top spiral 3552-1.

The following table provides a summary of the antenna elements of this two-cell two-layer two-spiral MTM antenna structure with two vias. This modified design improves the impedance matching.

TABLE 4

| Parameter | Description | | Location |
|---|---|---|---|
| Antenna | Each antenna element comprises a Cell | | |
| Element | coupled to a CPW Feed 3504 through a Top | | |
| | Launch Pad 3512-1 and Feed Line 3508. | | |
| Feed Line | Connects the Top Launch Pad 3512-1 with the | | Top Layer |
| | CPW Feed 3504. | | |
| Top Spiral | Connected to the Feed Line 3508. | | Top Layer |
| Bottom | Connected to a Bottom Launch Pad 3512-2 and | | Bottom |
| Spiral | to the Top Spiral 3508 through a Via 2 | | Layer |
| | (3520-2). | | |
| Via 2 | Cylindrical shape and connects the Top and | | |
| | Bottom Spirals 3552-1 and 3552-2. | | |
| Launch | The Top Launch Pad 3512-1 is coupled to the | | Top Layer |
| Pad | Cell through a Top Coupling Gap 3528-1. | | |
| | The Bottom Launch Pad 3512-2 is coupled to | | Bottom |
| | the Cell through a Bottom Coupling gap 3528- | | Layer |
| | 2. | | |
| Cell | Cell | A Top Cell patch 3516-1 has a | Top Layer |
| | Patch | polygon shape. | |
| | | A Bottom Cell Patch 3516-2 has a | Bottom |
| | | polygon shape and is connected to | Layer |
| | | the Top Cell Patch 3516-1 through | |
| | | a Via 1 (3520-1). | |
| | Via 1 | Has a cylindrical shape and | |
| | | connects the Top and Bottom Cell | |
| | | Patches 3516-1 and 3516-2. | |
| | Via | Connects the Bottom Cell Patch | Bottom |
| | Line | 3516-2 to a Bottom Ground | Layer |
| | | Electrode 3541. | |

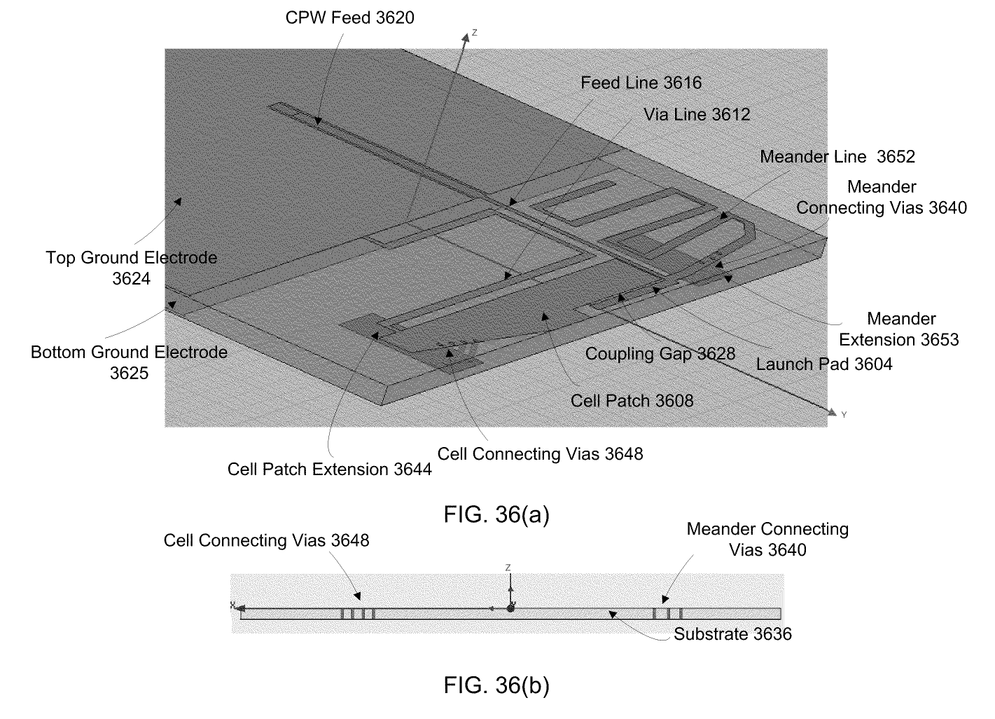

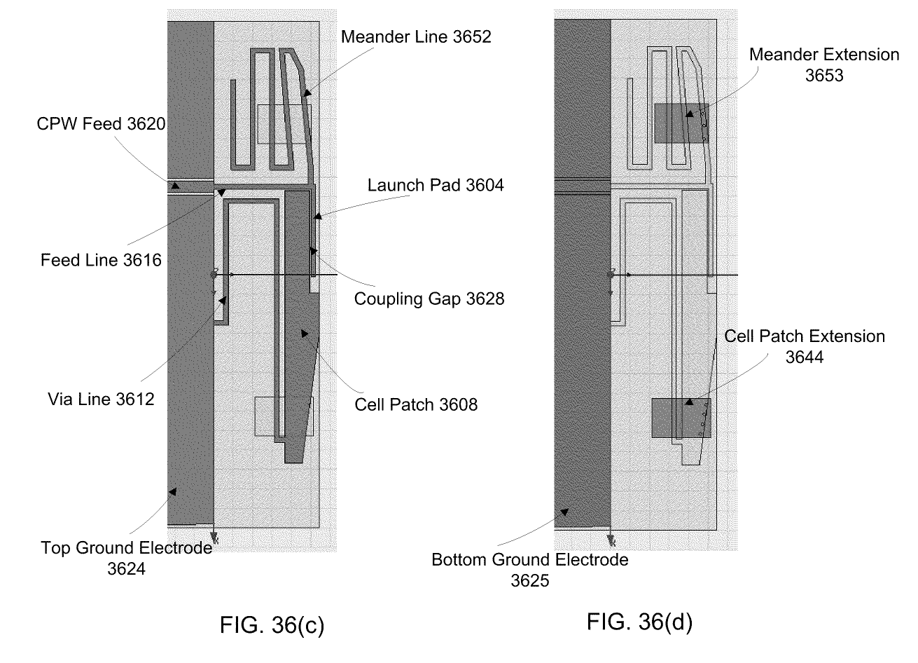

FIGS. 36(a)-36(d) show an example of a semi single-layer MTM structure, showing the 3D view, side view, top view of the top layer and top view of the bottom layer, respectively. This is an example for an MTM antenna structure designed for penta-band cell phone applications. FIG. 36(c) shows the bottom layer that is overlaid with the top layer. FIG. 36(d) shows the top layer that is overlaid with the bottom layer. In this design, a cell includes two metal patches that are respectively formed in the top and bottom metallization layers and are connected by conductive vias. Of the two metal patches, a cell patch 3608 in the top layer is larger in size than a cell patch extension 3644 in the bottom layer and thus is the main cell patch. The cell patch extension 3644 in the bottom layer is not connected to a ground electrode. A via line 3612 is formed in the top layer, the same layer of the cell patch 3608, to connect the cell patch 3608 to a top ground electrode 3624. Therefore, this antenna structure can be viewed as a single-layer MTM structure with the cell patch and meander line folded onto the bottom layer to comply with the limited available area for an antenna in a cell phone (e.g., 10 mm×42 mm). For this reason, this structure is referred to as a “semi single-layer MTM structure.”

More specifically, this semi single-layer MTM antenna has a launch pad 3604, a meander line 3652 and a cell patch 3608, all of which are in the top metallization layer on the top surface of the substrate. The cell patch 3608 is extended to a cell patch extension 3644 in the bottom metallization layer on the bottom surface of the substrate by using one or more vias 3648 to connect the cell patch 3608 on the top surface and the cell patch extension 3644 on the bottom surface. The meander line 3652 is extended to a meander extension 3653 in the bottom metallization layer on the bottom surface of the substrate by using one or more vias 3640 to connect the meander line 3652 on the top surface and the meander extension 3653 on the bottom surface. The respective vias are referred to as meander connecting vias 3640 and cell connecting vias 3648 in the figures. Such extensions can be made to comply with the space requirements while maintaining a certain performance level. The antenna is fed by a grounded CPW feed 3620 with a characteristic impedance of 50Ω. A feed line 3616 connects the CPW feed 3620 to the launch pad 3604, and has the added meander line 3652. The low-frequency monopole mode resonance is generated by the addition of the meander line 3652. The length of the meander line 3652 can be adjusted to create a resonance at a frequency higher than, but close to the LH resonance so that the resulting bandwidth of the two modes (the combined monopole-mode and LH-mode resonance) is sufficient to cover the low band with a bandwidth of ˜150 MHz. The cell patch extension 3644 helps improve matching of the LH mode resonance, whereas the meander extension 3653 helps improve matching of the monopole mode resonance. The cell patch 3608 has a polygonal shape, and capacitively coupled to the launch pad 3604 through a coupling gap 3628. The cell patch 3608 is shorted to the top ground electrode 3624 on the top surface through a via line 3612. The via line route is optimized for matching. The substrate 3632 can be made of a suitable dielectric material, e.g., an FR4 material with a dielectric constant of 4.4.

Table 4 provides a summary of the elements of the semi single-layer MTM antenna structure in this example.

TABLE 5

| Parameter | Description | | Location |
|---|---|---|---|
| Antenna | Each antenna element comprises a cell | | |
| Element | coupled to a CPW Feed 3620 via a Launch | | |
| | Pad 3604 and Feed Line 3616. | | |
| Feed Line | Connects the Launch Pad 3604 with the CPW | | Top Layer |
| | Feed 3620. | | |
| Launch Pad | Rectangular shaped and is coupled to a Cell | | Top Layer |
| | Patch 3608 through a Coupling Gap 3628. | | |
| Meander | Added to the Feed Line 3616. | | Top Layer |
| Line | | | |
| Meander | A rectangular shaped patch that is an | | Bottom |
| Extension | extension of the meander Line 3652. | | Layer |
| Meander | Vias connecting the meander Line 3652 on | | |
| Connecting | the top layer with the Meander Extension | | |
| Vias | 3653 on the bottom layer. | | |
| Cell | Cell Patch | Polygonal shape. | Top Layer |
| | Cell Patch | A rectangular shaped patch that | Bottom |
| | Extension | is an extension of the Cell | Layer |
| | | Patch 3608. | |
| | Via Line | Line that connects the Cell | Top Layer |
| | | Patch 3608 with a Top Ground | |
| | | Electrode 3624. | |
| | Cell | Vias connecting the Cell Patch | |
| | Connecting | 3608 on the top layer with the | |
| | Vias | Cell Patch extension 3644 on | |
| | | the bottom layer. | |

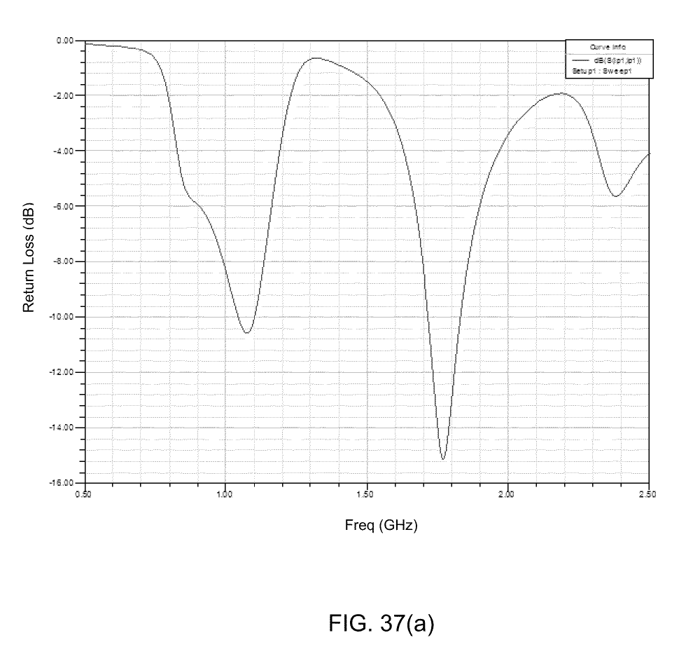

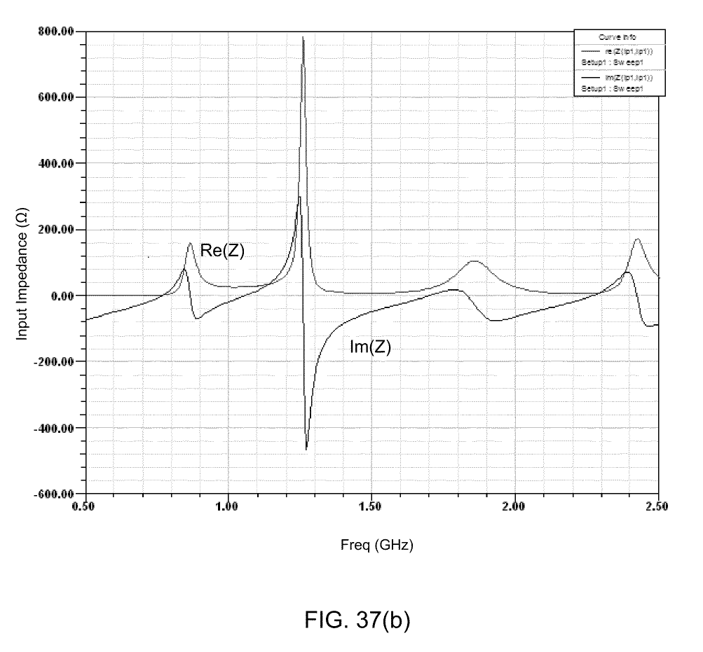

The design parameters are selected to cover the penta band for cell phone applications. The HFSS EM simulation software is used to simulate the antenna performance. The simulated return loss is shown in FIG. 37(a), and the simulated input impedance is shown in FIG. 37(b). As shown in these figures, the LH resonance appears at about 800 MHZ in this example. The simulated return loss in FIG. 37(a) shows the low-band bandwidth of larger than 150 MHz.

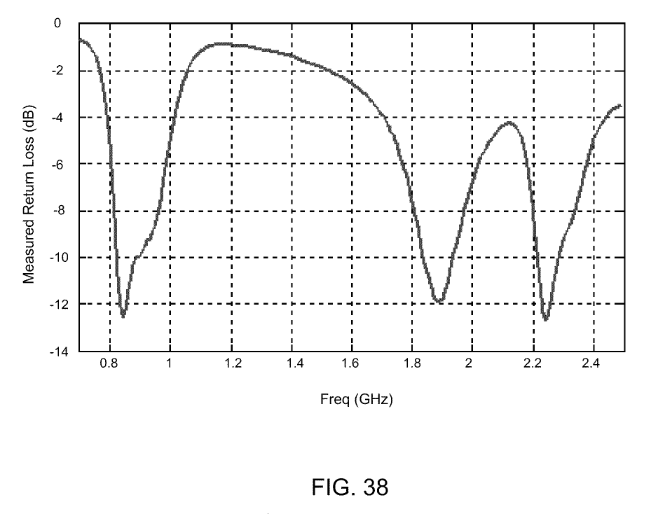

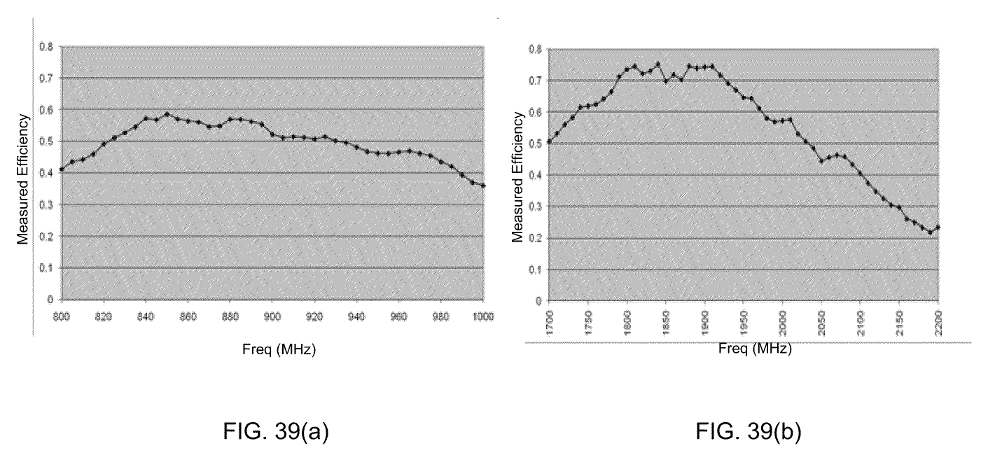

As evidenced in FIG. 38, the measured return loss of a fabricated sample of this semi single-layer MTM antenna has the low band covering from 800 MHz to 1 GHz, well supporting the cellular band (824 MHZ-960 MHz). The high band also shows the good coverage for the PCS/DCS band (1710-2170 MHz). The measured efficiency is shown in FIGS. 39(a) and 39(b) for the low band and high band, respectively. The peak efficiency in the low band is about 60%, while reaching almost 75% in the high band.

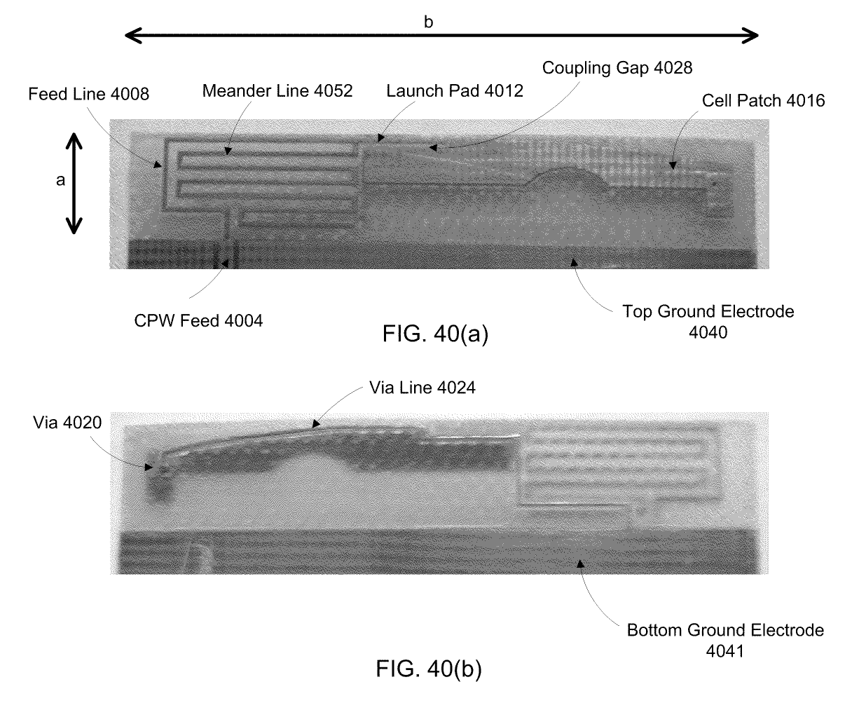

A reduced-size one-cell two-layer MTM antenna with a meander line is designed and fabricated as shown in the photos of FIGS. 40(a) and 40(b), showing the top view of the top layer and the bottom view of the bottom layer, respectively. This is another MTM antenna designed for penta-band cell phone applications. This structure is similar to the one-cell two-layer MTM antenna structure with a conductive via connecting the two metallization layers shown in FIGS. 13(a)-13(d), except that a meander line 4052 is added to the feed line 4008. As can be seen from the simulated return loss in FIG. 14(a) of the one-cell two-layer MTM antenna without a meander line shown in FIGS. 13(a)-13(d), the low band in this case has a sufficient bandwidth to cover the quad band but is too narrow to cover the penta band. The one-cell two-layer MTM antenna with the meander line 4052, shown in FIGS. 40(a)-40(b), is designed to increase the low-band bandwidth. The length of the meander line 4052 can be adjusted to create a resonance at a frequency higher than, but close to the LH resonance so that the resulting bandwidth of the two modes is sufficient to cover the low band ranging from 824 MHz to 960 MHz (i.e., cellular band).

The meander line 4052 is formed on the same side as the cell patch 4016 from the feed line 4008. This geometry is determined to utilize the available area between the cell patch 4016 and the edge of the top ground electrode 4040 with respect to the location of the CPW feed 4004. As a result, the area occupied by the antenna portion, i.e., (a×b) in FIG. 40(a), of this MTM structure can be reduced from 10 mm×42 mm [in the previous penta-band MTM antennas shown in FIGS. 31(a)-31(c), 35(a)-35(d), and 36(a)-36(d)] to 7 mm×40 mm, for example. Table 6 provides a summary of the elements of the reduced-size one-cell two-layer MTM antenna structure with the meander line 4052 in this example.

TABLE 6

| Parameter | Description | | Location |
|---|---|---|---|
| Antenna | Each antenna element comprises a Cell coupled | | |
| Element | to a CPW Feed 4004 through a Launch Pad 4012 | | |
| | and Feed Line 4008. | | |
| Feed Line | Connects the Launch Pad 4012 with the CPW | | Top Layer |
| | Feed 4004. | | |
| Launch | Coupled to a Cell Patch 4016 through a | | Top Layer |
| Pad | Coupling Gap 4028. | | |
| Meander | Attached to the Feed Line 4008. | | Top Layer |
| Line | | | |
| Cell | Cell Patch | Has an irregularly-curved shape | Top Layer |
| | | around other components placed on | |
| | | the substrate. | |
| | Via Line | Line that connects a Bottom Ground | Bottom |
| | | Electrode 4041 to a Via 4020, | Layer |
| | | hence the Cell Patch 4016. | |
| | Via | Connects the Cell Patch 4016 with | |
| | | the Vial Line 4024. | |

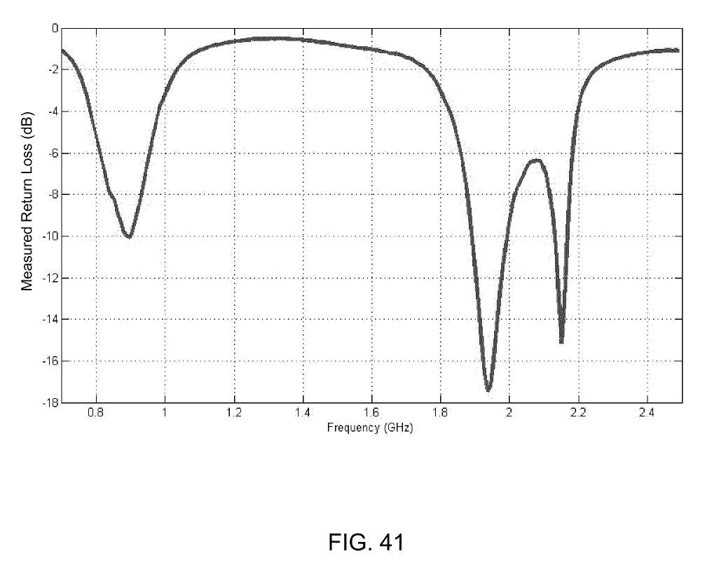

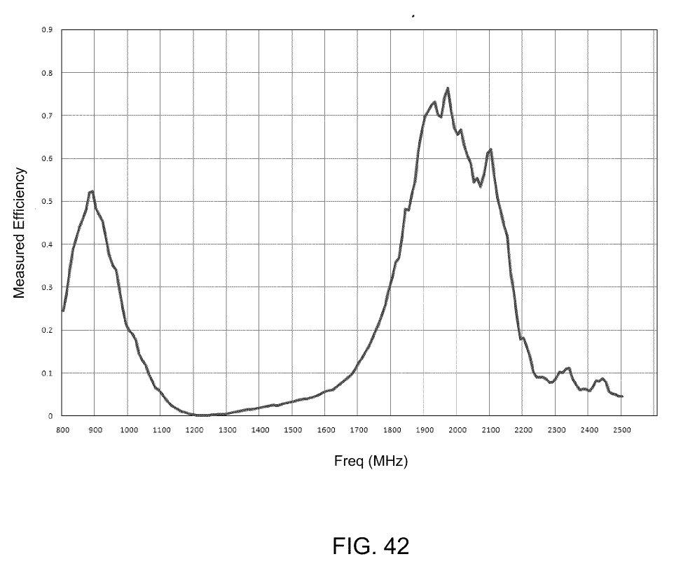

The measured return loss of a fabricated sample of this reduced-size one-cell two-layer MTM antenna with the meander is shown in FIG. 41. The frequency values at the −6 dB return loss indicate that the low band, i.e., the cellular band (824-960 MHz), is well covered, and the high band, i.e., the PCS/DCS band (1710-2170 MHz) can be covered by minor tuning to lower the high band to start around 1700 MHz using this MTM antenna. The measured efficiency is depicted in FIG. 42, showing a peak efficiency of 50% at about 900 MHz in the low band and 75% in the high band.

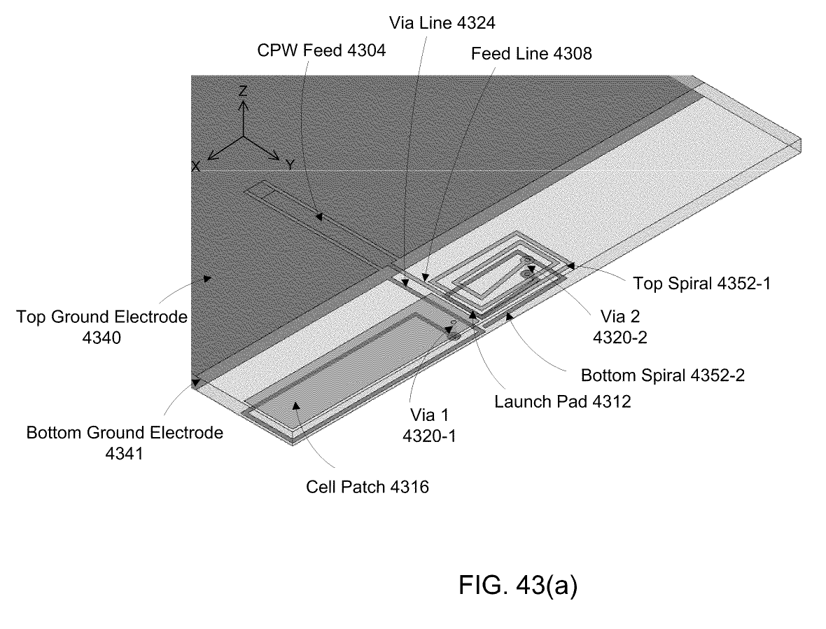

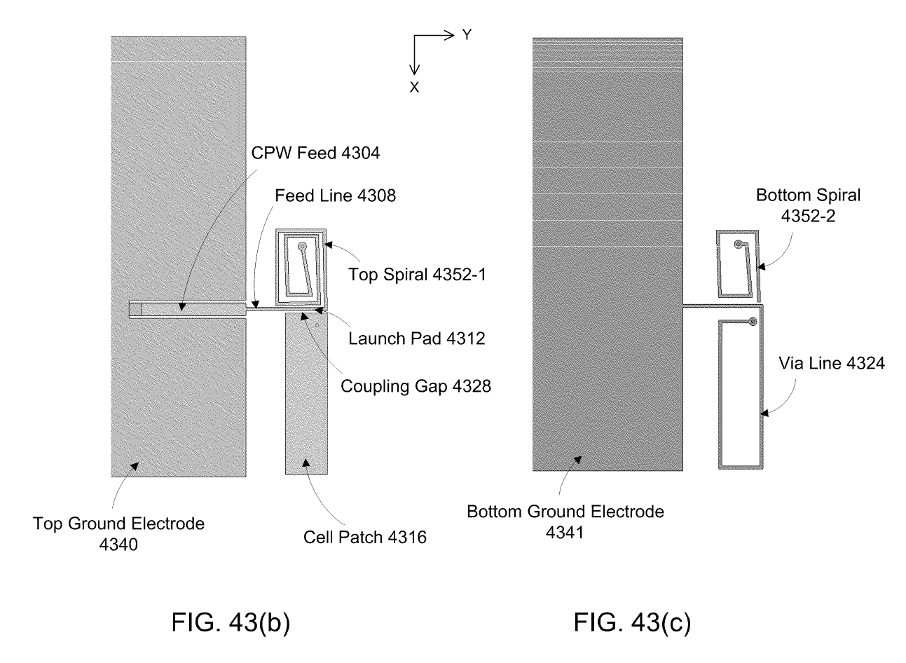

FIGS. 43(a)-43(c) show an example of a small one-cell two-layer MTM antenna with a split spiral, illustrating the 3D view, top view of the top layer and top view of the bottom layer, respectively. This is an MTM antenna designed for CDMA single band applications, characterized by a small size (e.g., 8 mm×22 mm) and a split spiral. This structure is similar to the reduced-size one-cell two-layer MTM antenna with a meander line shown in FIGS. 40(a) and 40(b), except that the meander line is replaced by a spiral line that is split into a top spiral and bottom spiral connected by a via. The overall footprint is reduced in this structure by utilizing both the top and bottom metallization layers to form the long spiral line. Similar to the MTM antenna structures with the spiral or meander line in the previous examples, the low-frequency monopole mode resonance is generated by the addition of the spiral line. The total length of the top and bottom spirals can be adjusted to create a resonance at a frequency higher than, but close to the LH resonance so that the resulting bandwidth of the two modes (the combined monopole-mode and LH-mode resonance) is sufficient to cover the CDMA single band with a bandwidth of ˜70 MHz.

More specifically, a top ground electrode 4340 is formed above a bottom ground electrode 4341 so that a CPW feed 4304 can be formed in the top electrode ground 4340. Therefore, as in the aforementioned examples, the CPW ground is formed by the top and bottom ground electrodes 4340 and 4341 in this small one-cell two-layer MTM antenna structure with the split spiral. Alternatively, the antenna can be fed with a CPW feed that does not require a ground plane on a different layer, a probed patch or a cable connector. The CPW feed 4304 is connected to a feed line 4308, which is further connected to a launch pad 4312 to direct a signal to or receive a signal from a cell patch 4316 through a coupling gap 4328. The gap width can be a few mils in some implementations. A spiral line is attached to the launch pad 4312. The spiral line is split into a top spiral 4352-1 and bottom spiral 4352-2, which are connected by a via 2 (4320-2). The cell patch 4316 is connected to the bottom ground electrode 4341 through a via line 4324 on the bottom surface of the substrate. The cell patch 4316 and the via line 4324 are connected through a via 1 (4320-1). Table 7 provides a summary of the elements of the small one-cell two-layer MTM antenna structure with the split spiral.

TABLE 7

| Parameter | Description | | Location |
|---|---|---|---|
| Antenna | Each antenna element comprises a Cell coupled | | Top Layer |
| Element | to a CPW Feed 4304 through a Launch Pad 4312 | | |
| | and Feed Line 4308. | | |
| Feed Line | Rectangular-shaped strip connecting the CPW | | Top layer |
| | Feed 4304 and the Launch Pad 4312. | | |
| Launch | Connects a Cell Patch 4316 to the CPW Feed | | Top Layer |
| Pad | 4304 through a Coupling Gap 4328 between the | | |
| | Launch Pad 4312 and Cell Patch 4316. | | |
| Spiral | Top Spiral | First part of a spiral line | Top Layer |
| | | attached to the Launch Pad 4312. | |
| | Bottom | Second part of the spiral line | Bottom |
| | Spiral | located on the bottom layer and | layer |
| | | connected to the Top Spiral 4352-1 | |
| | | through a Via 2 (4320-2). | |
| | Via 2 | Cylindrical shape connecting the | |
| | | Top and Bottom Spirals 4352-1 and | |
| | | 4352-2. | |
| Cell | Cell Patch | Rectangular shape. | Top Layer |
| | Via Line | Line that connects the Cell Patch | Bottom |
| | | 4316 to a Bottom Ground Electrode | Layer |
| | | 4343 through a Via 1 (4320-1). | |
| | Via 1 | Cylindrical shape connecting the | |
| | | Cell Patch 4316 and the Via Line | |
| | | 4324. | |

The dimensions of the elements in the small one-cell two-layer MTM antenna with the split spiral are selected to generate the CDMA single band resonances. Examples of the design parameters in one exemplary implementation are provided below. The substrate is 42 mm wide, 100 mm long and 1 mm thick. The material is FR4 with a dielectric constant of 4.4. The gap between the launch pad 4312 and the cell patch 4316 is 0.2 mm. The size of the cell patch 4316 is 15.45 mm long and 4 mm wide. The via line is 46.2 mm long and 0.3 mm wide. The spiral line has a total length of 83 mm combining the top and bottom spirals 4352-1 and 4352-2, and its width is 0.3 mm. The antenna area is 8 mm×22 mm.

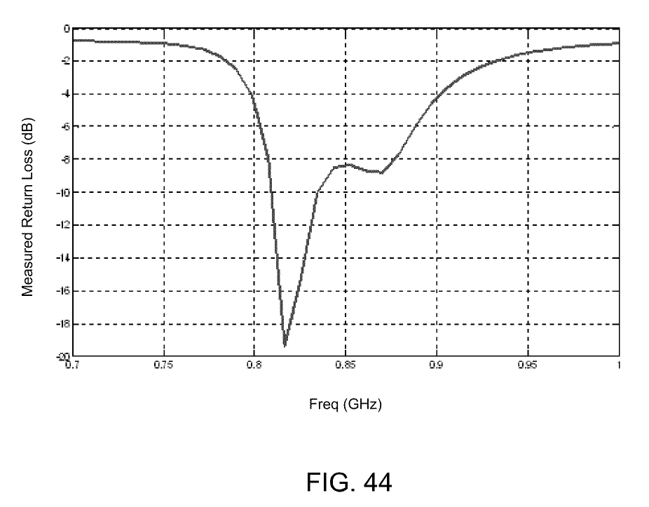

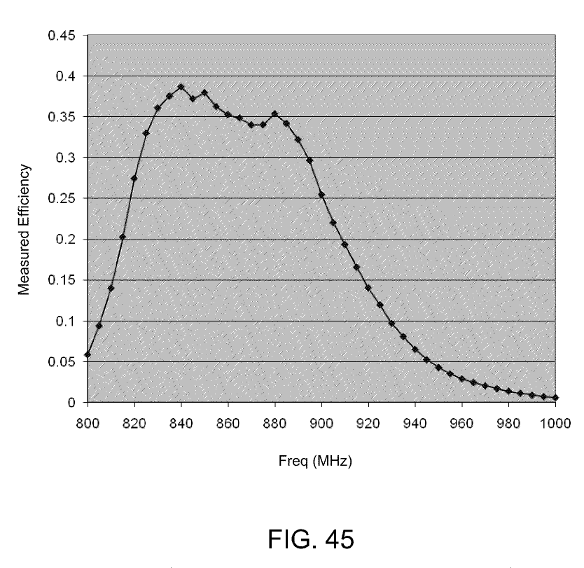

The measured return loss of a fabricated sample of this MTM antenna is shown in FIG. 44, demonstrating that the CDMA single band (824-894 MHz) is well covered by this MTM antenna. The measured efficiency is plotted in FIG. 45, showing the peak efficiency in this band to be close to 40%. The relatively low efficiency is the result of the size-efficiency trade-off.

In the aforementioned antenna structures, the coupling gap between the launch pad and cell patch is formed to be a slim and straight or right-angled gap between a straight edge portion of the launch pad and an aligned straight edge portion of the cell patch. The gap width can be 4-8 mils, for example, in some applications. The coupling geometry, which is determined by the layout of the launch pad and cell patch, can be designed to have more complex geometries. For example, the launch pad can be formed to completely surround the cell patch, or vice versa. The analysis presented in the previous sections still holds for this geometry in that the series LH capacitance CL is similarly induced between the launch pad and cell patch but with more complex dependencies on the gap geometry.

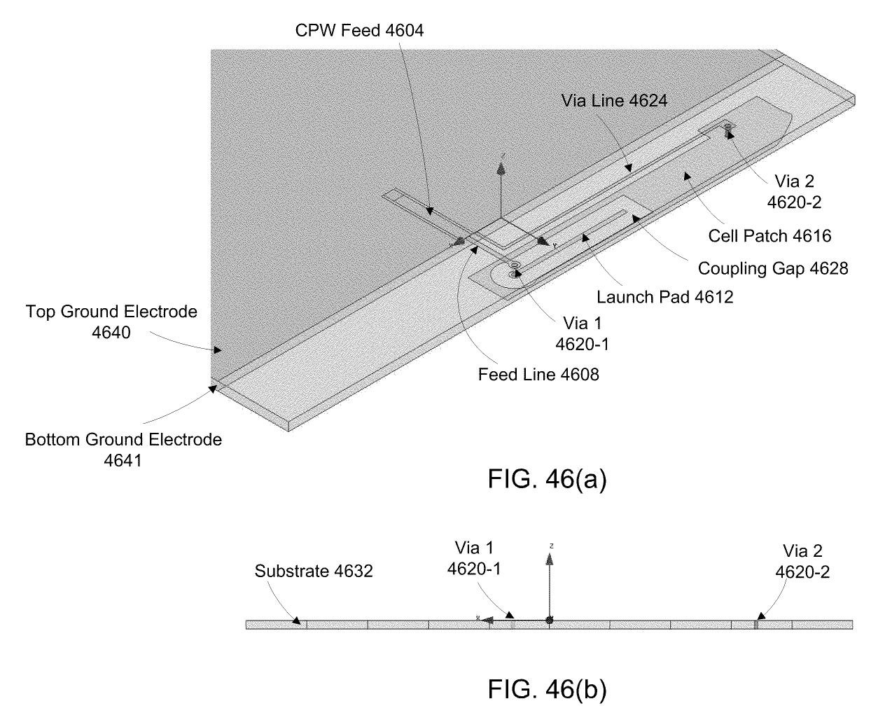

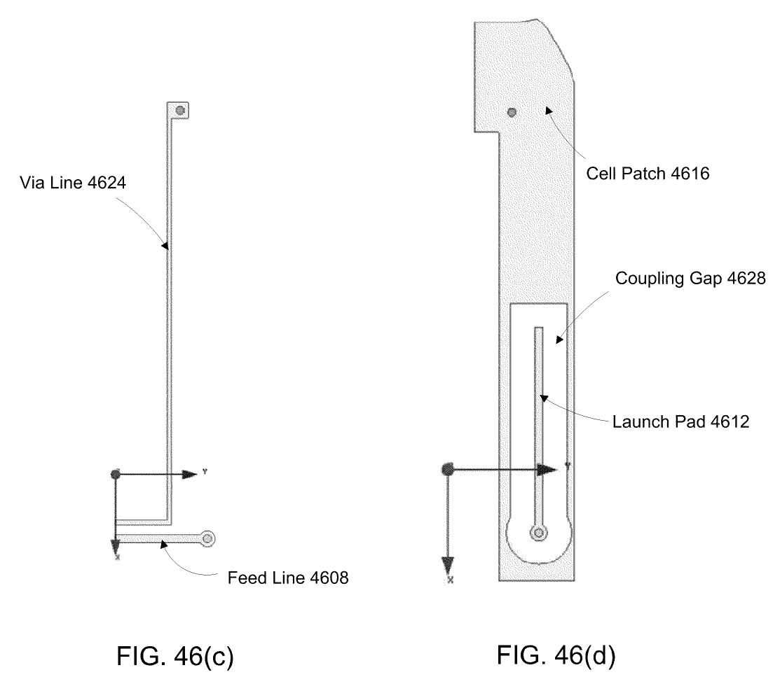

FIGS. 46(a)-46(d) show an example of an MTM antenna structure in which the launch pad is completely surrounded by the cell patch, illustrating the 3D view, side view, top view of the top layer and top view of the bottom layer, respectively. The cell patch 4616 in the bottom metallization layer is shaped to include an opening region in which the launch pad 4612 is formed and is completely surrounded by the cell patch 4616. This MTM antenna structure is featured by a three-dimensional power feeding structure that comprises two strips connected by a via: one strip in the top metallization layer (feed line 4608), the other strip in the bottom metallization layer (launch pad 4612) and a via 1 (4620-1) connecting the two strips. A via line 4624 is formed in the top metallization layer and connects a top ground electrode 4640 and the top portion of a via 2 (4620-2), which further connects to the cell patch 4616 in the bottom metallization layer.

The top ground electrode 4640 is formed above a bottom ground electrode 4641 so that a CPW feed 4604 can be formed in the top ground electrode 4640. Therefore, as in the aforementioned examples, the CPW ground is formed by the top and bottom ground electrodes 4640 and 4641 in the present MTM antenna structure. Alternatively, the antenna can be fed with a CPW feed that does not require a ground plane on a different layer, a probed patch or a cable connector. The CPW feed 4604 is connected to the feed line 4608, which is further connected to the launch pad 4612 to direct a signal to or receive a signal from the cell patch 4616 through a coupling gap 4628, which is surrounded by the cell patch 4616. This MTM antenna structure is different from a slot antenna because the feed structure and cell patch are completely separated by the gap, providing capacitive coupling CL.

A possible design variation is to have a via line in the bottom metallization layer, directly connecting the cell patch 4616 with the bottom ground electrode 4641. Another variation is to have the via line and another ground electrode in a third metallization layer and have the via connecting the cell patch 4616 in the bottom metallization layer and the via line in the third metallization layer. The third metallization layer can be formed on the bottom surface of a second substrate which is stacked underneath the original substrate 4632, thus providing a multi-layer structure. The bottom ground electrode 4641, which is in the bottom metallization layer, can be moved to the third metallization layer instead of forming another ground electrode in the third metallization layer. The top and bottom metallization layers are interchangeable in the MTM antenna structure shown in FIGS. 46(a)-46(d) as well as the additional third metallization layer in its variations explained above.

Table 8 provides a summary of the elements of the MTM antenna structure having the launch pad surrounded by the cell patch shown in FIGS. 46(a)-46(d).

TABLE 8

| Parameter | Description | | Location |
|---|---|---|---|
| Antenna | Comprises a Cell coupled a CPW Feed 4604 | | Top Layer |
| Element | through a Feed Line 4608, Via 1 (4620-1) and | | &Bottom |
| | Launch Pad 4612. | | Layer |
| Feed Line | Connects the CPW Feed 4604 with the Launch | | Top Layer |
| | Pad 4612 through the Vial 1 (4620-1). | | |
| Launch | Connected to the Feed Line 4608 and delivers | | Bottom |
| Pad | power to a Cell Patch 4616 by coupling | | layer |
| | through a Coupling Gap 4628. | | |
| Via 1 | Cylindrical shape connecting the Feed Line | | |
| | 4608 with the Launch Pad 4612. | | |
| Cell | Cell | Substantially rectangular shape with | Bottom |
| | Patch | an opening inside, where the Launch | Layer |
| | | Pad 4612 is formed and surrounded by | |
| | | the Cell Patch 4616. | |
| | Via 2 | Cylindrical shape connecting the | |
| | | Cell Patch 4616 with a Via Line | |
| | | 4624. | |
| | Via | A thin trace that connects the Via 2 | Top Layer |
| | Line | (4620-2), hence the Cell Patch 4616, | |
| | | to a Top Ground Electrode 4640. | |

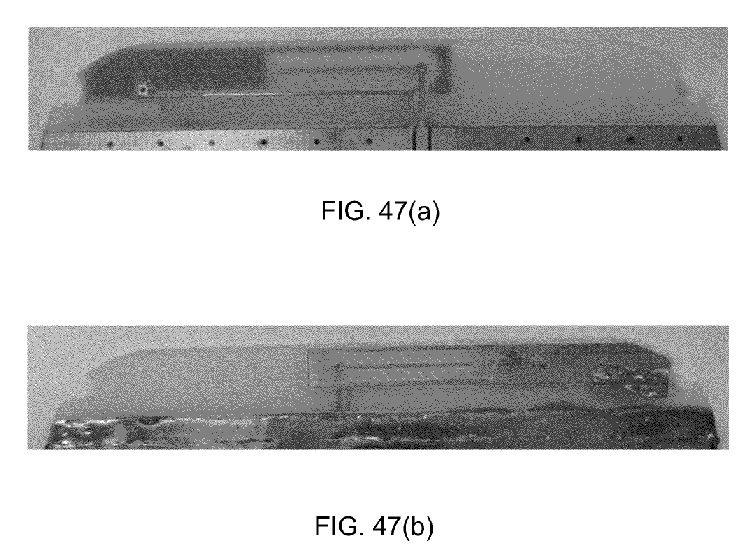

The dimensions of the elements in the MTM antenna structure having the launch pad surrounded by the cell patch as shown in FIGS. 46(a)-46(d) are selected to generate frequency resonances in the low band around 800 MHz and the high band around 2 GHz, providing the capability of covering the two bands used in cell phone applications. Examples for the design parameters in one exemplary implementation are provided below. The size of the substrate is 66.5 mm wide and 100 mm long, with a 1 mm thickness. The material is FR4 with a dielectric constant of 4.4. Overall height of the antenna portion is 7.8 mm from the edge of the top ground electrode 4640, and its total length is 35.65 mm. The feed line 4608 is 6.1 mm in length and 0.5 mm in width, and the launch pad 4612 is 13.5 mm in length and 0.5 mm in width. The width of the coupling gap 4628 is about 1.5 mm. The cell patch 4616 is substantially rectangular shaped, with 35.65 mm in length and 6.15 mm in width with an opening inside to accommodate the launch pad 4612. The via line 4624 is 29.77 mm long in total, and has a width of 0.3 mm. Each of the via pads has a square dimension of 1 mm by 1 mm. The photos of a fabricated sample are shown in FIGS. 47(a) and 47(b), showing the top view of the top layer and bottom view of the bottom layer, respectively.

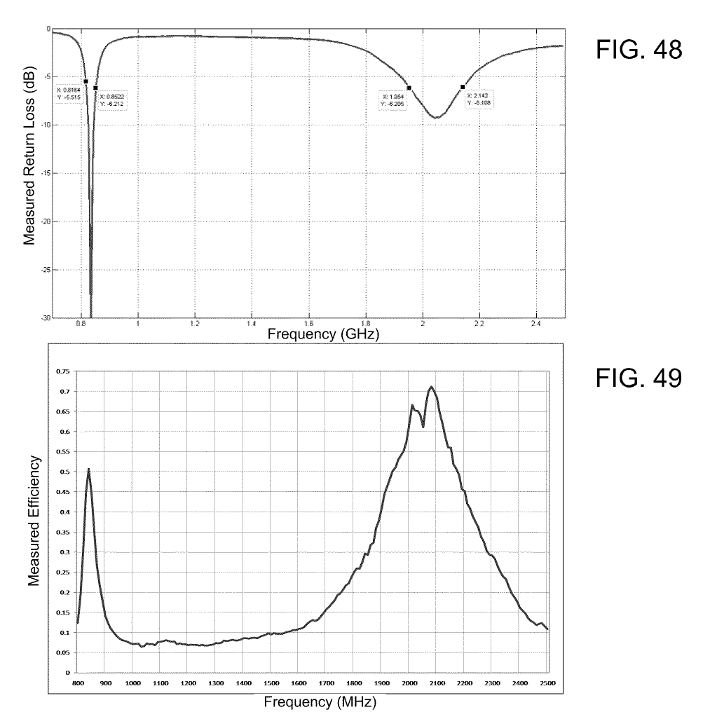

Two frequency bands can be observed in the measured return loss shown in FIG. 48. The first resonance is centered at about 834 MHz with a bandwidth of 36 MHz at the −6 dB return loss. This is an LH mode resonance, which is mainly controlled by the layout and shape of the cell patch (contributing to LR) and the corresponding via and via line structure (contributing to LL and Lp), the gap between the via line and cell patch (contributing to CR), and the gap between the cell patch and the feed line-plus-launch pad structure. Note that the coupling between the cell patch and feed line-plus-launch pad structure arises from two sources in the present case: (i) the vertical gap between the feed line 4608 in the top layer and the cell patch 4616 in the bottom layer; and (ii) the horizontal, enclosing gap between the launch pad 4612 and cell patch 4616 (contributing to CL). The vertical coupling is much weaker than that from the horizontal, enclosing gap because the overlay between the feed line and cell patch is small in this example. The width of the coupling gap, ˜1.5 mm, for example, is critical to the performance of the antenna. The second resonance is centered at about 2.05 GHz with a bandwidth of 188 MHz at the −6 dB return loss. This resonance is an RH mode(monopole mode), which is mainly controlled by the physical length of the feed line-plus-launch pad structure and also by the relative electrical length, determined by the length of the cell patch 4616, which is added to the physical length when the launch pad 4612 couples through the gap 4628 to the cell patch 4616. In this example, two major bands, the “low” band at ˜800 MHz and the “high” band at ˜2 GHz, can be defined, making this MTM antenna suitable for cell phone applications. The measured efficiency is plotted in FIG. 49, showing good efficiency in both bands.

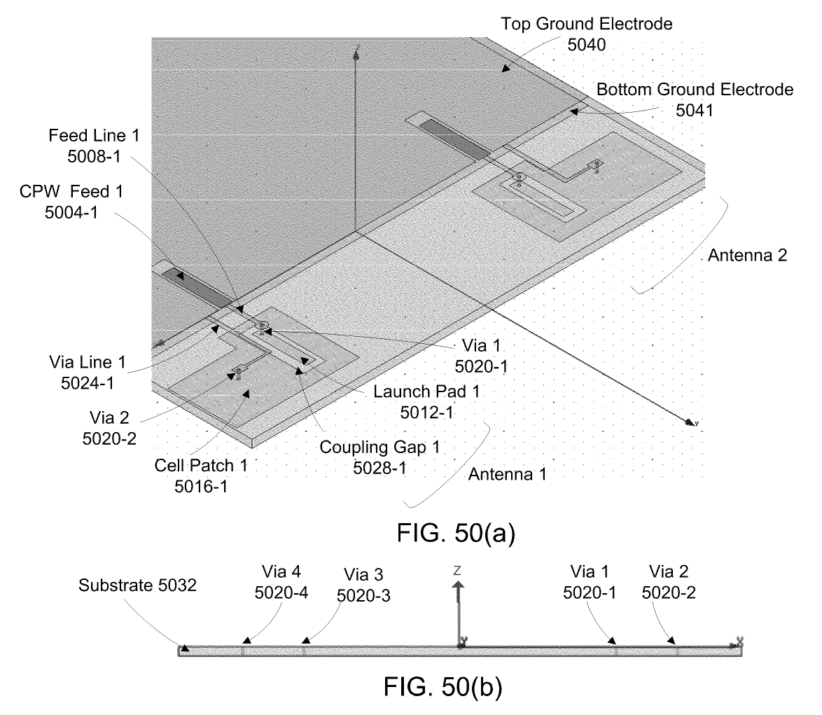

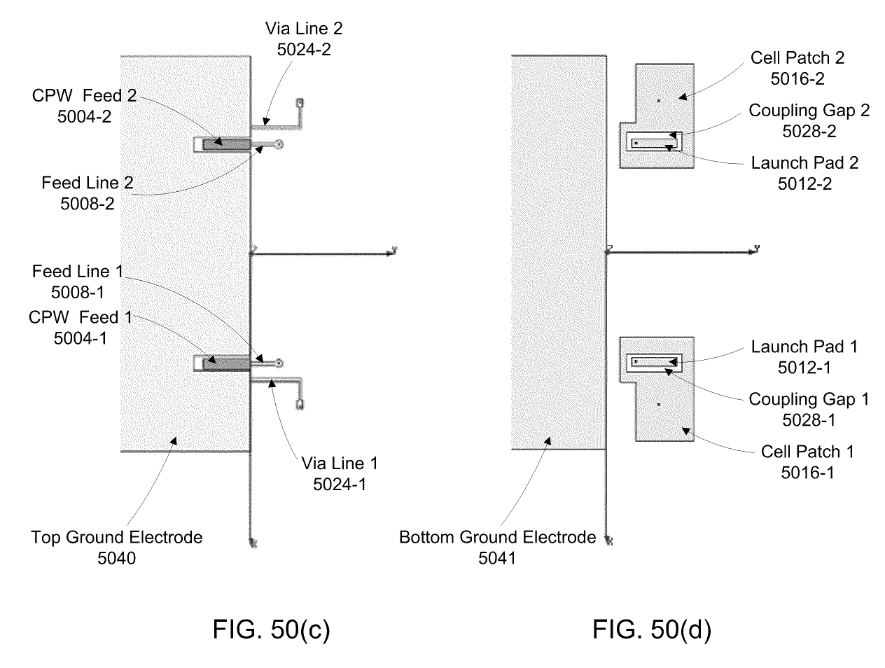

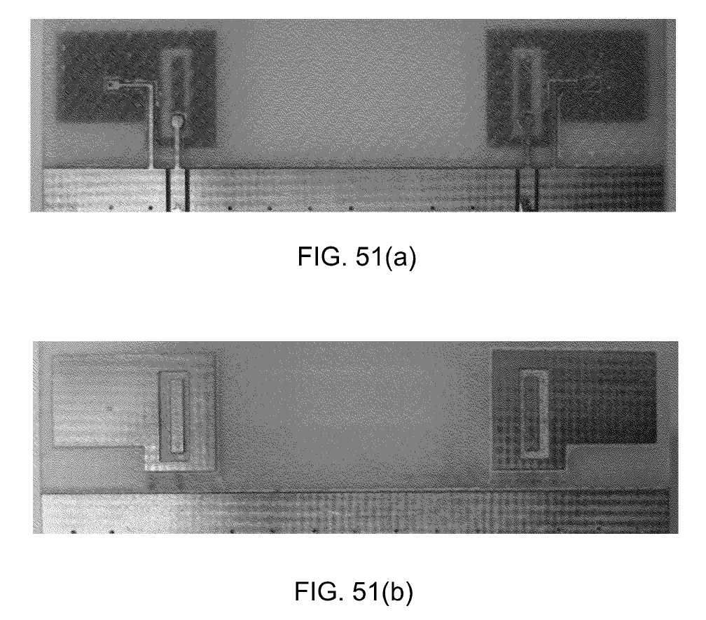

An example of a two-antenna array based on the MTM antenna structure having a launch pad surrounded by a cell patch is illustrated in FIGS. 50(a)-50(d), showing the 3D view, side view, top view of the top layer and top view of the bottom layer, respectively. The photos of a sample fabricated by using an FR-4 substrate are shown in FIGS. 51(a) and 51(b), showing the top view of the top layer and bottom view of the bottom layer, respectively. Each antenna, Antenna 1 or Antenna 2, in this array has the same basic structure as the previous example shown in FIGS. 46(a)-46(d). The description below is given for Antenna 1, but the same description is applicable for Antenna 2 by changing the reference numerals. Power is delivered by a CPW feed 1 (5004-1), which is formed in a top ground electrode 5040 and acts as a matching device to pass the energy to a feed line 1 (5008-1) in the top metallization layer. A bottom ground electrode 5041 is formed directly below the top ground electrode 5040 in this example. A via 1 (5020-1) connects the feed line 1 (5008-1) to a launch pad 1 (5012-1) in the bottom metallization layer. The launch pad 1 (5012-1) is surrounded by a cell patch 1 (5016-1) formed in the bottom metallization layer. The cell patch 1 (5016-1) is connected to the top ground electrode 5040 by the means of a via 2 (5020-2), which is connected to a via line 1 (5024-1) formed in the top metallization layer.

The dimensions of the elements in the two-antenna array based on the MTM antenna structure having the launch pad surrounded by the cell patch illustrated in FIGS. 50(a)-50(d) are selected to generate frequency resonances in the low band around 2 GHz and the high band around 4-6 GHz, providing the capability of covering both WiFi bands. Examples of the design parameters in one exemplary implementation are provided below. The size of the PCB is 47 mm wide and 43 mm long, with 1 mm thickness. The material is FR4 with a dielectric constant of 4.4. Overall height of each antenna is 10.5 mm from the edge of the top ground electrode 5040, and its total length is 12.4 mm. The feed line 5008-1 is 4 mm in length and 0.5 mm in width, and the launch pad 1 (5020-1) has 5.5 mm in length and 0.5 mm in width. The width of the coupling gap 1 (5028-1) varies from 0.4 mm to 0.8 mm between the launch pad 5012-1 and the cell patch 1 (5016-1). The cell patch 1 (5016-1) is substantially rectangular shaped, with 12.4 mm in length and 8.9 mm in width with an opening inside to accommodate the launch pad 1 (5012-1). The via line 1 (5024-1) is 9 mm long in total, and has a width of 0.3 mm. Each of the via pads has rectangular dimensions of 1 mm by 0.7 mm.

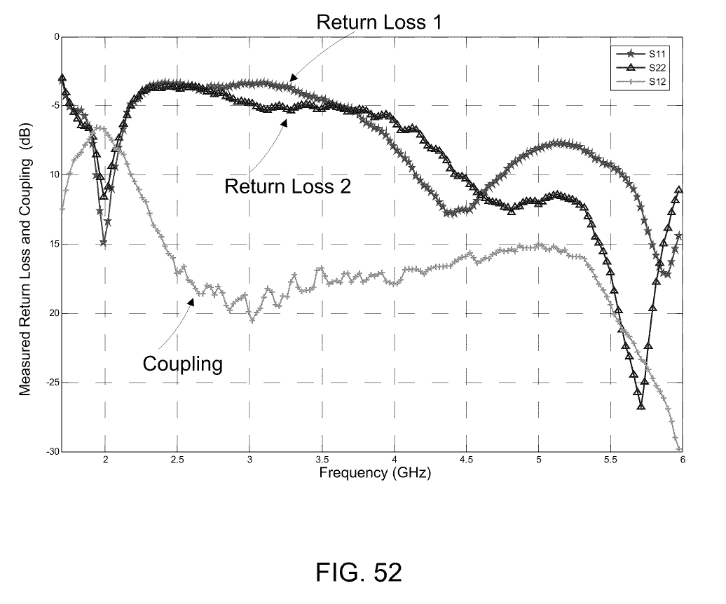

Each antenna in this two-antenna array has two frequency resonances as shown by the measured return loss in FIG. 52. Return Loss 1 (S11) and Return Loss 2 (S22) in this figure represent the return loss of Antenna 1 and that of Antenna 2, respectively, in this two-antenna array. The first resonance is centered at about 2 GHz with a bandwidth of 300 MHz at the −6 dB return loss. This is an LH mode resonance. The second resonance covers from about 4 to 6 GHz at the −6 dB return loss. This resonance is an RH (monopole) mode. In this case two major bands, the ˜2 GHz “low” band and the 4-6 GHz “high” band, can be defined, making this antenna structure suitable for WiFi applications.

The measured coupling between the two antennas (S12) is also plotted in FIG. 52. The isolation is defined to be “good” when the S12 coupling is less than −10 dB. It can be seen that significant coupling between the two antennas is present around 2 GHz in this example.

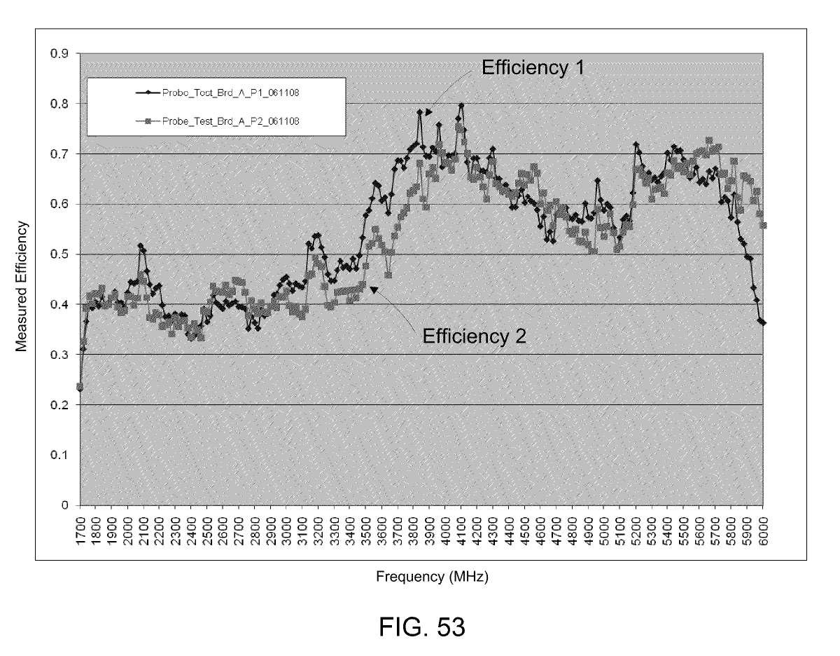

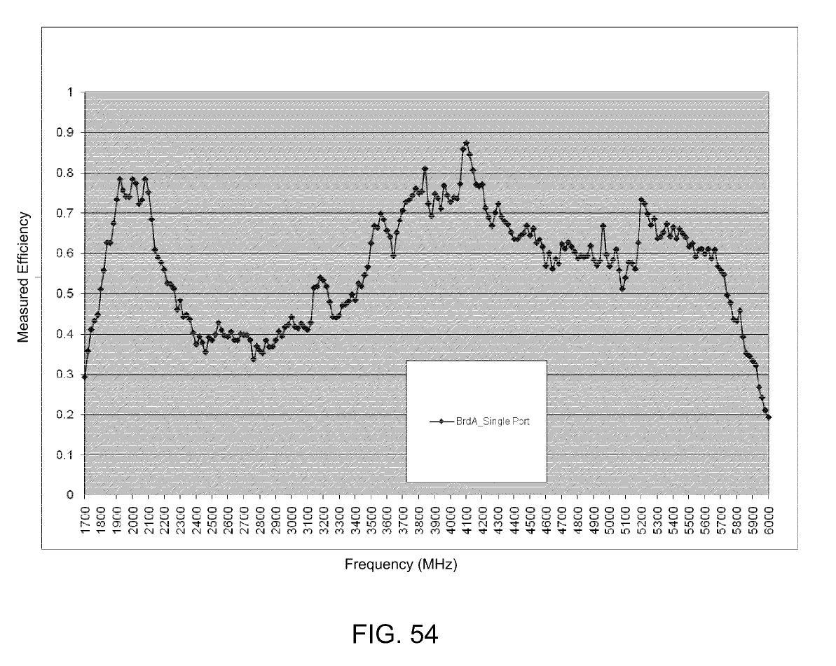

The measured efficiency associated with each antenna of the two-antenna array is plotted in FIG. 53, in which Efficiency 1 and Efficiency 2 refer to the efficiencies of Antenna 1 and Antenna 2, respectively. FIG. 54 shows the measured efficiency of a single antenna (e.g., Antenna 1) when the other antenna is removed from the board. The coupling loss, which results from the interaction between the two antennas, is not present in this case. Thus, the efficiency around the 2 GHz band increases significantly compared to that of each antenna in the two-antenna array shown in FIG. 53.

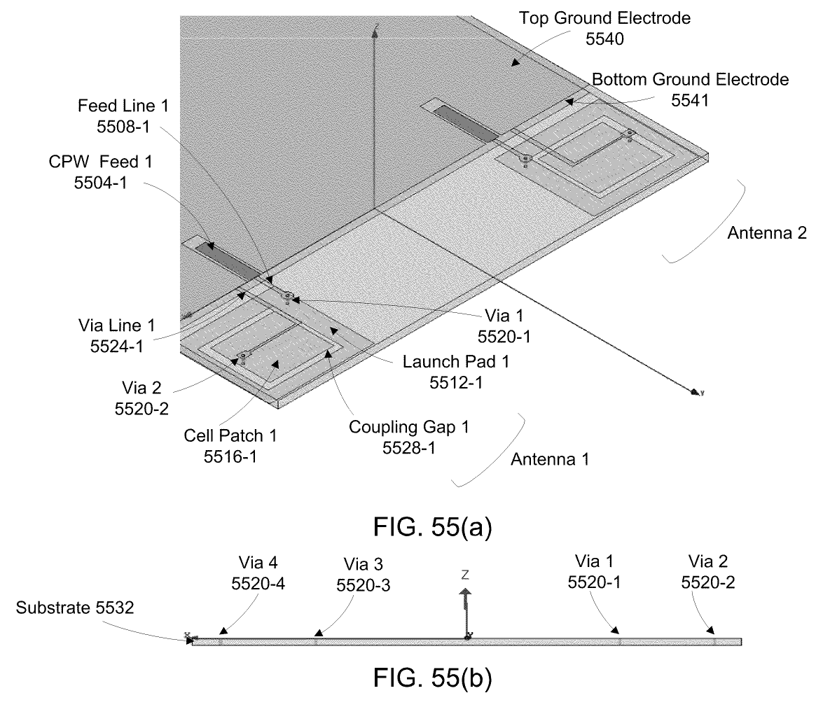

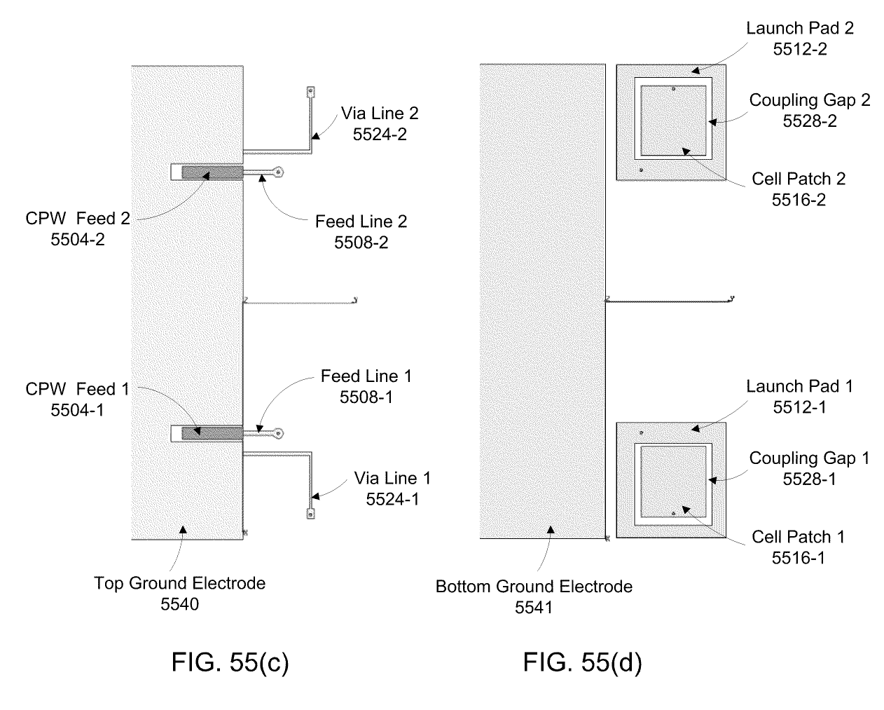

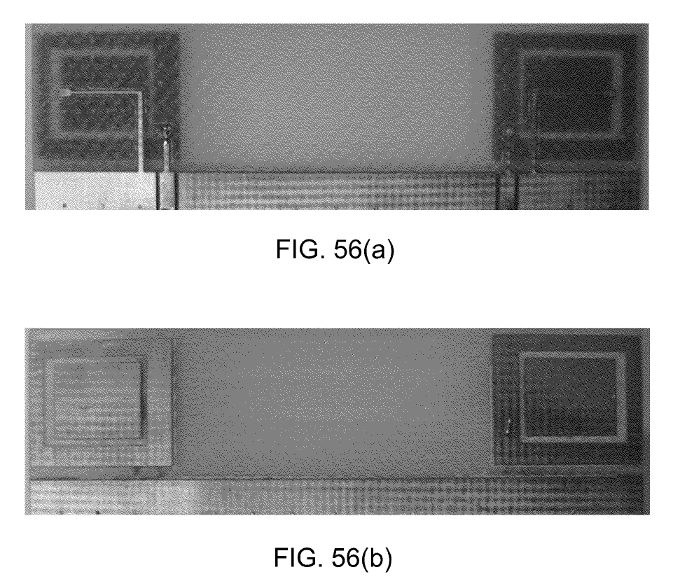

A coupling gap can be formed by having a cell patch surrounded by a launch pad, instead of the launch pad surrounded by the cell patch as in the above examples. FIGS. 55(a)-55(d) illustrate a two-antenna array based on such an MTM antenna structure, showing the 3D view, side view, top view of the top layer and top view of the bottom layer. The photos of a sample fabricated by using an FR-4 substrate are displayed in FIGS. 56(a) and 56(b), showing the top view of the top layer and bottom view of the bottom layer, respectively.

As shown in FIGS. 55(a) and 55(d), each launch pad is shaped to have an opening in the interior and each antenna, Antenna 1 or Antenna 2, in this two-antenna array has a cell patch located inside the opening of the respective launch pad and is surrounded by the launch pad in the bottom metallization layer. The description below is given for Antenna 1, but the same description is applicable for Antenna 2 by changing the reference numerals. Power is delivered by a CPW feed 1 (5504-1), which acts as a matching device to pass the energy to a feed line 1 (5508-1) in the top metallization layer. A via 1 (5520-1) connects the feed line 1 (5508-1) and a launch pad 1 (5512-1) in the bottom metallization layer. A cell patch 1 (5516-1) is surrounded by the launch pad 1 (5512-1), which is separated from the cell patch 1 (5516-1) by a coupling gap 1 (5528-1) providing capacitive coupling (CL). The cell patch 1 (5516-1) is then connected through a via 2 (5520-2) to a via line 1 (5524-1) in the top metallization layer, where the via line 1 (5524-1) is connected to a top ground electrode 5540.

The top ground electrode 5540 is formed above a bottom ground electrode 5541 so that the CPW feed 1 (5504-1) can be formed in the top ground electrode 5540. Therefore, as in the aforementioned examples, the CPW ground is formed by the top and bottom ground electrodes 5540 and 5541 in the present MTM antenna structure. Alternatively, the antenna can be fed with a CPW feed that does not require a ground plane on a different layer, a probed patch or a cable connector.

A possible design variation is to have the via line and another ground electrode in a third metallization layer, and have the via connecting the cell patch in the bottom metallization layer and the via line in the third metallization layer. The third metallization layer can be formed on the bottom surface of a second substrate which is stacked underneath the original substrate 5532, thus providing a multi-layer structure. The bottom ground electrode 5541, which is in the bottom metallization layer, can be moved to the third metallization layer instead of forming another ground electrode in the third metallization layer. The top and bottom metallization layers are interchangeable in the MTM antenna structure shown in FIGS. 55(a)-55(d) as well as the additional third metallization layer in its variations explained above.

The dimensions of the elements in the two-antenna array based on the MTM antenna structure having the cell patch surrounded by the launch pad illustrated in FIGS. 55(a)-55(d) are selected to generate frequency resonances to cover a very wide band. Examples of the design parameters in one exemplary implementation are provided below. The size of the substrate is 47 mm wide and 43 mm long, with 1 mm thickness. The material is FR4 with a dielectric constant of 4.4. Overall height of each antenna is 12 mm from the edge of the top ground electrode 5540, and its total length is 11.4 mm. The feed line 1 (5508-1) is 4 mm in length and 0.5 mm in width, and the launch pad 1 (5512-1) forms a square loop with outer dimensions of 11 mm×11 mm and a loop width of about 1.9 mm. The square loop surrounds the cell patch 1 (5516-1). The cell patch 1 (5516-1) has a substantially rectangular shape, with 7 mm in length and 6.5 mm in width. The via line 1 (5524-1) is 12.5 mm long in total, and has a width of 0.3 mm. Each of the via pads has rectangular dimensions of 1 mm by 0.7 mm.

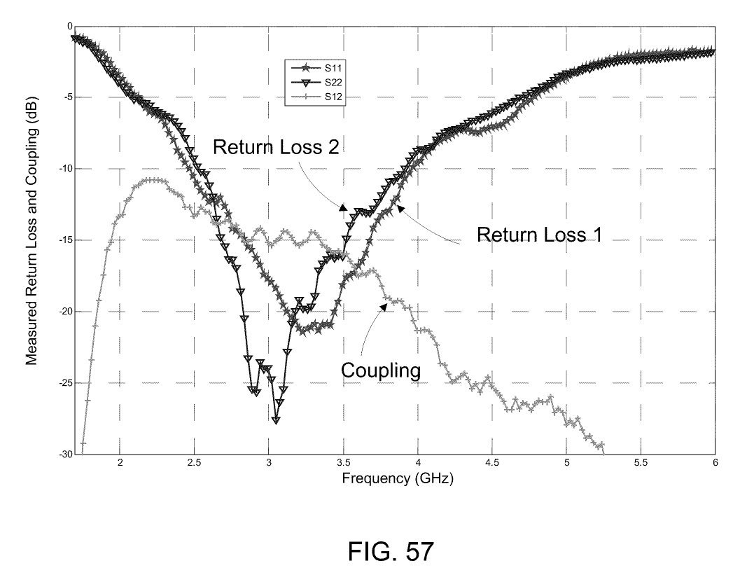

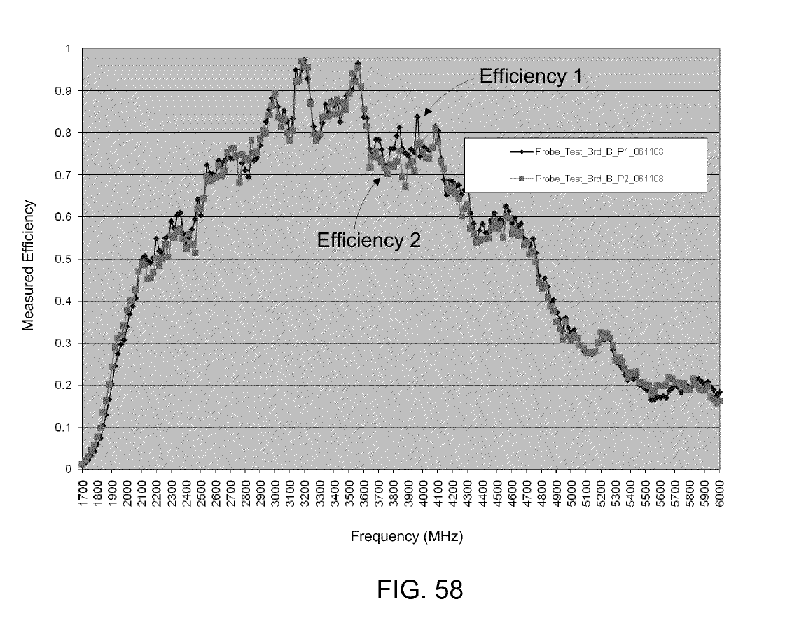

The measured return loss of the two-antenna array based on the MTM antenna having the cell patch surrounded by the launch pad as shown in FIGS. 55(a)-55(d) is plotted in FIG. 57. Return Loss 1 (S11) and Return Loss 2 (S22) in this figure represent the return loss of Antenna 1 and that of Antenna 2, respectively, in the two-antenna array. This MTM antenna structure allows the generation of radiating modes which are close together, merging both LH and RH modes to facilitate the coverage of a very wide band ranging from 2.1 to 4.7 GHz. These two modes can be tuned and split if the separate bands need to be covered individually instead of a wide continuous band. The measured coupling is also displayed in FIG. 57, showing good isolation between the two antennas in this very wide band. The measured efficiency associated with each of the two-antenna array is plotted in FIG. 58, showing good efficiency over the very wide band.

In the MTM antenna examples described above, the coupling geometry for capacitive coupling between the launch pad and cell patch is implemented in a planar fashion where both the launch pad and cell patch are located on the same metallization layer and thus the coupling gap between the two is formed in the same plane. However, the coupling gap can be formed vertically, that is, the launch pad and cell patch can be located on two different layers, thereby forming a vertical, non-planar coupling gap in between.

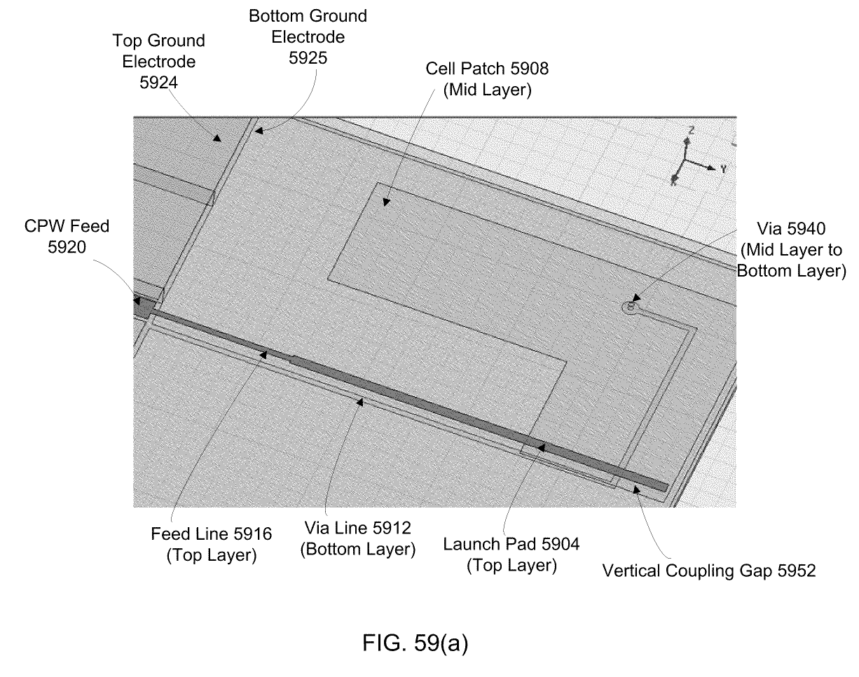

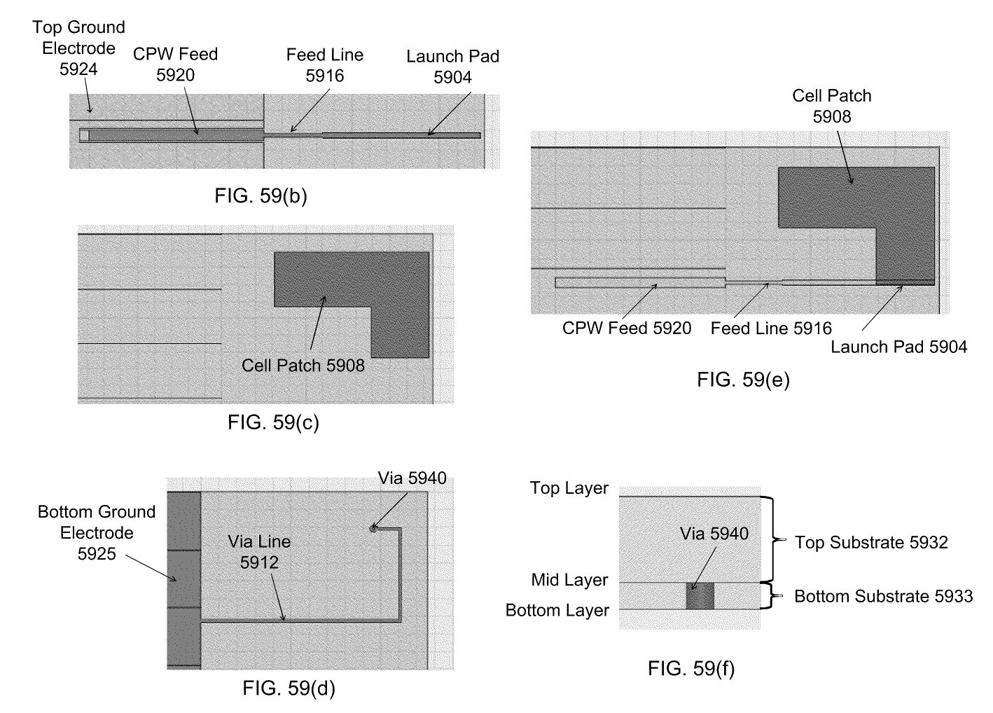

An example of a three-layer MTM antenna with the vertical coupling between a cell patch and launch pad at different layers is illustrated in FIGS. 59(a)-59(f), showing the 3D view, top view of the top layer, top view of the middle layer, top view of the bottom layer, top view of the top and middle layers overlaid, and the side view, respectively. As shown in FIG. 59(f), this three-layer MTM structure has a top substrate 5932 and a bottom substrate 5933 that are stacked over each other to provide three metallization layers: the top layer on the top surface of the top substrate 5932, the middle layer between the two substrates 5932 and 5933, and the bottom layer on the bottom surface of the bottom substrate 5933. In one implementation, the middle layer is 30 mil (0.76 mm) below the top layer, and the bottom layer is 1 mm below the top layer. This keeps the overall thickness of 1 mm, the same as in a two-layer structure.

The top layer includes a feed line 5916 that connects a CPW feed 5920 to a launch pad 5904. The CPW feed 5929 can be formed in a CPW structure that has a top ground electrode 5924 and a bottom ground electrode 5925. Both the feed line 5916 and launch pad 5904 have a rectangular shape with dimensions of 6.7 mm×0.3 mm and 18 mm×0.5 mm, respectively. The middle layer includes an L-shaped cell patch 4808 which may, in one implementation, have one section with dimensions of 6.477 mm×18.4 mm and the other section with dimensions of 6.0 mm×6.9 mm. A vertical coupling gap 5952 is formed between the launch pad 5904 in the top layer and the cell patch 5908 in the middle layer. A via 5940 is formed in the bottom substrate to couple the cell patch 5908 in the middle layer to a via line 5912 in the bottom layer. The via line 5912 in the bottom layer is shorted to the bottom ground electrode 5925 with two bends, as can be seen from FIG. 59(d).

A possible design variation is to have the via line in the top layer connected to the top ground electrode 5924 and the via connecting the cell patch in the middle layer and the via line in the top layer. Another variation is to have the via line in the middle layer directly connecting the cell patch 5908 to another ground electrode formed in the middle layer. The bottom (third) layer and the bottom substrate can be eliminated in these variations. The top, middle and bottom metallization layers are interchangeable in the three-layer MTM antenna structure in this example.

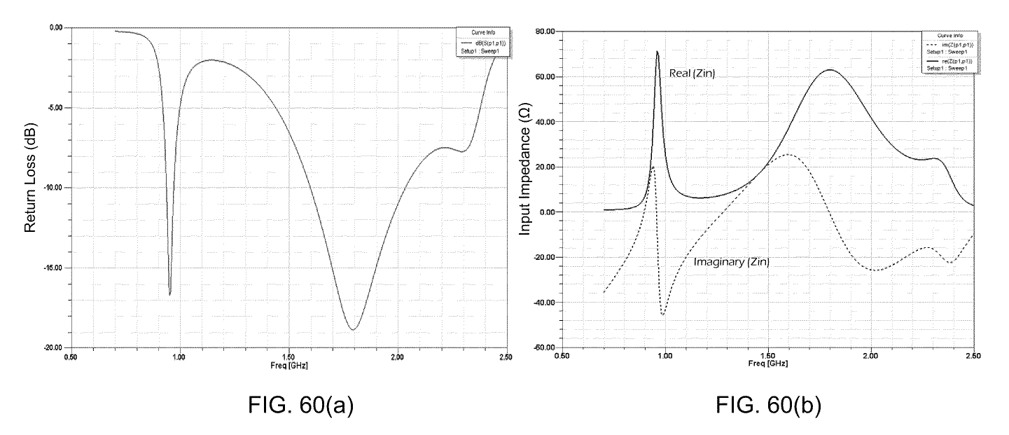

Design parameters for the three-layer MTM antenna with the vertical coupling shown in FIGS. 59(a)-59(f) are chosen as described above to generate frequency resonances that can support quad-band cell phone operations. The simulated return loss of this MTM antenna is plotted in FIG. 60(a), which shows two bands at the −6 dB return loss: the low band at 0.925-0.99 GHz and the high-band at 1.48-2.36 GHz, providing the capability of covering the quad-band.

The simulated input impedance of this MTM antenna with the vertical coupling is plotted in FIG. 60(b). Generally, a perfect 50Ω matching corresponds to Real(Zin)=50Ω and Imaginary(Zin)=0 within the operating frequency band, and implies good transfer of energy between the CPW feed and antenna. FIG. 60(b) shows that good matching occurs near 950 MHZ in the low band (LH mode) and near 1.8 GHz in the high band (RH mode).

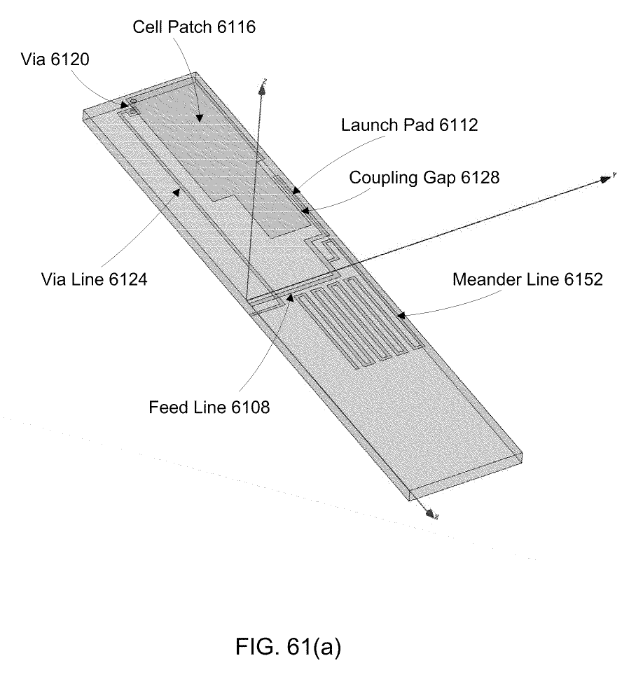

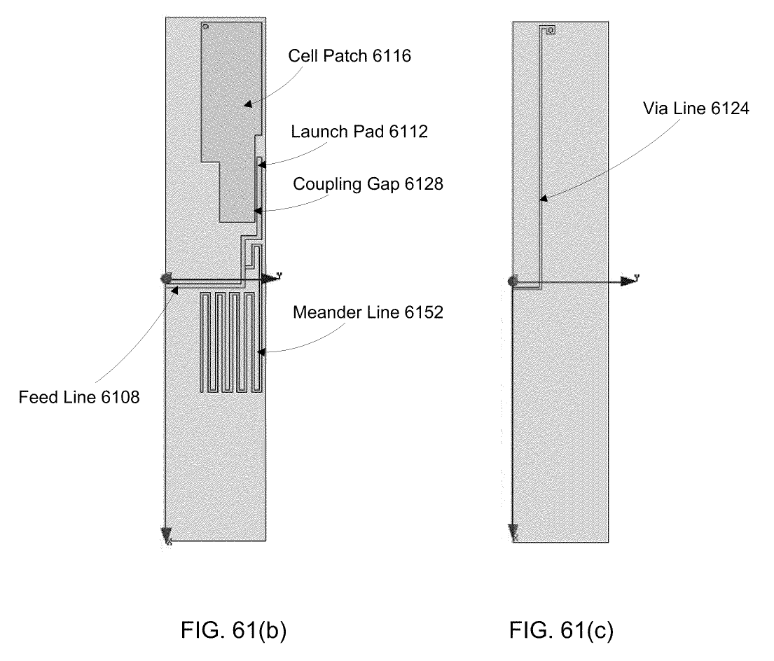

Various practical implementations may pose space constraints that require a certain routing of traces in the antenna structure. An MTM antenna can be compacted by using lumped circuit elements, such as capacitors or inductors, to augment the inductance and capacitance involved in the MTM structure. The MTM antenna structure with a conductive meander line shown in FIGS. 61(a)-61(c) is used as the base structure to evaluate the effects arising from adding lumped elements. This MTM structure is similar to the reduced-size one-cell two-layer MTM structure with the meander line shown in FIGS. 40(a)-40(b), except that the meander line is located on the other side of the cell patch from the feed line. The ground electrodes and the CPW feed are not illustrated in these figures for simplicity. Specifically, in this structure, a feed line 6108 is formed in the top metallization layer and is connected to a launch pad 6112 to direct a signal to or receive a signal from a cell patch 6116 through a coupling gap 6128. A via 6120 connects the cell patch 6116 and a via line 6124 that is formed in the bottom metallization layer and connected to a bottom ground electrode. A meander line 6152 is added to the feed line 6108.

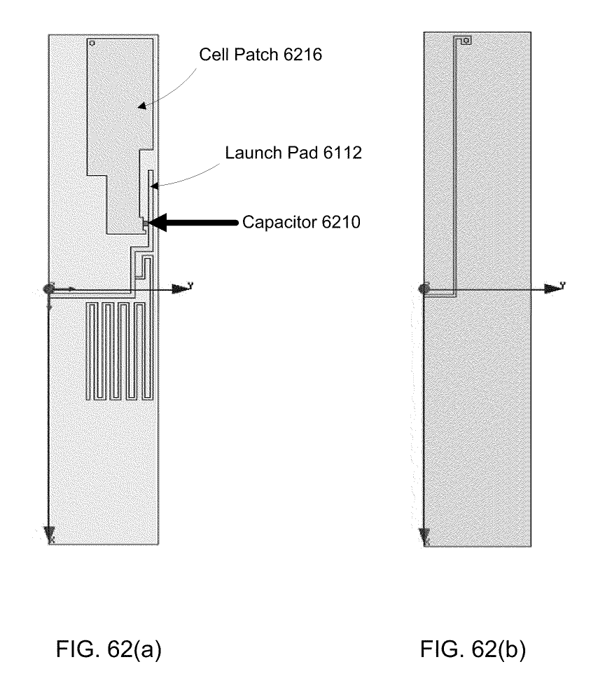

In the MTM antenna structure shown in FIGS. 62(a) and 62(b), the capacitance between the launch pad 6112 and the cell patch 6216 is enhanced by using a lumped capacitor 6210. In this example, the width of the coupling gap 6128 in the base structure shown in FIG. 61(b) is increased by reducing the width of the cell patch from the size of the cell patch 6116 in FIG. 61(b) to the size of the cell patch 6216 in FIG. 62(a), and the reduced capacitance is compensated for by the added lumped capacitor 6210. Instead of increasing the width of the gap, the length of the gap can be reduced and the reduced capacitance can be compensated for by adding a lumped capacitor.

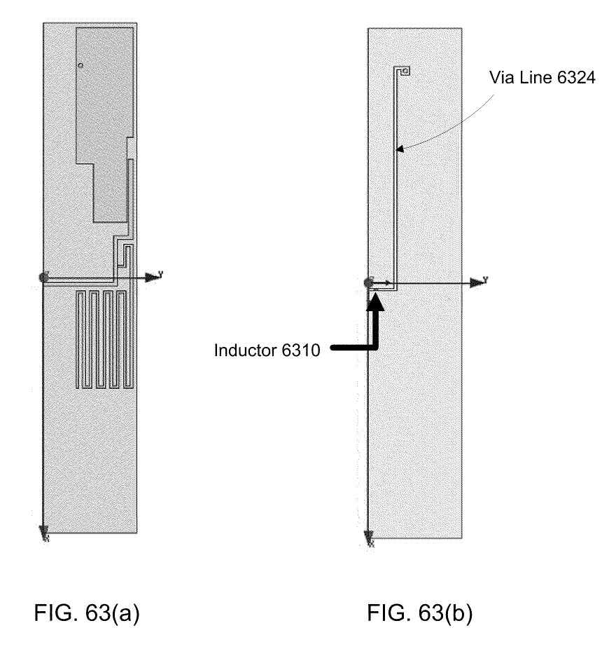

In the MTM antenna structure shown in FIGS. 63(a) and 63(b), a lumped inductor 6310 is added to the via line trace. The length of the via line 6124 in FIG. 61(c) is reduced to the length of the via line 6324 shown in FIG. 63(b), and the reduced inductance due to the shortened via line 6324 is compensated for by the added lumped inductor 6310.

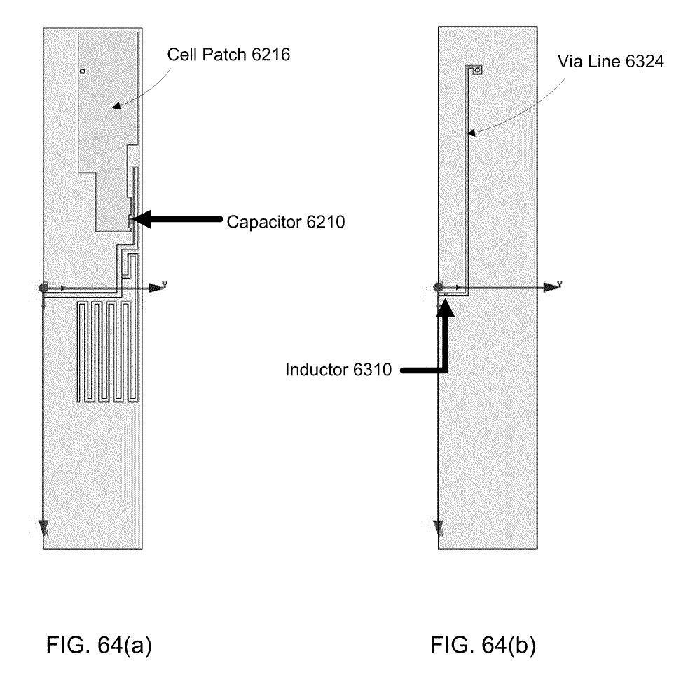

In the MTM antenna structure shown in FIGS. 64(a) and 64(b), the lumped inductor 6310 is added to the via line trace and the lumped capacitor 6210 is added to the coupling gap. The via line is shortened and the gap width is widened as in the above examples.

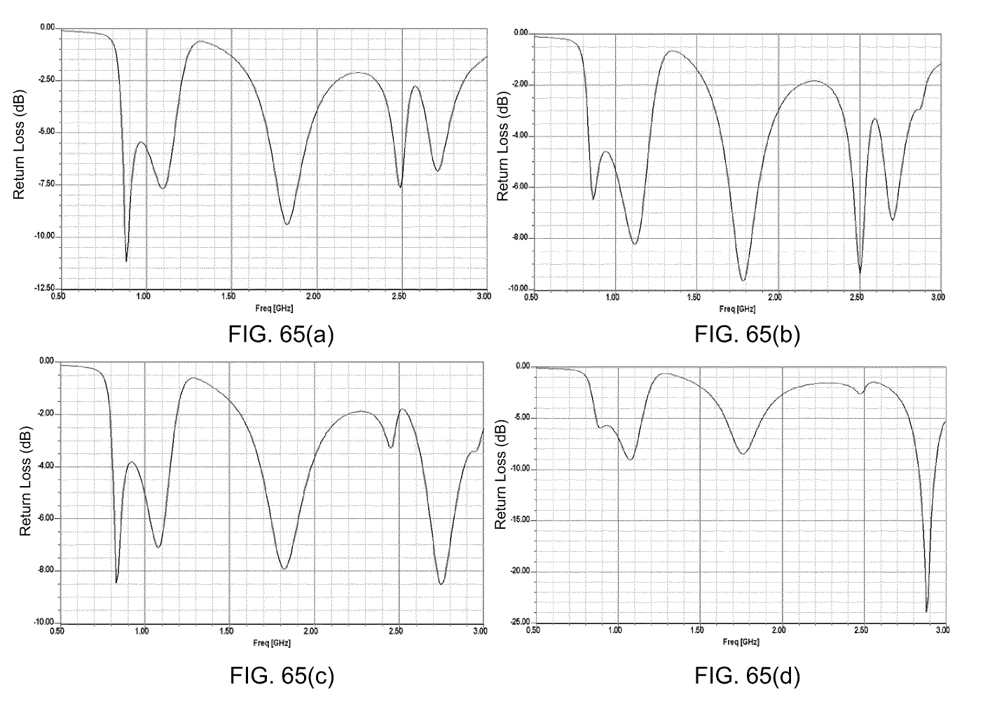

FIGS. 65(a)-65(d) show the simulated return loss results for several MTM structures. FIG. 65(a) shows the simulated return loss of the base MTM structure without any lumped components shown in FIGS. 61(a)-61(c). FIG. 65(b) shows the simulated return loss of the MTM structure with the lumped capacitor 6210 and the reduced-width cell patch 6216 in FIGS. 62(a)-62(b). FIG. 65(c) shows the simulated return loss of the MTM structure with the lumped inductor 6310 and the shortened via line 6324 in FIGS. 63(a)-63(b). FIG. 65(d) shows the simulated return loss of the MTM structure with both the lumped capacitor 6210 and the lumped inductor 6310 with the reduced-width cell patch and the shortened via line in FIGS. 64(a)-64(b), respectively. Qualitatively similar results are obtained for all four cases.

Lumped components can be added to various parts of the MTM antenna structure to achieve certain desired effects. For example, an inductor can be added to the meander line, and the length of the meander line can be reduced. In this example, the reduced inductance due to the shortened meander line is compensated for by the addition of the inductor while maintaining the similar antenna performance. Since lumped components do not radiate, they can be placed at locations where there is little radiation to minimize the impact on the radiation efficiency of the antenna. For example, it is possible to obtain the same resonance by adding an inductor at the beginning or end of the meander line. However, adding the inductor at the end of the meander line may significantly reduce the radiation efficiency because the end of the meander line has the highest radiation. It should be noted that these lumped-component loading techniques can be combined to achieve further miniaturization.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements may be made.

What is claimed is:

1. A metamaterial device comprising:
a substrate;
a plurality of metallization layers associated with the substrate and patterned to have a plurality of conductive parts; and
a conductive via formed in the substrate to connect a conductive part in one metallization layer to a conductive part in another metallization layer,
wherein the conductive parts and the conductive via form a composite right and left handed (CRLH) metamaterial structure.

2. The device as in claim 1, wherein the conductive parts and the conductive via of the CRLH metamaterial structure are structured to form a metamaterial antenna and are configured to generate two or more frequency resonances.

3. The device as in claim 2, wherein at least two out of the two or more frequency resonances are sufficiently close to produce a wide band.

4. The device as in claim 1, wherein the conductive parts and the conductive via of the CRLH metamaterial structure are configured to generate a first frequency resonance in a low band and a second frequency resonance in a high band, the first frequency resonance being a left-handed (LH) mode frequency resonance and the second frequency resonance being a right-handed (RH) mode frequency resonance.

5. The device as in claim 1, wherein the conductive parts and the conductive via of the CRLH metamaterial structure are configured to generate a first frequency resonance in a low band, a second frequency resonance in a high band, and a third frequency resonance which is substantially close in frequency to the first frequency resonance to be coupled with the first frequency resonance, providing a combined mode resonance band that is wider than the low band.

6. The device as in claim 5, wherein the first frequency resonance is a left-handed (LH) mode frequency resonance, the second frequency resonance is a right-handed (RH) mode frequency resonance, and the third frequency resonances is another right-handed (RH) mode frequency resonance.

7. The device as in claim 5, wherein a bandwidth of the combined mode resonance band is about 150 MHz or more.

8. The device as in claim 6, wherein the RH mode frequency resonance is a monopole mode frequency resonance.

9. The device as in claim 1, wherein the conductive parts and the conductive via of the CRLH metamaterial structure are configured to generate two or more frequency resonances to cover WiFi bands.

10. The device as in claim 1, wherein the conductive parts and the conductive via of the CRLH metamaterial structure are configured to generate the two or more frequency resonances to cover part of a cellular band and a PCS/DCS band for quad-band antenna operations.

11. The device as in claim 1, wherein the conductive parts and the conductive via of the CRLH metamaterial structure are configured to generate two or more frequency resonances to cover a cellular band and a PCS/DCS band for penta-band antenna operations.

12. The device as in claim 1, wherein the conductive parts and the conductive via of the CRLH metamaterial structure are configured to generate two or more frequency resonances to cover WiMax bands.

13. The device as in claim 1, wherein the conductive parts and the conductive via of the CRLH metamaterial structure are structured to form a metamaterial transmission line and are configured to generate two or more frequency resonances.

14. The device as in claim 1, further comprising a lumped circuit element coupled to the conductive parts.

15. The device as in claim 1, wherein the conductive parts and the conductive via of the CRLH metamaterial structure are structured to form a plurality of metamaterial antennas and are configured to generate two or more frequency resonances.

16. The device as in claim 1, wherein the CRLH metamaterial structure is sized based on a trade-off between the size and efficiency.

17. The device as in claim 1, wherein:
the substrate has a first surface and a second surface opposite to the first surface,
the plurality of metallization layers include a first metallization layer formed on the first surface and a second metallization layer formed on the second surface, and
the conductive parts of the CRLH metamaterial structure comprise: (1) a ground electrode formed in the second metallization layer; (2) a cell patch formed in the first metallization layer; (3) a via line formed in the second metallization layer and connecting the ground electrode and the conductive via, which connects to the cell patch in the first metallization layer; (4) a feed line formed in the first metallization layer; and (5) a launch pad formed at a distal end of the feed line and electromagnetically coupled to the cell patch through a gap to direct a signal to or from the cell patch.

18. The device as in claim 17, wherein the CRLH metamaterial structure is configured to generate a left-handed (LH) mode frequency resonance in a low band and a right-handed (RH) mode frequency resonance in a high band.

19. The device as in claim 18, wherein the low band includes part of a cellular band and the high band includes a PCS/DCS band for quad-band antenna operations.

20. The device as in claim 1, wherein
the substrate has a first surface and a second surface opposite to the first surface,
the plurality of metallization layers include a first metallization layer formed on the first surface and a second metallization layer formed on the second surface, and
the conductive parts of the CRLH metamaterial structure comprise:
a ground electrode formed in the second metallization layer;
a first cell patch and a second cell patch formed in the first metallization layer;
a via line formed in the second metallization layer and connecting the ground electrode and the conductive via, which connects to the first cell patch in the first metallization layer; and
a feed line formed in the first metallization layer; and
a launch pad formed at a distal end of the fee line and electromagnetically coupled to the first and second cell patches through a first and second gaps, respectively, to direct signals to or from the first and second cell patches.

21. The device as in claim 20, wherein the CRLH metamaterial structure is configured to generate a left-handed (LH) mode frequency resonance in a low band and a first right-handed (RH) mode frequency resonance in a high band, and a second RH mode frequency resonance which is mainly controlled by a configuration of the second cell patch and is substantially close in frequency to the LH mode frequency resonance to be coupled with the LH mode frequency resonance, providing a combined mode resonance band that is wider than the low band.

22. The device as in claim 21, wherein the combined mode resonance band includes a cellular band and the high band includes a PCS/DCS band for penta-band antenna operations.

23. The device as in claim 20, further comprising:
a via line extension formed in the second metallization layer and connected to the via line for improving matching.

24. The device as in claim 1, wherein
the substrate comprises a main substrate and an elevated substrate which is placed above the main substrate with a spacing between the main and elevated substrates, the elevated substrate having a first surface and a second surface opposite to the first surface, the main substrate having a third surface and a fourth surface opposite to the third surface, the second and third surfaces facing each other with the spacing in between,
the plurality of metallization layers include a first metallization layer formed on the first surface, a second metallization layer formed on the second surface, a third metallization layer formed on the third surface and a fourth metallization layer formed on the fourth surface, the conductive via includes a first via, a second via, and a third via, and
the conductive parts of the CRLH metamaterial structure comprise:
a ground electrode formed in the fourth metallization layer;
a first cell patch and a second cell patch formed in the first metallization layer;
a first via line formed in the second metallization layer and connected to the first cell patch by the first via which is formed in the elevated substrate;
a second via line formed in the fourth metallization layer and connected to the first via line in the second metallization layer by the second via which penetrates through the main substrate and the spacing;
a first feed line formed in the third metallization layer;
a second feed line formed in the first metallization layer and connected to the first feed line in the third metallization layer by the third via which penetrates through the elevated substrate and the spacing; and
a launch pad formed at a distal end of the second feed line and electromagnetically coupled to the first and second cell patches through a first and second gaps, respectively, to direct signals to or from the first and second cell patches.

25. The device as in claim 24, wherein the CRLH metamaterial structure is configured to generate a left-handed (LH) mode frequency resonance in a low band and a first right-handed (RH) mode frequency resonance in a high band, and a second RH mode frequency resonance which is mainly controlled by a configuration of the second cell patch and is substantially close in frequency to the LH mode frequency resonance to be coupled with the LH mode frequency resonance, providing a combined mode resonance band that is wider than the low band.

26. The device as in claim 25, wherein the spacing between the main and elevated substrates is increased to improve matching in a frequency range between the low band and the high band.

27. The device as in claim 24, further comprising:
a via line extension formed in the second metallization layer and connected to the via line for improving matching.

28. The device as in claim 1, wherein
the substrate has a first surface and a second surface opposite to the first surface,
the plurality of metallization layers include a first metallization layer on the first surface and a second metallization layer on the second surface, and
the CRLH metamaterial structure comprises a first metamaterial antenna and a second metamaterial antenna,
wherein each of the first and second metamaterial antennas comprises:
a ground electrode formed in the second metallization layer;
a cell patch formed in the first metallization layer;
a via line formed in the second metallization layer and connecting the ground electrode and the conductive via, which connects to the cell patch in the first metallization layer; and
a feed line formed in the first metallization layer; and
a launch pad formed at a distal end of the feed line and electromagnetically coupled to the cell patch through a gap to direct a signal to or from the cell patch.

29. The device as in claim 28, wherein the first metamaterial antenna is configured to generate a low frequency resonance in a low band, and the second metamaterial antenna is configured to generate a high frequency resonance in a high band.

30. The device as in claim 29, wherein the low frequency resonance is a left-handed (LH) mode resonance, and the feed line in the first metamaterial antenna is formed to be substantially long to generate a monopole mode resonance close to and higher than the LH mode resonance in frequency to be coupled with the LH mode resonance, providing a combined mode resonance band that is wider than the low band.

31. The device as in claim 1, wherein the conductive parts and the conductive via of the CRLH metamaterial structure are structured to form a receive diversity antenna array comprising a plurality of metamaterial antennas which are configured to generate different frequency resonances.

32. The device as in claim 31, wherein the plurality of metamaterial antennas of the receive diversity antenna array are configured to be compact based on a trade-off between the size and efficiency.

33. The device as in claim 31, wherein
the substrate has a first surface and a second surface opposite to the first surface,
the plurality of metallization layers include a first metallization layer on the first surface and a second metallization layer on the second surface, and
the plurality of metamaterial antennas comprise a first metamaterial antenna, a second metamaterial antenna and a third antenna,
wherein each of the first, second and third metamaterial antennas comprises:
a ground electrode formed in the second metallization layer;
a cell patch formed in the first metallization layer;
a via line formed in the second metallization layer and connecting the ground electrode and the conductive via, which connects to the cell patch in the first metallization layer; and
a feed line formed in the first metallization layer; and
a launch pad attached at a distal end of the feed line and electromagnetically coupled to the cell patch through a gap to direct a signal to or from the cell patch.

34. The device as in claim 33, wherein the ground electrode is common for the first, second and third metamaterial antennas and has extended portions for improving matching and isolation.

35. The device as in claim 33, wherein the first metamaterial antenna is configured to generate a first LH frequency resonance to cover a US Cell Rx 869-894 MHz band, the second metamaterial antenna is configured to generate a second LH frequency resonance to cover a GPS1570-1580 MHz band, and the third metamaterial antenna is configured to generate a third LH frequency resonance to cover a PCS Rx 1930-1990 MHz band.

36. The device as in claim 1, wherein
the substrate has a first surface and a second surface opposite to the first surface,
the plurality of metallization layers include a first metallization layer formed on the first surface and a second metallization layer formed on the second surface, the conductive via includes a first via, and
the conductive parts of the CRLH metamaterial structure comprises:
a ground electrode formed in the second metallization layer;
a first cell patch formed in the first metallization layer;
a second cell patch formed in the second metallization layer and connected to the first cell patch by the first via;
a via line formed in the second metallization layer and connecting the ground electrode and the second cell patch; and
a feed line formed in the first metallization layer; and
a launch pad formed at a distal end of the feed line and electromagnetically coupled to the first cell patch through a first gap to direct signals to or from the first cell patch;
a first conductive line formed in the first metallization layer and attached to the feed line or the launch pad; and
a second conductive line formed in the second metallization layer and positioned to substantially overlay with the first conductive line, the second conductive line being electromagnetically coupled to the second cell patch through a second gap.

37. The device as in claim 36, wherein
the conductive via further includes a second via, which connects the top conductive line and the bottom conductive line, to improve matching.

38. The device as in claim 36, wherein the CRLH metamaterial structure is configured to generate an LH mode frequency resonance in a low band, and the top conductive line is configured to generate a monopole mode frequency resonance at a frequency close to and higher than the LH mode frequency resonance.

39. The device as in claim 36, wherein the top and bottom conductive lines are in a spiral form.

40. The device as in claim 36, wherein the top and bottom conductive lines are in a meander form.

41. The device as in claim 1, wherein
the substrate has a first surface and a second surface opposite to the first surface,
the plurality of metallization layers include a first metallization layer formed on the first surface and a second metallization layer formed on the second surface,
the conductive via includes a first via and a second via, and
the conductive parts of the CRLH metamaterial structure comprise:
a ground electrode formed in the first metallization layer;
a first cell patch formed in the first metallization layer;
a second cell patch formed in the second metallization layer and connected to the first cell patch by the first via;
a via line formed in the first metallization layer and connecting the ground electrode and the first cell patch; and
a feed line formed in the first metallization layer; and
a launch pad formed at a distal end of the feed line and electromagnetically coupled to the first cell patch through a gap to direct a signal to or from the first cell patch;
a first conductive line formed in the first metallization layer and attached to the feed line or the launch pad; and
a second conductive line formed in the second metallization layer and connected to the first cell patch by the second via.

42. The device as in claim 41, wherein the CRLH metamaterial structure is configured to generate a left-handed (LH) mode frequency resonance in a low band and a first monopole mode frequency resonance in a high band, and a second monopole mode frequency resonance which is mainly controlled by a configuration of the top conductive line and is substantially close in frequency to the LH mode frequency resonance to be coupled with the LH mode frequency resonance, providing a combined mode resonance band that is wider than the low band.

43. The device as in claim 42, wherein the combined mode resonance band includes a cellular band and the high band includes a PCS/DCS band for penta-band antenna operations.

44. The device as in claim 41, wherein the top conductive line is in a spiral form.

45. The device as in claim 41, wherein the top conductive line is in a meander form.

46. The device as in claim 17, wherein the conductive parts of the CRLH metamaterial structure further comprise a conductive line formed in the first metallization layer and attached to the feed line or the launch pad.

47. The device as in claim 46, wherein the CRLH metamaterial structure is configured to generate a left-handed (LH) mode frequency resonance in a low band and a first monopole mode frequency resonance in a high band, and a second monopole mode frequency resonance which is mainly controlled by a configuration of the conductive line and is substantially close in frequency to the LH mode frequency resonance to be coupled with the LH mode frequency resonance, providing a combined mode resonance band that is wider than the low band, and
wherein the combined mode resonance band includes a cellular band and the high band includes a PCS/DCS band for penta-band antenna operations.

48. The device as in claim 17, further comprising a capacitor that couples the cell patch and the launch pad, wherein a width of the gap is increased and/or a length of the gap is decreased as compared to the width and/or the length of the gap in the absence of the capacitor based on a capacitance value of the capacitor.

49. The device as in claim 17, further comprising an inductor inserted in the via line, wherein a length of the via line is shortened as compared to the length of the via line in the absence of the inductor based on an inductance value of the inductor.

50. The device as in claim 46, further comprising an inductor inserted in the conductive line, wherein a length of the conductive line is shortened as compared to the length of the conductive line in the absence of the inductor based on an inductance value of the inductor.

51. The device as in claim 17, wherein the conductive parts of the CRLH metamaterial structure further comprise a three-dimensional conductive line attached to the feed line or the launch pad, the three-dimensional conductive line comprising:
a first conductive line portion formed in the first metallization layer;
a second conductive line portion formed in the second metallization layer; and
a conductive line via portion formed in the substrate and connecting the first conductive line portion and the second conductive line portion.

52. The device as in claim 51, wherein the three-dimensional conductive line is in a spiral form.

53. The device as in claim 51, wherein the three-dimensional conductive line is in a meander form.

54. The device as in claim 51, wherein the CRLH metamaterial structure is configured to generate two or more frequency resonances to cover a CDMA band.

55. The device as in claim 1, wherein
the substrate has a first surface and a second surface opposite to the first surface,
the plurality of metallization layers include a first metallization layer formed on the first surface and a second metallization layer formed on the second surface,
the via includes a first via and a second via, and
the conductive parts of the CRLH metamaterial structure comprise:
a ground electrode formed in the first metallization layer;
a cell patch formed in the second metallization layer and patterned to define an internal opening;
a via line formed in the first metallization layer and connecting the ground electrode and the first via, which connects to the cell patch in the second metallization layer; and
a feed line formed in the first metallization layer; and
a launch pad formed in the second metallization layer within the internal opening and connected to the feed line by the second via, wherein the launch pad is surrounded by the cell patch and electromagnetically coupled to the cell patch through a gap to direct a signal to or from the cell patch.

56. The device as in claim 1, wherein
the substrate has a first surface and a second surface opposite to the first surface,
the plurality of metallization layers include a first metallization layer formed on the first surface and a second metallization layer formed on the second surface, and
the conductive parts of the CRLH metamaterial structure comprise:
a ground electrode formed in the second metallization layer;
a cell patch formed in the second metallization layer and patterned to define an internal opening;
a via line formed in the second metallization layer and connecting the ground electrode and the cell patch; and
a feed line formed in the first metallization layer; and
a launch pad formed in the second metallization layer within the internal opening and connected to the feed line by the via, wherein the launch pad is surrounded by the cell patch and electromagnetically coupled to the cell patch through a gap to direct a signal to or from the cell patch.

57. The device as in claim 1, wherein
the substrate is a multilayer substrate,
the plurality of metallization layers include a first metallization layer, a second metallization layer and a third metallization layer, which are associated with the multilayer substrate,
the via includes a first via and a second via, and
the conductive parts of the CRLH metamaterial structure comprise:
a ground electrode formed in the third metallization layer;
a cell patch formed in the second metallization layer and patterned to define an internal opening;
a via line formed in the third metallization layer and connecting the ground electrode and the first via, which connects to the cell patch in the second metallization layer; and
a feed line formed in the first metallization layer; and
a launch pad formed in the second metallization layer within the internal opening and connected to the feed line by the second via, wherein the launch pad is surrounded by the cell patch and electromagnetically coupled to the cell patch through a gap to direct a signal to or from the cell patch.

58. The device as in claim 55, wherein the CRLH metamaterial structure is configured to generate an LH frequency resonance in a low band and an RH frequency resonance in a high band.

59. The device as in claim 58, wherein the CRLH metamaterial structure is configured to generate the LH frequency resonance and the RH frequency resonance to cover WiFi bands.

60. The device as in claim 1, wherein
the substrate has a first surface and a second surface opposite to the first surface,
the plurality of metallization layers include a first metallization layer formed on the first surface and a second metallization layer formed on the second surface,
the via includes a first via and a second via, and
the conductive parts of the CRLH metamaterial structure comprise:
a ground electrode formed in the first metallization layer;
a feed line formed in the first metallization layer; and
a launch pad formed in the second metallization layer and patterned to define an internal opening, the launch pad being connected to the feed line by the first via,
a cell patch formed in the second metallization layer within the internal opening;
a via line formed in the first metallization layer and connecting the ground electrode and the second via, which connects to the cell patch in the second metallization layer;
wherein the launch pad surrounds the cell patch and is electromagnetically coupled to the cell patch through a gap to direct a signal to or from the cell patch.

61. The device as in claim 1, wherein
the substrate has a first surface and a second surface opposite to the first surface,
the plurality of metallization layers include a first metallization layer formed on the first surface and a second metallization layer formed on the second surface, and
the conductive parts of the CRLH metamaterial structure comprise:
a ground electrode formed in the first metallization layer;
a feed line formed in the second metallization layer; and
a launch pad formed in the second metallization layer at a distal end of the feed line and patterned to define an internal opening,
a cell patch formed in the second metallization layer within the internal opening;
a via line formed in the first metallization layer and connecting the ground electrode and the via, which connects to the cell patch in the second metallization layer;
wherein the launch pad surrounds the cell patch and is electromagnetically coupled to the cell patch through a gap to direct a signal to or from the cell patch.

62. The device as in claim 1, wherein
the substrate is a multilayer substrate,
the plurality of metallization layers include a first metallization layer, a second metallization layer and a third metallization layer, which are associated with the multilayer substrate,
the via includes a first via and a second via, and
the conductive parts of the CRLH metamaterial structure comprise:
a ground electrode formed in the third metallization layer;
a feed line formed in the first metallization layer; and
a launch pad formed in the second metallization layer and patterned to define an internal opening, the launch pad being connected to the feed line by the first via,
a cell patch formed in the second metallization layer within the internal opening;
a via line formed in the third metallization layer and connecting the ground electrode and the second via, which connects to the cell patch in the second metallization layer;
wherein the launch pad surrounds the cell patch and is electromagnetically coupled to the cell patch through a gap to direct a signal to or from the cell patch.

63. The device as in claim 60, wherein the CRLH metamaterial structure is configured to generate an LH frequency resonance in a low band and an RH frequency resonance in a high band.

64. The device as in claim 63, wherein the CRLH metamaterial structure is configured to generate the low band and the high band substantially close to be coupled with each other, providing a wide band with a bandwidth of about 2.5 GHz or more.

65. The device as in claim 1, wherein
the substrate is a multilayer substrate,
the plurality of metallization layers include a first metallization layer, a second metallization layer and a third metallization layer, which are associated with the multilayer substrate, and
the conductive parts of the CRLH metamaterial structure comprise:
a ground electrode formed in the third metallization layer;
a feed line formed in the first metallization layer;
a launch pad formed at a distal end of the feed line in the first metallization layer;
a cell patch formed in the second metallization layer; and
a via line formed in the third metallization layer and connecting the ground electrode and the via, which connects to the cell patch in the second metallization layer;
wherein the launch pad is electromagnetically coupled to the cell patch through a vertical gap below the launch pad between the first and second metallization layers to direct a signal to or from the cell patch.

66. The device as in claim 1, wherein
the substrate has a first surface and a second surface opposite to the first surface,
the plurality of metallization layers include a first metallization layer formed on the first surface and a second metallization layer formed on the second surface, and
the conductive parts of the CRLH metamaterial structure comprise:
a ground electrode formed in the first metallization layer;
a feed line formed in the first metallization layer; and
a launch pad formed at a distal end of the feed line in the first metallization layer,
a cell patch formed in the second metallization layer;
a via line formed in the first metallization layer and connecting the ground electrode and the via, which connects to the cell patch in the second metallization layer;
wherein the launch pad is electromagnetically coupled to the cell patch through a vertical gap below the launch pad between the first and second metallization layers to direct a signal to or from the cell patch.

67. The device as in claim 65, wherein the CRLH metamaterial structure is configured to generate an LH frequency resonance in a low band and an RH frequency resonance in a high band.

68. The device as in claim 67, wherein the CRLH metamaterial structure is configured to generate the LH frequency resonance and the RH frequency resonance to cover a quad-band.

69. A metamaterial device comprising:
a substrate;
a first metallization layer formed on a first surface of the substrate and patterned to comprise a cell patch and a launch pad that are separated from each other and are electromagnetically coupled to each other;
a second metallization layer formed on a second surface of the substrate parallel to the first surface and patterned to comprise a ground electrode located outside a footprint of the cell patch, a cell via pad located underneath the cell patch, a cell via line connecting the ground electrode to the cell via pad, an interconnect pad located underneath the launch pad, and a feed line connected to the interconnect pad;
a cell via formed in the substrate to connect the cell patch to the cell via pad; and
an interconnect via formed in the substrate to connect the launch pad to the interconnect pad,
wherein one of the cell patch and the launch pad is shaped to include an opening and the other of the cell patch and the launch pad is located inside the opening, and the cell patch, the cell via, the cell via pad, the cell via line, the ground electrode, the launch pad, the interconnect via, the interconnect via and the feed line form a composite right and left handed (CRLH) metamaterial structure.

70. The device as in claim 69, wherein the cell via pad is less than the cell patch in area.

71. The device as in claim 69, wherein the cell patch is shaped to have the opening and the launch pad is located inside the opening.

72. The device as in claim 69, wherein the launch pad is shaped to have the opening and the cell patch is located inside the opening.
